(19) United States
(12) Patent Application Publication
(10) Pub. No.: US 2013/0120646 A1
(43) Pub. Date: May 16, 2013

(54) LENS UNIT

(71) Applicant: Toshiro Mukai, Osaka (JP)

(72) Inventor: Toshiro Mukai, Osaka (JP)

(73) Assignee: PANASONIC CORPORATION, Osaka (JP)

(21) Appl. No.: 13/810,233

(22) PCT Filed: Jul. 26, 2011
(86) PCT No.: PCT/JP2011/004220

§ 371 Date: Jan. 15, 2013

(30) Foreign Application Priority Data
Jul. 26, 2010 (JP) 2010-167644

(51) Int. Cl. H04N 5/225

(52) U.S. Cl. CPC H04N 5/2254
USPC 348/360

(57) ABSTRACT

A 3D adapter (100) comprises a left-eye optical system (OL) and a right-eye optical system (OR). The left-eye optical system (OL) is an optical system for forming a first optical image seen from a first viewpoint, and guides light from a subject to a uniaxial optical system (V). The right-eye optical system (OR) is an optical system for forming a second optical image seen from a second viewpoint that is different from the first viewpoint, and guides light from a subject to the uniaxial optical system (V).

### TECHNICAL FIELD

The technology disclosed herein relates to a lens unit.

### BACKGROUND ART

Digital still cameras, digital video cameras, and other such digital cameras are known as imaging devices. A digital camera has a CCD (charge coupled device) image sensor, a CMOS (Complementary Metal Oxide Semiconductor) image sensor, or another such imaging element. The imaging element converts an optical image formed by an optical system into an image signal. Image data for a subject can be acquired in this way.

### CITATION LIST

### Patent Literature

Patent Literature 1: Japanese Laid-Open Patent Application H2-260890

### SUMMARY

### Technical Problem

Recent years have seen the development of imaging devices that capture stereo images. A stereo image is an image intended for three-dimensional display, and includes a left-eye image and a right-eye image having parallax. With the device discussed in Patent Literature 1, two cameras are set up side by side to capture a left-eye image and a right-eye image.

A configuration such as this, however, does not lend itself well to easy three-dimensional imaging.

It is an object of the present invention to provide a lens unit with which three-dimensional imaging can be carried out easily.

### Solution to Problem

The lens unit disclosed herein is a lens unit for forming a first optical image and a second optical image having parallax, on an imaging element via a uniaxial optical system, said lens unit having a first optical system and a second optical system. The first optical system is an optical system for forming a first optical image seen from a first viewpoint, and guides light from a subject to a uniaxial optical system. The second optical system is an optical system for forming a second optical image seen from a second viewpoint that is different from the first viewpoint, and guides light from the subject to a uniaxial optical system.

With this lens unit, since light is guided to a uniaxial optical system by a biaxial optical system made up of a first optical system and a second optical system, an optical system intended for ordinary two-dimensional imaging can be converted to use in three-dimensional imaging.

### Advantageous Effects

Three-dimensional imaging can be carried out easily with the lens unit disclosed herein.

### BRIEF DESCRIPTION OF DRAWINGS

FIG. 1 is an oblique view of a video camera unit;

FIG. 2 is an exploded oblique view of a video camera unit;

FIG. 3 is a diagram of the configuration of the optical system in a video camera unit;

FIG. 4 is a simplified diagram of the configuration of a video camera;

FIG. 5 is a block diagram of a video camera;

FIG. 6 is a diagram illustrating an effective image range;

FIG. 7 is a diagram illustrating a convergence angle and a stereo base;

FIG. 8 is an oblique view of a 3D adapter;

FIG. 9 is an oblique view of a 3D adapter;

FIG. 10 is a detail exploded oblique view of a 3D adapter;

FIG. 11 is an exploded oblique view of an upper case and a threaded ring unit 17;

FIG. 12 is an exploded oblique view of a 3D adapter;

FIG. 13 is an exploded oblique view of a 3D adapter;

FIG. 14 is an exploded oblique view of a 3D adapter;

FIG. 15 is an exploded oblique view of a 3D adapter;

FIG. 16 is an exploded oblique view of a 3D adapter;

FIG. 17 is an exploded oblique view of a 3D adapter and cap;

FIG. 18 is a diagram illustrating the polarization angle of first and second prism groups;

FIG. 19 is an oblique view of a 3D adapter (when the exterior part has been removed);

FIG. 20 is an exploded oblique view of a 3D adapter (when the exterior part has been removed);

FIG. 21 is an oblique view of a 3D adapter (when the exterior part and front panel have been removed);

FIG. 22 is a front view of a 3D adapter (when the exterior part and front panel have been removed);

FIG. 23 is an oblique view of a main body frame;

FIG. 24 is an exploded oblique view of a main body frame;

FIG. 25 is an exploded oblique view of a main body frame;

FIG. 26 is an exploded oblique view of the area around an intermediate lens frame;

FIG. 27 is an exploded oblique view of the area around a prism support frame;

FIG. 28 is an exploded oblique view of the area around a first adjustment frame;

FIG. 29 is an oblique view of a first adjustment frame;

FIG. 30 is a diagram of the configuration of a first front support hole and a first rear support hole;

FIG. 31 is a front view of a first restricting mechanism;

FIG. 32 is an exploded oblique view of the area around a second adjustment frame;

FIG. 33 is an oblique view of a second adjustment frame;

FIG. 34 is a bottom face view of a main body frame;

FIG. 35 is a diagram of the configuration of a second front support hole and a second rear support hole;

FIG. 36 is a front view of a second restricting mechanism;

FIG. 37 is an exploded oblique view of a third adjustment mechanism;

FIG. 38 is an exploded oblique view of a third adjustment mechanism;

FIG. 39 is an oblique view of a third adjustment mechanism (as seen from the bottom face);

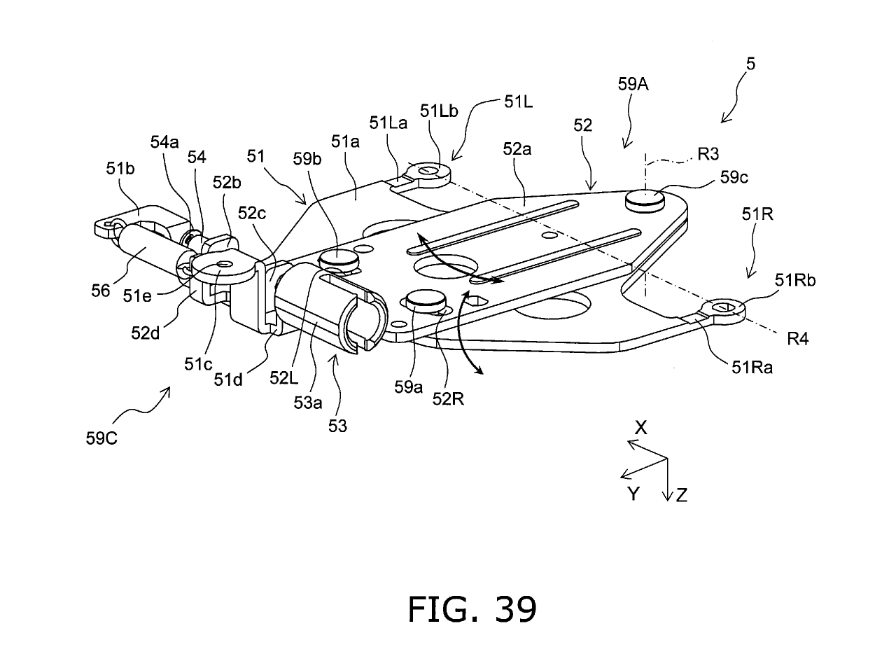

FIG. 40 is a bottom face view of a third adjustment mechanism;

FIG. 41 is an exploded oblique view of an operating mechanism and the area around it;

FIG. 42 is a diagram illustrating an effective image region;

FIG. 43 is a diagram illustrating an effective image region;

FIG. 44 is a diagram illustrating an effective image region;

FIG. 45 is a diagram of the configuration of a left-eye optical image;

FIG. 46 is a diagram of the configuration of a right-eye optical image;

FIG. 47 is a diagram of the configuration of a left-eye optical image and a right-eye optical image;

FIG. 48 is a diagram illustrating left-eye and right-eye optical images during vertical relative offset adjustment;

FIG. 49 is a flowchart;

FIG. 50 is a flowchart;

FIG. 51 is a plan view of a light blocking sheet (another embodiment);

FIG. 52 is a diagram illustrating left-eye and right-eye optical images during vertical relative offset adjustment (another embodiment); and

FIG. 53 is a diagram corresponding to FIG. 52 during normal imaging (another embodiment).

### DESCRIPTION OF EMBODIMENTS

### Overview of Video Camera Unit

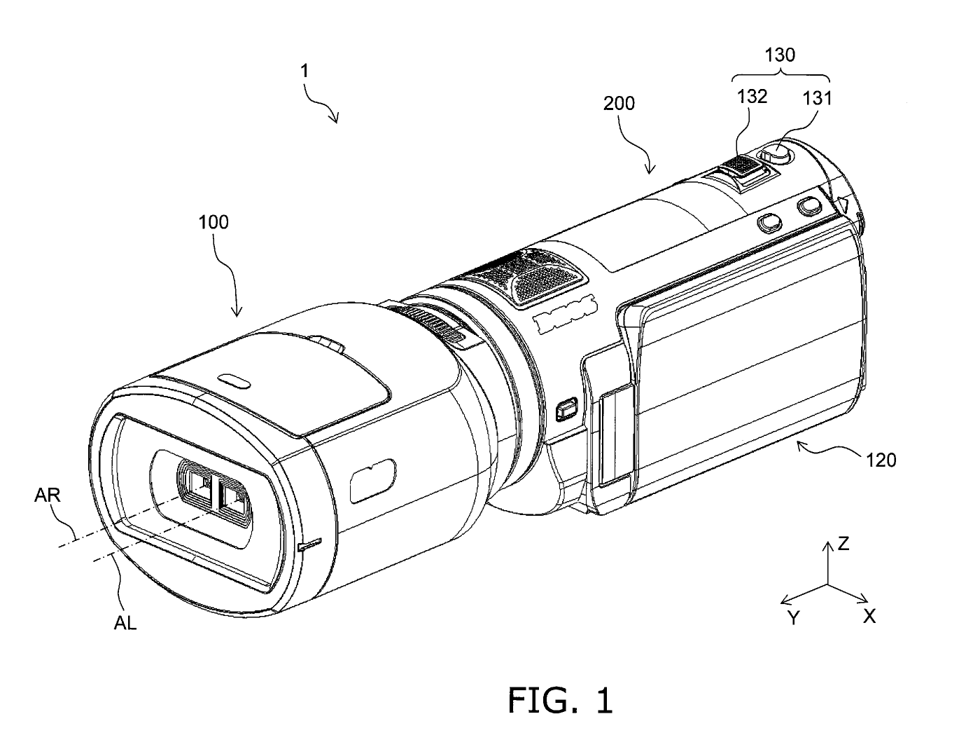

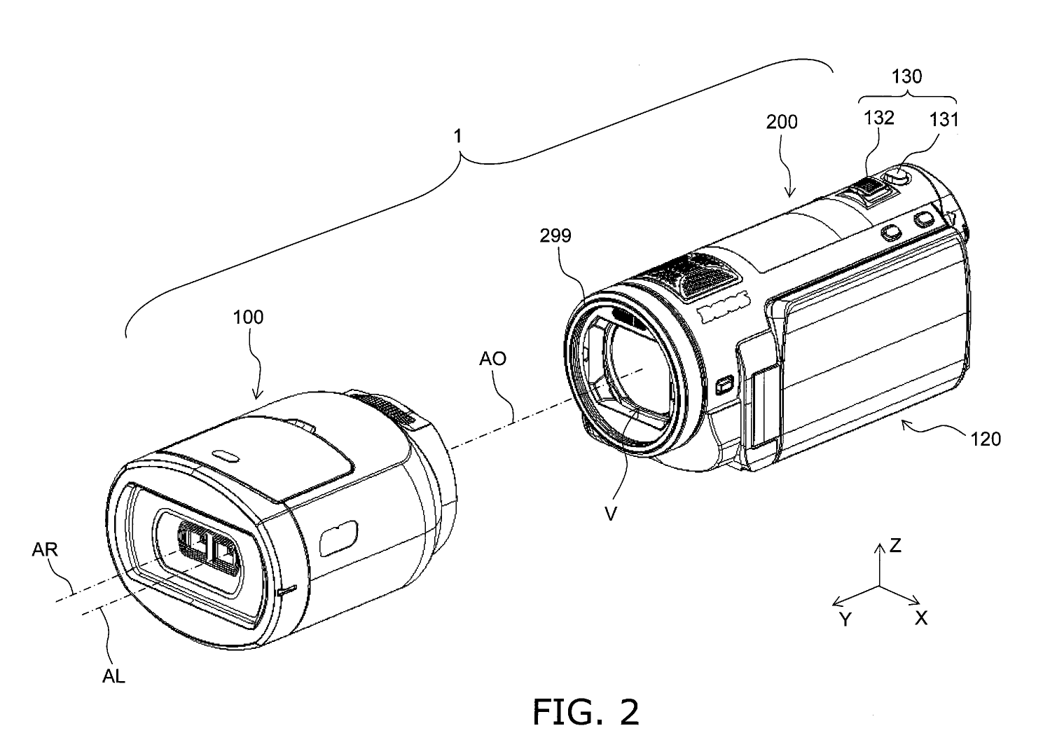

As shown in FIG. 1, a video camera unit 1 comprises a video camera 200 (an example of an imaging device) and a 3D adapter 100 (an example of a lens unit) that is mounted to the video camera 200. As shown in FIG. 2, the 3D adapter 100 is configured so that it can be attached to and removed from the video camera 200. The video camera 200 has a uniaxial optical system V with an optical axis A0. On the other hand, the 3D adapter 100 has a biaxial optical system with a left-eye optical axis AL (an example of a first optical axis or a second optical axis) and a right-eye optical axis AR (an example of a first optical axis or a second optical axis). When two-dimensional imaging is performed, it is performed by only the video camera 200, and when three-dimensional imaging is performed, it is performed by mounting the 3D adapter 100 to the video camera 200. That is, the video camera 200 is compatible with both two-dimensional imaging and three-dimensional imaging.

The 3D adapter 100 is a conversion lens for performing three-dimensional imaging with the video camera 200, and can be mounted to a front frame 299 of the video camera 200. The front frame 299 is provided for mounting a wide conversion lens, a telephoto conversion lens, or another such optical part. The 3D adapter 100 makes use of a side-by-side imaging method in which two optical images are formed on a single imaging element by a pair of left and right optical systems. The uniaxial optical system V can be switched to a biaxial optical system that allows three-dimensional imaging by mounting the 3D adapter 100 to the video camera 200.

For the purposes of this description, the subject side of the video camera unit 1 will called the front, the opposite side of the video camera unit 1 from the subject will be called the rear, the vertically upper side when the video camera unit 1 is in its normal orientation (hereinafter also referred to as landscape orientation) will be called the top, and the vertically lower side will be called the bottom. The right side when facing the subject in the normal orientation of the video camera unit 1 will be called the right, and the left side will be called the left.

Also, in the following description, a three-dimensionally intersecting coordinate system is set for the 3D adapter 100 and the video camera 200. In the following description, the X axis direction is a direction parallel to the X axis, the Y axis direction is a direction parallel to the Y axis, and the Z axis direction is a direction parallel to the Z axis. As shown in FIG. 2, since the Y axis is set parallel to the optical axis A0, the left-eye optical axis AL and the right-eye optical axis AR are substantially parallel to the Y axis. Also, if an imaginary plane parallel to the left-eye optical axis AL and the right-eye optical axis AR in a state in which the left-eye optical axis AL and the right-eye optical axis AR are intersecting is used as a reference plane, the Z axis direction is perpendicular to the reference plane.

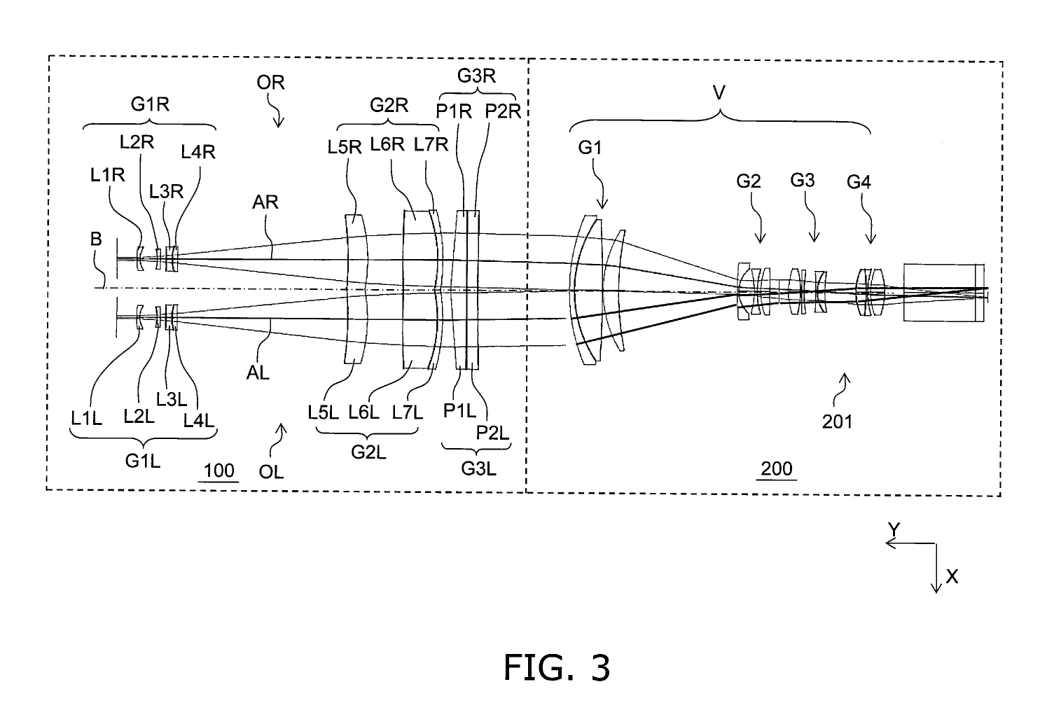

As shown in FIG. 3, in the following description, an imaginary plane that includes the optical axis A0 of the video camera 200 and the Z axis is termed an intermediate reference plane B. The intermediate reference plane B is disposed between a left-eye optical system OL and a right-eye optical system OR, and is defined at the center of the left-eye optical system OL and the right-eye optical system OR. The intermediate reference plane B is disposed substantially parallel to the left-eye optical axis AL and the right-eye optical axis AR. The intermediate reference plane B is perpendicular to the X axis direction. In other words, the left-eye optical system OL and the right-eye optical system OR are disposed at positions that are substantially in left and right symmetry with respect to the intermediate reference plane B. Also, the intermediate reference plane B is perpendicular to the above-mentioned reference plane. The reference plane can also be called an imaginary plane parallel to the paper plane of FIG. 3.

### Configuration of Video Camera

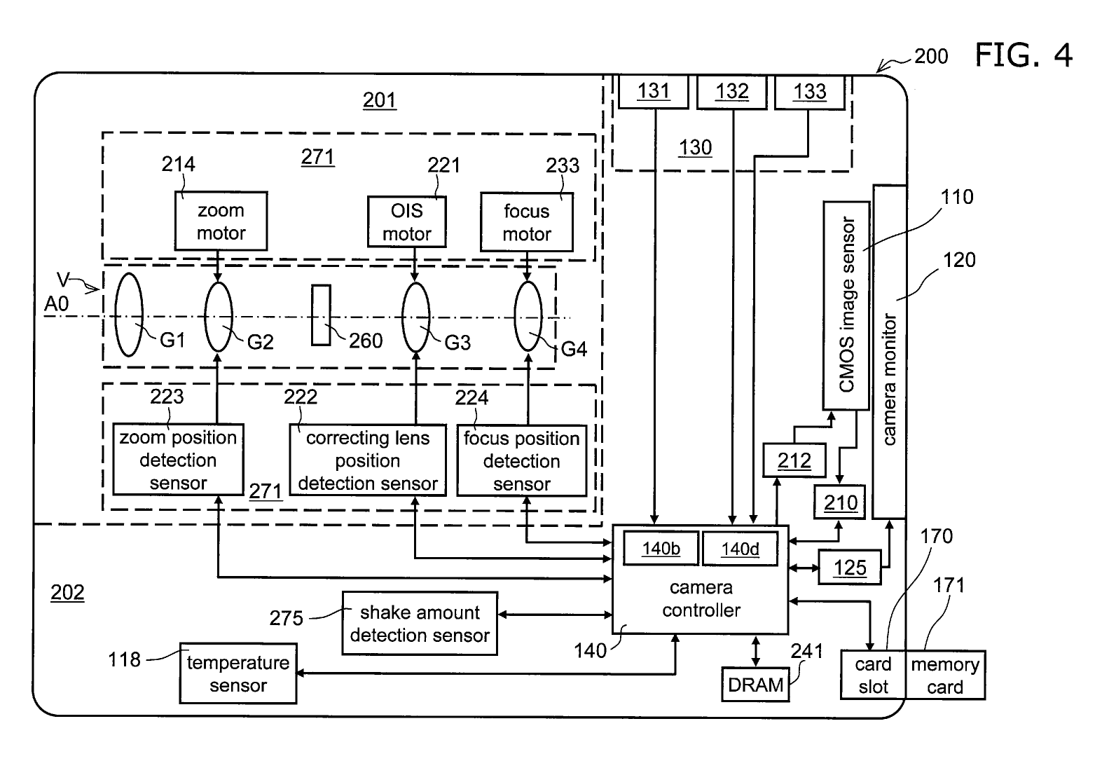

As shown in FIG. 4, the video camera 200 has a video lens unit 201 and a video camera body 202. In this embodiment, the video lens unit 201 and the video camera body 202 together constitute the video camera 200.

### 1: Configuration of Video Lens Unit 201

As shown in FIG. 4, the video lens unit 201 is provided to form an optical image of a subject, and has an optical system V and a drive unit 271.

(1) Optical System V

As shown in FIG. 3, the optical system V is a uniaxial optical system having the optical axis A0, and has a first lens group G1, a second lens group G2, a third lens group G3, and a fourth lens group G4.

The first lens group G1 is disposed at the position in the optical system V that is closest to the subject. The second lens group G2 (an example of a zoom adjusting lens group) is a lens group for zoom adjustment, and is provided movably along the optical axis A0. The third lens group G3 is a lens group for correcting hand shake. The fourth lens group G4 (an example of a focus lens group) is a lens group for focal adjustment, and is provided movably along the optical axis A0.

(2) Drive Unit 271

As shown in FIG. 4, the drive unit 271 is provided to adjust the state of the optical system V, and has a zoom motor 214, an OIS motor 221, a correcting lens position detection sensor 222, a zoom position detection sensor 223, a focus position detection sensor 224, and a focus motor 233.

The zoom motor 214 (an example of a zoom driver) drives the second lens group G2 in a direction parallel to the optical axis A0. The focal length of the optical system V can be adjusted by moving the second lens group G2 in a direction parallel to the optical axis A0. The zoom motor 214 is controlled by a camera controller 140. In this embodiment, the zoom motor 214 is a stepping motor, but it may instead be a DC motor, a servo motor, an ultrasonic motor, or another such actuator.

The OIS motor 221 drives the third lens group G3. The correcting lens position detection sensor 222 detects the position of a correcting lens included in the third lens group G3.

The focus motor 233 (an example of a focus driver) drives the fourth lens group G4 in a direction parallel to the optical axis A0. The imaging distance (the distance from the video camera 200 to a subject that is in focus) can be adjusted by moving the fourth lens group G4 in a direction parallel to the optical axis A0. The focus motor 233 is controlled by a lens controller 240. In this embodiment, the focus motor 233 is a stepping motor, but may instead be a DC motor, a servo motor, an ultrasonic motor, or another such actuator.

### 2: Configuration of Video Camera Body 202

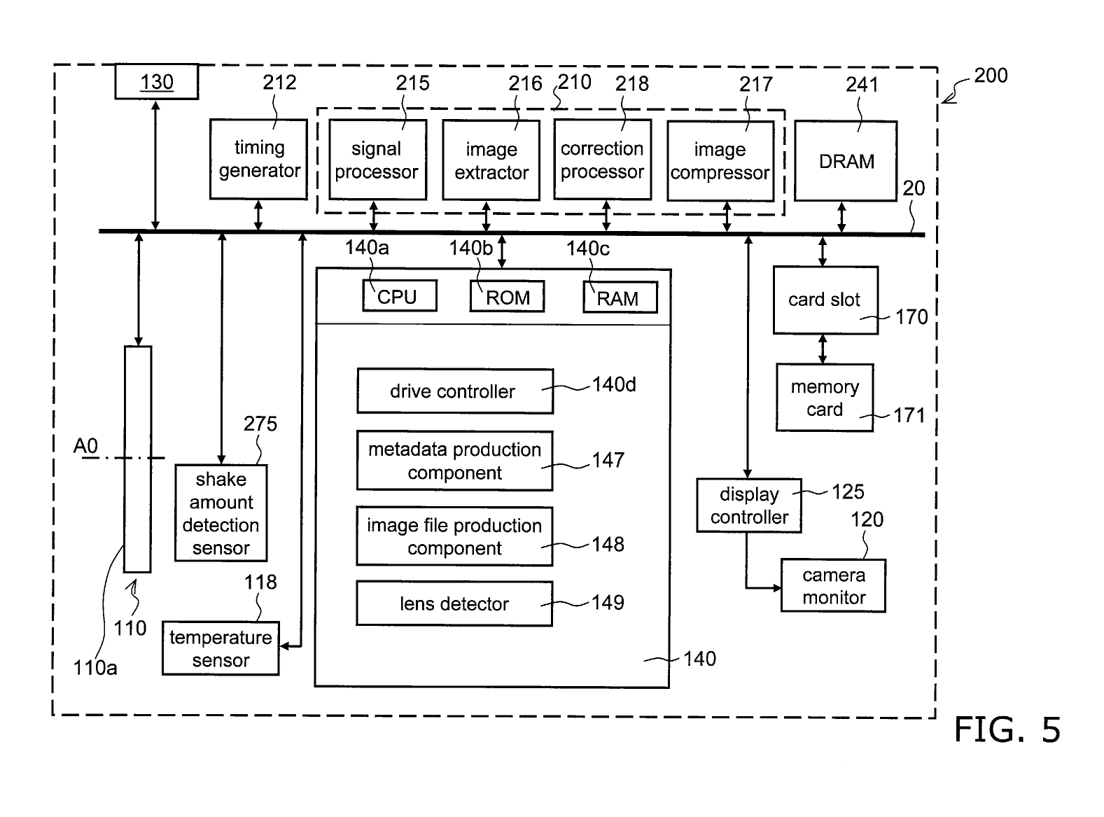

As shown in FIG. 4, the video camera body 202 comprises a CMOS image sensor 110, a camera monitor 120, a display controller 125, an interface component 130, a card slot 170, a DRAM 241, an image processor 210, a temperature sensor 118, a shake amount detection sensor 275, and the camera controller 140. As shown in FIG. 5, these components are connected to a bus 20, and can exchange data with each other through the bus 20.

(1) CMOS Image Sensor 110

As shown in FIG. 4, the CMOS image sensor 110 (an example of an imaging element) converts an optical image of a subject formed by the video lens unit 201 (hereinafter also referred to as a subject image) into an image signal. The CMOS image sensor 110 outputs an image signal on the basis of a timing signal produced by a timing generator 212. The image signal produced by the CMOS image sensor 110 is digitized and converted into image data by the image processor 210. Still picture data and moving picture data can be acquired with the CMOS image sensor 110. The acquired moving picture data is also used for the display of a through-image.

The “through-image” referred to here is an image, out of the moving picture data, that is not recorded to a memory card 171. The through-image is mainly a moving picture, and is displayed on the camera monitor 120 in order to determine the composition of a moving picture or still picture.

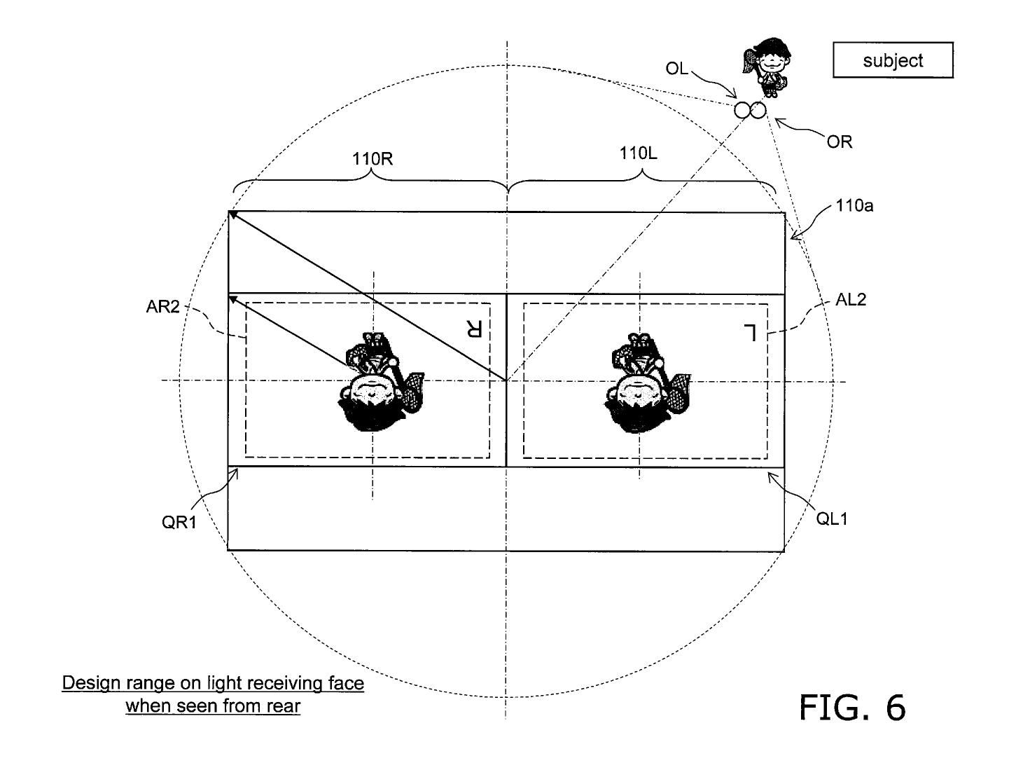

As shown in FIG. 5, the CMOS image sensor 110 has a light receiving face 110a that receives light that has passed through the video lens unit 201. An optical image of the subject is formed on the light receiving face 110a. As shown in FIG. 6, when viewed from the rear face side of the video camera body 202, a first light receiving face 110L accounts for the left half of the light receiving face 110a, while a second light receiving face 110R accounts for the right half. The first light receiving face 110L and the second light receiving face 110R have the same surface area. When imaging is performed with the 3D adapter 100 attached to the video camera 200, a left-eye optical image QL1 is formed on the first light receiving face 110L, and a right-eye optical image QR1 is formed on the second light receiving face 110R.

The CMOS image sensor 110 is an example of an imaging element that converts an optical image of a subject into an electrical image signal. “Imaging element” here is a concept that encompasses the CMOS image sensor 110 as well as a CCD image sensor or another such opto-electric conversion element.

(2) Camera Monitor 120

The camera monitor 120 shown in FIG. 5 is a liquid crystal display, for example, and displays display-use image data as an image. This display-use image data is image data that has undergone image processing, or data for displaying the imaging conditions, operating menu, and so forth of the video camera unit 1, and is produced by the camera controller 140. The camera monitor 120 is capable of selectively displaying both moving and still pictures. As shown in FIGS. 1 and 2, in this embodiment the camera monitor 120 is disposed on the side face of the video camera body 202, but the camera monitor 120 may be disposed anywhere on the video camera body 202.

The camera monitor 120 is an example of a display component provided to the video camera body 202. The display component could also be an organic electroluminescence component, an inorganic electroluminescence component, a plasma display panel, or another such device that allows images to be displayed.

(3) Interface Component 130

As shown in FIG. 4, the interface component 130 has a record button 131, a zoom lever 132, and an adjustment mode button 133. The record button 131 accepts record operations from the user. The zoom lever 132 is a lever switch provided to the top face of the video camera body 202, and is used for zoom adjustment. The adjustment mode button 133 is provided for switching the video camera 200 to adjustment mode, in which various position adjustments are made to the left and right images during three-dimensional imaging. The interface component 130 can include a button, lever, dial, touch panel, or the like, so long as it can be operated by the user.

(4) Card Slot 170

As shown in FIG. 4, the card slot 170 allows the memory card 171 to be inserted. The card slot 170 controls the memory card 171 on the basis of control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 in image processing. For instance, the memory card 171 can store uncompressed raw image data or compressed JPEG image data. Furthermore, the memory card 171 can store stereo image data in multi-picture format (MPF).

Also, still picture data that has been internally stored ahead of time can be outputted from the memory card 171 via the card slot 170. The still picture data outputted from the memory card 171 is subjected to image processing by the camera controller 140. For example, the camera controller 140 produces display-use still picture data by subjecting the still picture data acquired from the memory card 171 to expansion processing.

The memory card 171 is further able to store moving picture data produced by the camera controller 140 in image processing. For instance, the memory card 171 can store moving picture data compressed according to H.264/AVC, which is a moving picture compression standard. Moving picture data stored internally ahead of time can also be outputted from the memory card 171 via the card slot 170. The moving picture data outputted from the memory card 171 is subjected to image processing by the camera controller 140. For example, the camera controller 140 subjects the moving picture data acquired from the memory card 171 to expansion processing and produces display-use moving picture data.

(5) Camera Controller 140

The camera controller 140 controls the entire video camera 200. The camera controller 140 is electrically connected to the interface component 130. Operation signals from the interface component 130 are inputted to the camera controller 140. The camera controller 140 uses the DRAM 241 as a working memory during control operation or during the image processing operation discussed below.

As shown in FIG. 5, the camera controller 140 has a CPU (central processing unit) 140a, a ROM (read only memory) 140b (an example of an index memory), and a RAM (random access memory) 140c, and can perform various functions by reading the programs stored in the ROM 140b into the CPU 140a. More specifically, the camera controller 140 performs the functions of a drive controller 140d, a metadata production component 147, an image file production component 148, and a lens detector 149 by reading programs stored in the ROM 140b to the CPU 140a.

The camera controller 140 also has a reproduction mode, a two-dimensional imaging mode, a three-dimensional imaging mode, and an adjustment mode. As discussed above, the camera controller 140 can automatically switch the operating mode between two-dimensional imaging mode and three-dimensional imaging mode on the basis of the detection result of the lens detector 149. In two-dimensional imaging mode, an ordinary two-dimensional image can be captured. In three-dimensional imaging mode, meanwhile, the 3D adapter 100 can be used to capture a stereo image. The adjustment mode button 133 can be used to have the camera controller 140 switch the operating mode to adjustment mode. In adjustment mode, the relative offset in the up and down direction, the up and down positions, and the left and right positions of the left-eye optical image QL1 and the right-eye optical image QR1 can be adjusted. Switching to adjustment mode can be accomplished by using the adjustment mode button 133.

As shown in FIG. 5, the drive controller 140d (an example of a drive controller) controls the zoom motor 214 on the basis of index data indicating the individual differences of a product in two-dimensional imaging mode and three-dimensional imaging mode, and drives the second lens group G2 to the desired position. Consequently, even if there are individual differences between products, the second lens group G2 can be disposed at the designed reference position, and offset of the reference plane distance of the video camera unit 1 can be corrected. Index data is data indicating the individual differences of the optical system V, for example, and index data is calculated for each product during its manufacture or shipment. Index data is data that can be converted to a focal length, for example, and more specifically it may be data indicating the difference between the design value for focal length and the actual focal length. This index data is stored in the ROM 140b, for example.

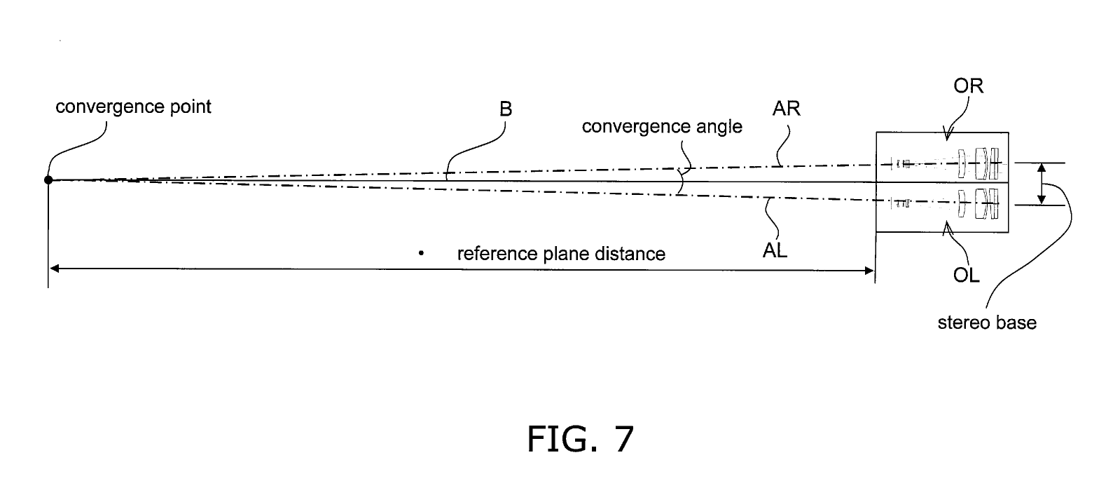

The metadata production component 147 produces metadata including a stereo base and a convergence angle. As shown in FIG. 7, “stereo base” refers to the distance between the left-eye optical system OL and the right-eye optical system OR. “Convergence angle” refers to the angle formed by the left-eye optical axis AL and the right-eye optical axis AR. The stereo base and the convergence angle are used in displaying a stereo image. “Convergence point” refers to the point of intersection between the left-eye optical axis AL and the right-eye optical axis AR. The minimum distance from the convergence point to the front face of the 3D adapter 100 is called the reference plane distance.

The image file production component 148 shown in FIG. 5 produces stereo image data in MPF (multi-picture format) by combining left- and right-eye image data compressed by an image compressor 217 (discussed below) with metadata. The image data thus produced is sent to the card slot 170 and stored on the memory card 171, for example.

As shown in FIG. 5, the camera controller 140 also has the lens detector 149. The lens detector 149 detects that the 3D adapter 100 has been mounted to the video camera 200. When the mounting of the 3D adapter 100 to the video camera 200 is detected by the lens detector 149, the camera controller 140 switches the operating mode from two-dimensional imaging mode to three-dimensional imaging mode. If the lens detector 149 detects that the 3D adapter 100 has been removed from the video camera 200, the camera controller 140 switches the operating mode from three-dimensional imaging mode to two-dimensional imaging mode. That is, the camera controller 140 can automatically switch the operating mode between two-dimensional imaging mode and three-dimensional imaging mode according to whether the 3D adapter 100 is mounted to or removed from the video camera 200.

(6) Image Processor 210

As shown in FIG. 5, the image processor 210 has a signal processor 215, an image extractor 216, a correction processor 218, and the image compressor 217.

The signal processor 215 digitizes the image signal produced by the CMOS image sensor 110, and produces basic image data for the optical image formed on the CMOS image sensor 110. More specifically, the signal processor 215 converts the image signal outputted from the CMOS image sensor 110 into a digital signal, and subjects this digital signal to digital signal processing such as noise elimination or contour enhancement. The image data produced by the signal processor 215 is temporarily stored as raw data in the DRAM 241. The image data produced by the signal processor 215 is called basic image data.

The image extractor 216 extracts left-eye image data and right-eye image data from the basic image data produced by the signal processor 215. The left-eye image data corresponds to part of the left-eye optical image QL1 formed by the left-eye optical system OL (see FIG. 6). The right-eye image data corresponds to part of the right-eye optical image QR1 formed by the right-eye optical system OR (see FIG. 6). The image extractor 216 extracts left-eye image data and right-eye image data from the basic image data held in the DRAM 241, on the basis of a preset first extraction region AL2 and second extraction region AR2 (see FIG. 6). The left-eye image data and right-eye image data extracted by the image extractor 216 are temporarily stored in the DRAM 241.

The correction processor 218 performs distortion correction, shading correction, and other such correction processing on the extracted left-eye image data and right-eye image data. After this correction processing, the left-eye image data and right-eye image data are temporarily stored in the DRAM 241.

The image compressor 217 performs compression processing on the corrected left- and right-eye image data stored in the DRAM 241, on the basis of a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 241.

(7) Temperature Sensor 118

The temperature sensor 118 shown in FIG. 5 (an example of a temperature detector) detects the environment temperature of the video camera 200. The temperature sensor 118 is disposed at a position where the temperature around the optical system V can be detected. The temperature sensor 118 is a thermocouple, but may be some other sensor capable of detecting the environment temperature of the video camera 200. The temperature detected by the temperature sensor 118 is used to correct offset of the reference plane distance at the drive controller 140d of the camera controller 140.

### Configuration of 3D Adapter

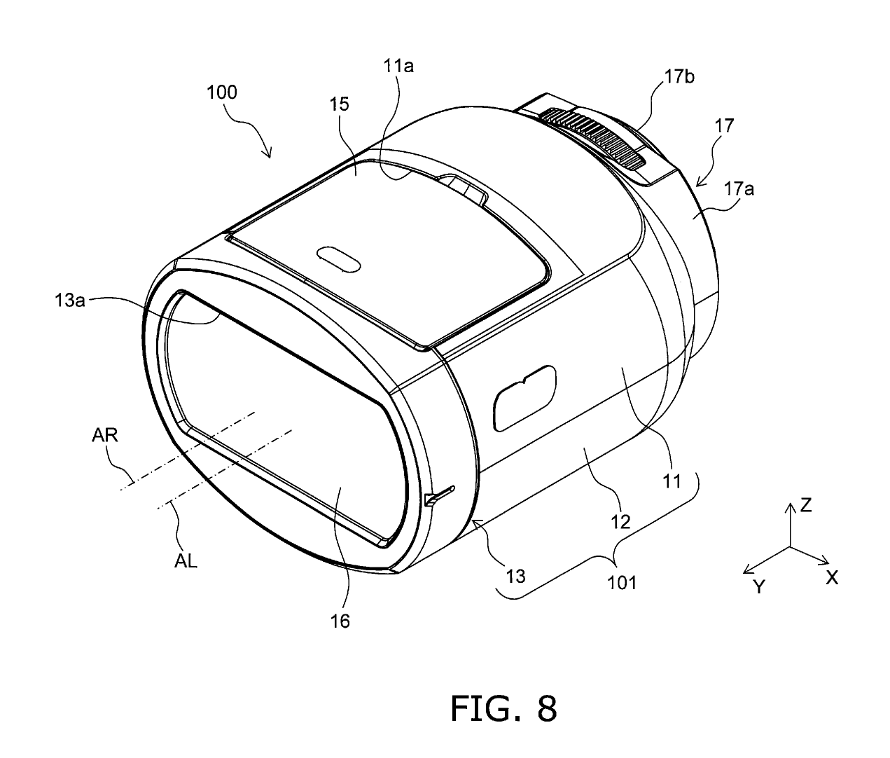

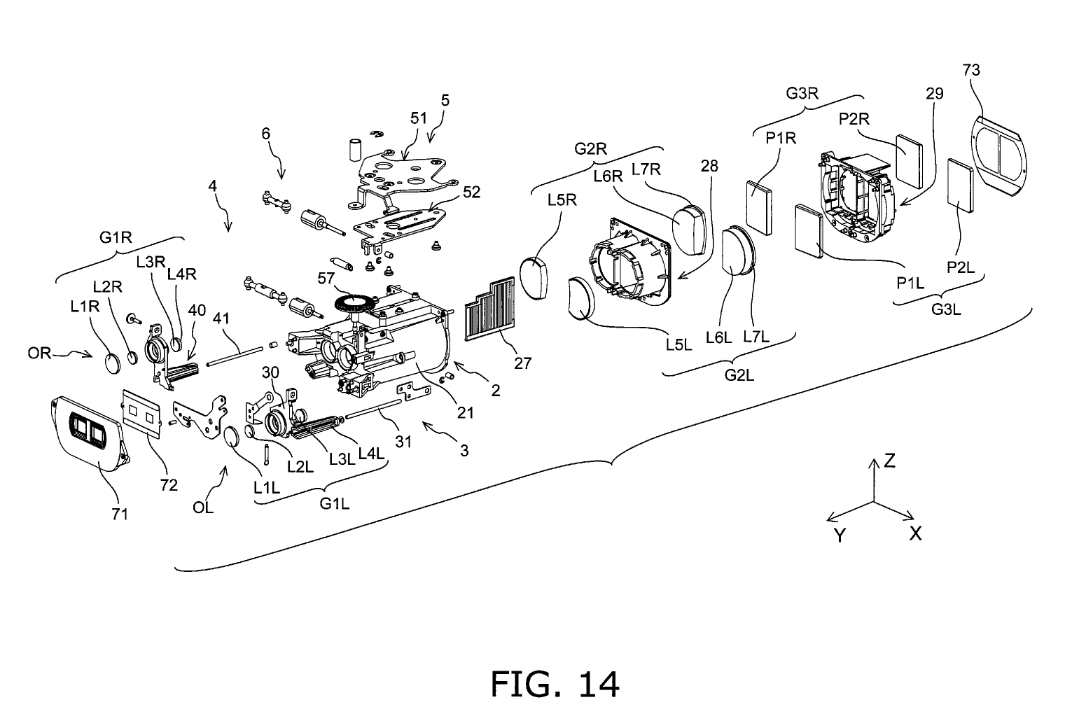

As shown in FIG. 8, the 3D adapter 100 has an exterior part 101 (an example of a housing). The exterior part 101 accommodates the left-eye optical system OL and right-eye optical system OR shown in FIG. 3. Furthermore, as shown in FIG. 14, the exterior part 101 accommodates a main body frame 2, a first adjustment mechanism 3, a second adjustment mechanism 4, a third adjustment mechanism 5, and an operation mechanism 6.

Here, the “left-eye optical system” is an optical system corresponding to the viewpoint on the left side, and more specifically refers to an optical system in which the optical element disposed the farthest on the subject side (front side) is disposed on the left side toward the subject. Similarly, the “right-eye optical system” is an optical system corresponding to the viewpoint on the right side, and more specifically refers to an optical system in which the optical element disposed the farthest on the subject side (front side) is disposed on the right side toward the subject.

The “optical element” referred to here corresponds to an optical element having a positive or negative refractive power, and does not include mere glass (such as the glass 16 discussed below).

(1) Exterior Part 101

As shown in FIG. 8, the exterior part 101 (an example of a housing) has an upper case 11, a lower case 12, a front case 13, a cover 15, and a threaded ring unit 17. The lower case 12 is fixed by screws to the upper case 11. The front case 13 is fixed by screws to the upper case 11 and the lower case 12. The cover 15 is openably and closeably mounted to the upper case 11. The upper case 11 has a recess 11a. When the cover 15 is closed, the cover 15 fits into the recess 11a.

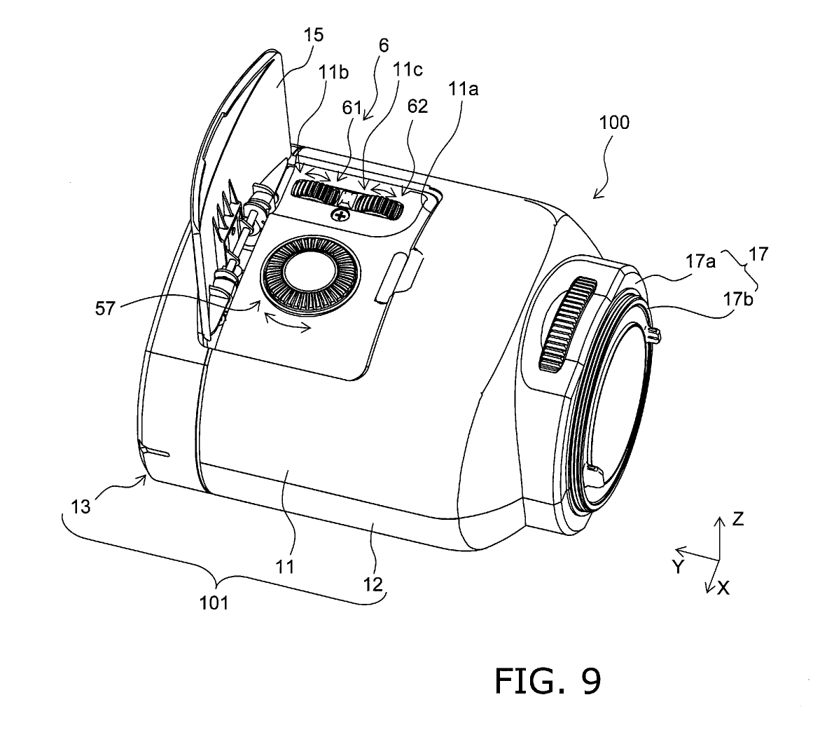

As shown in FIG. 9, the upper case 11 is configured so that when the cover 15 is open, a vertical position adjustment dial 57, a relative offset adjustment dial 61, and a horizontal position adjustment dial 62 of the operation mechanism 6 are exposed. The vertical position adjustment dial 57, the relative offset adjustment dial 61, and the horizontal position adjustment dial 62 are disposed in the recess 11a. The cover 15 is mounted openably and closeably to the upper case 11. The vertical position adjustment dial 57, the relative offset adjustment dial 61, and the horizontal position adjustment dial 62 can be operated when the cover 15 is opened.

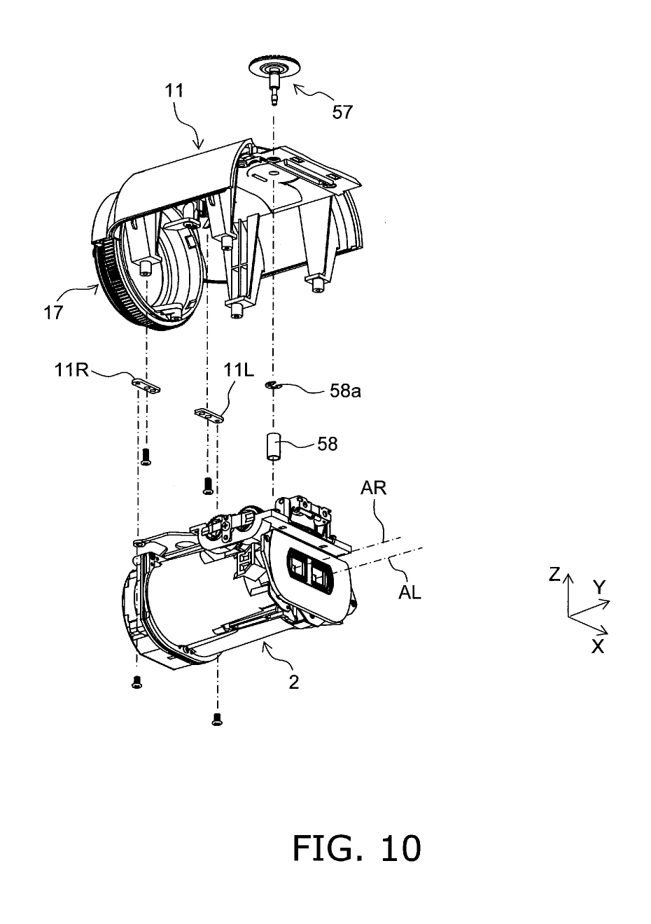

As shown in FIG. 10, the upper case 11 is mounted on the top side of the main body frame 2. The upper case 11 supports the main body frame 2 movably in the Z axis direction and the X axis direction.

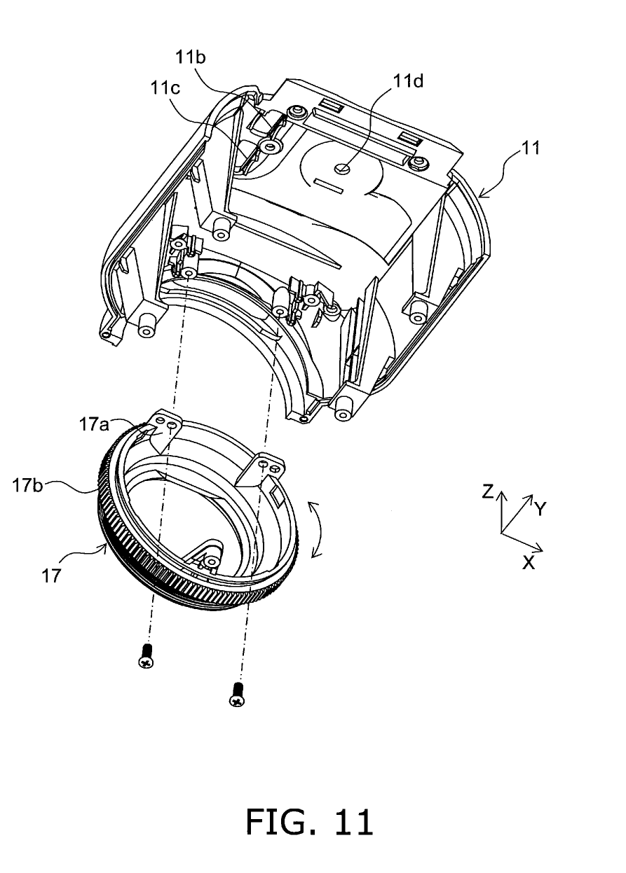

As shown in FIG. 11, the threaded ring unit 17 has a rear case 17a mounted to the upper case 11 and the lower case 12, and a threaded ring 17b for mounting the 3D adapter 100 to the front frame 299 (see FIG. 2). The rear case 17a supports the threaded ring 17b rotatably. The 3D adapter 100 can be mounted to the video camera 200 by connecting the threaded ring 17b to the front frame 299 of the video camera 200.

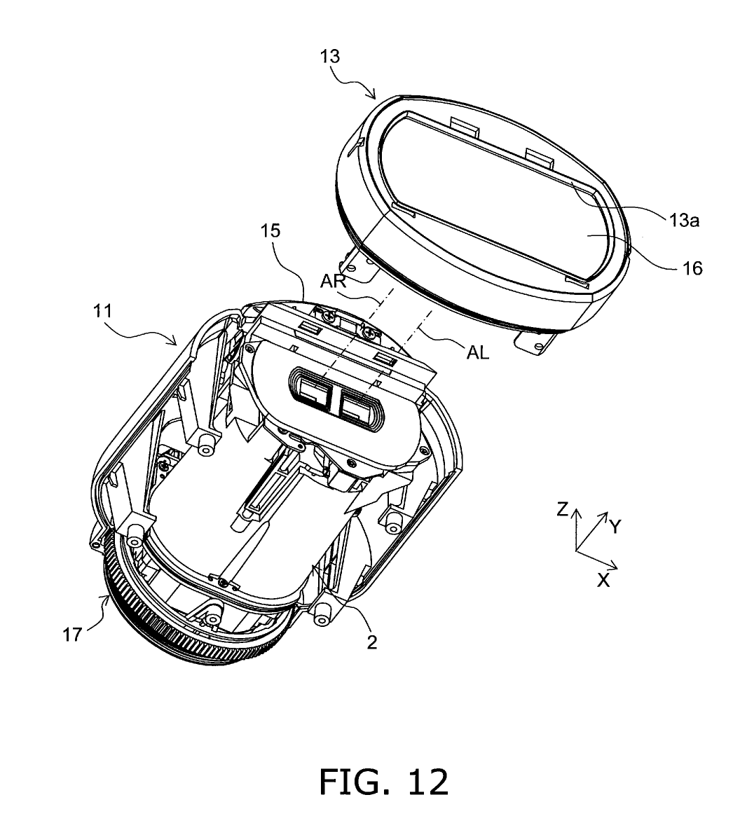

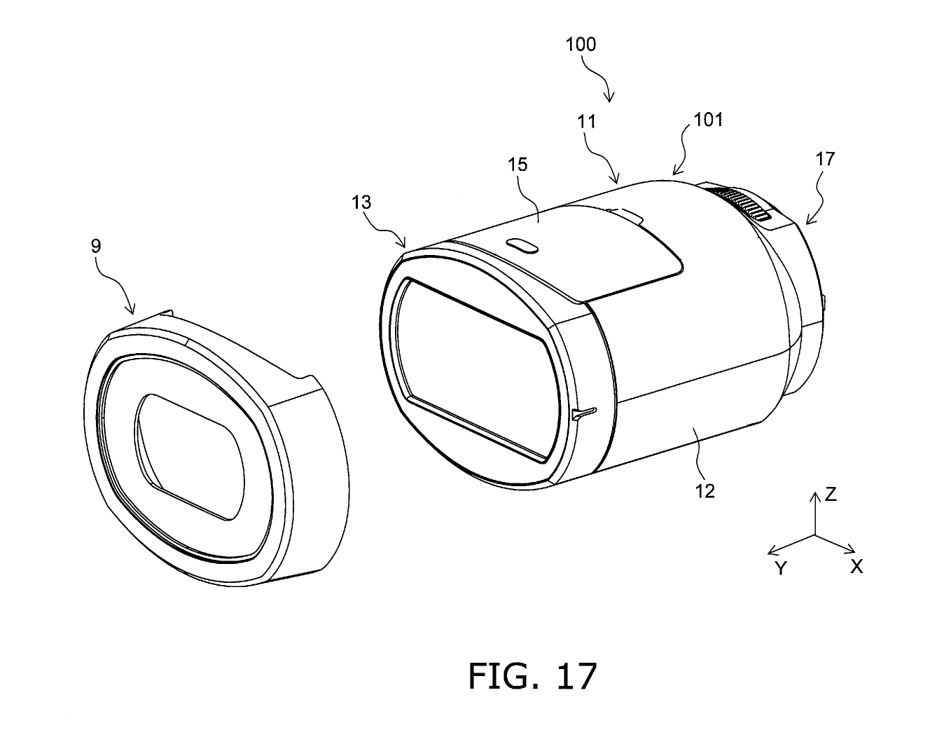

As shown in FIG. 12, the front case 13 is mounted to the front side of the main body frame 2 (the side closer to the subject). The front case 13 has an opening 13a and a glass 16 mounted in the opening 13a. A cap 9 can be mounted to the front case 13 as shown in FIG. 17. The cap 9 is mounted to protect the glass 16 or to adjust relative offset.

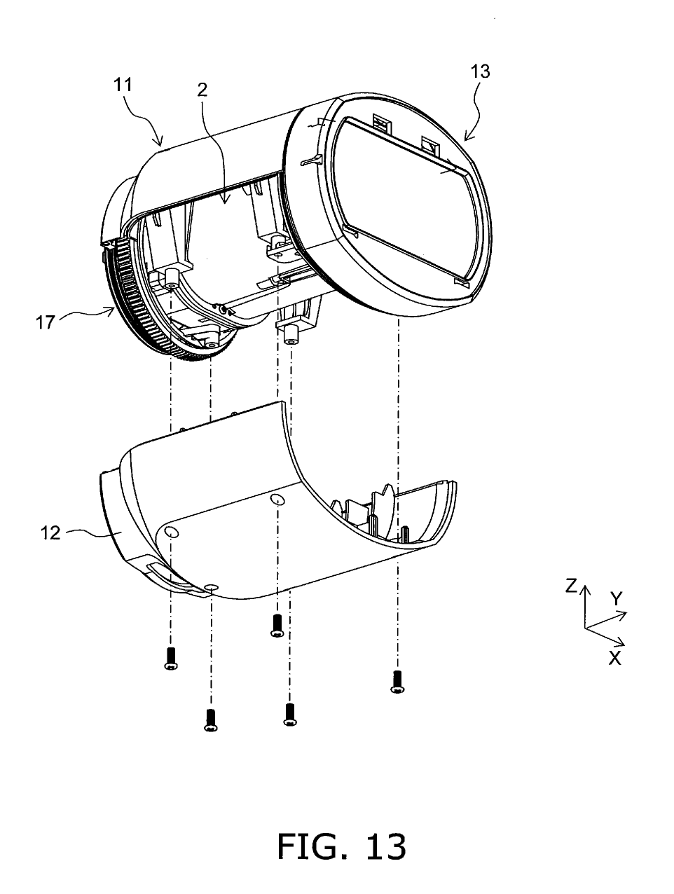

As shown in FIG. 13, the lower case 12 covers the bottom side of the main body frame 2, and is mounted to the upper case 11. A gap is provided between the lower case 12 and the main body frame 2 so that the main body frame 2 will be able to move in the Z axis direction and the X axis direction inside the exterior part 101. The exterior part 101 covers the main body frame 2.

(2) Left-Eye Optical System OL

As shown in FIG. 3, the left-eye optical system OL is an optical system for forming a left-eye optical image (an example of a first optical image or a second optical image) from a left-side viewpoint (an example of a first viewpoint or a second viewpoint), and has a left-eye negative lens group G1L, a left-eye positive lens group G2L, and a left-eye prism group G3L. The left-eye optical system OL is a substantially afocal optical system. For example, the focal length of the left-eye optical system OL is preferably at least 1000 mm or no more than −1000 mm.

The left-eye negative lens group G1L (an example of a first adjustment optical system, and an example of a first negative lens group or a second negative lens group) has on the whole a negative focal length (also called a negative refractive power), and has a first lens L1L, a second lens L2L, a third lens L3L, and a fourth lens L4L. The left-eye negative lens group G1L is disposed the farthest on the subject side in the left-eye optical system OL (at a position that is closest to the subject). The first lens L1L has a negative focal length. The second lens L2L has a negative focal length. The third lens L3L has a positive focal length (also called a positive refractive power). The fourth lens L4L has a negative focal length and is joined to the third lens L3L. The combined focal length of the left-eye negative lens group G1L is negative. The effective radius of the left-eye negative lens group G1L is smaller than the effective radius of the left-eye positive lens group G2L.

The left-eye positive lens group G2L (an example of a first positive lens group or a second positive lens group) is a lens group that receives light transmitted by the left-eye negative lens group G1L, and is disposed on the opposite side of the left-eye negative lens group G1L from the subject. The left-eye positive lens group G2L is disposed between the left-eye negative lens group G1L and the left-eye prism group G3L.

The left-eye positive lens group G2L has a fifth lens L5L, a sixth lens L6L, and a seventh lens L7L. The fifth lens L5L has a positive focal length. The sixth lens L6L has a positive focal length. The seventh lens L7L has a negative focal length and is joined to the sixth lens L6L.

Since light transmitted by the left-eye negative lens group G1L diverges, the optically effective region of the incident face of the left-eye positive lens group G2L is larger than the optically effective region of the emission face of the left-eye negative lens group G1L. Accordingly, the effective radius of the left-eye positive lens group G2L is larger than the effective radius of the left-eye negative lens group G1L. Also, the left-eye positive lens group G2L has a substantially semicircular shape in order to move the left-eye optical axis AL and right-eye optical axis AR closer together. More specifically, the inner side of the left-eye positive lens group G2L (the right-eye optical axis AR side, and the intermediate reference plane B side) is cut in a straight line (see FIG. 14). This allows the left-eye positive lens group G2L and a right-eye positive lens group G2R to be disposed closer together, and allows the stereo base to be made smaller. This also makes it easier to set the convergence angle formed by the left-eye optical axis AL and the right-eye optical axis AR to the proper value.

The left-eye optical axis AL is defined by the left-eye negative lens group G1L and the left-eye positive lens group G2L. More specifically, the left-eye optical axis AL is defined by a line that passes through the principal point of the left-eye negative lens group G1L and the principal point of the left-eye positive lens group G2L. The left-eye optical axis AL and the right-eye optical axis AR are disposed so as to be farther apart going from the subject side toward the CMOS image sensor 110 side.

The left-eye prism group G3L (an example of a first prism group or a second prism group) is a lens group that receives the light transmitted by the left-eye positive lens group G2L, and has a first front prism P1L and a first rear prism P2L. The first front prism P1L and the first rear prism P2L are refracting wedge prisms. The left-eye prism group G3L refracts light transmitted by the left-eye positive lens group G2L so that light transmitted by the left-eye positive lens group G2L will be guided to the optical system V (an example of a uniaxial optical system) of the video camera 200. More specifically, light transmitted by the left-eye positive lens group G2L is refracted inward (closer to the intermediate reference plane B) by the left-eye prism group G3L. The first front prism P1L refracts light transmitted by the left-eye positive lens group G2L inward (closer to the intermediate reference plane B). The first rear prism P2L refracts light transmitted by the first front prism P1L outward (away from the intermediate reference plane B). The main function of the first front prism P1L is to refract light transmitted by the left-eye positive lens group G2L inward, and the main function of the first rear prism P2L is to correct color dispersion caused by refraction. The combined polarization angle of the left-eye prism group G3L is approximately 1.7 degrees, for example.

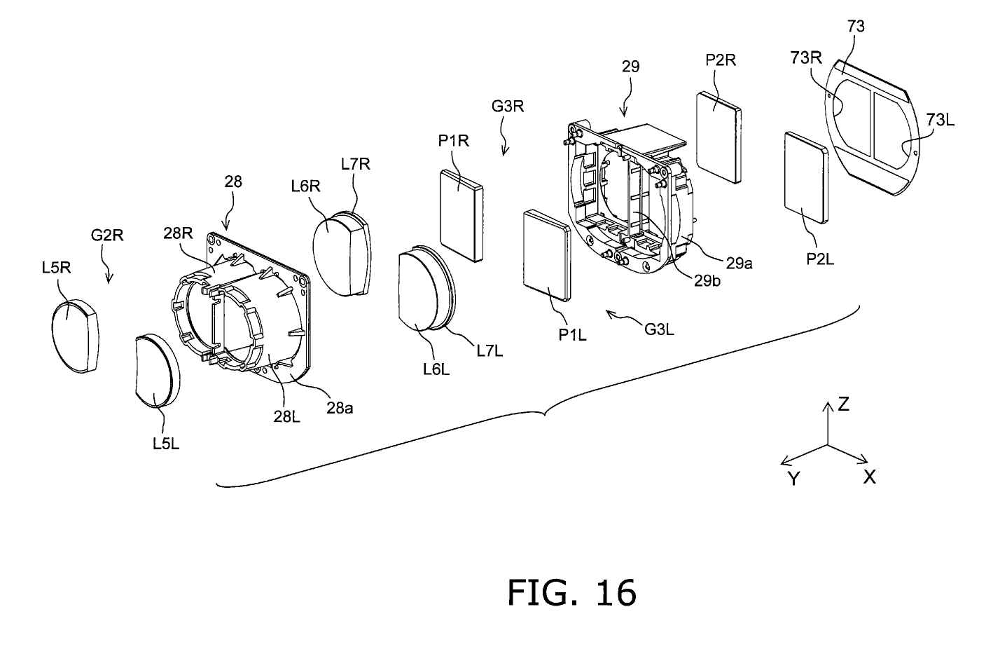

As shown in FIG. 14, the left-eye negative lens group G1L is fixed to a first adjustment frame 30 (discussed below) of the first adjustment mechanism 3, and is disposed substantially movably in the Z axis direction with respect to the left-eye positive lens group G2L, the left-eye prism group G3L, and the main body frame 2. As shown in FIG. 16, the left-eye positive lens group G2L is fixed to an intermediate lens frame 28 (discussed below). The left-eye prism group G3L is fixed to a prism support frame 29 (discussed below).

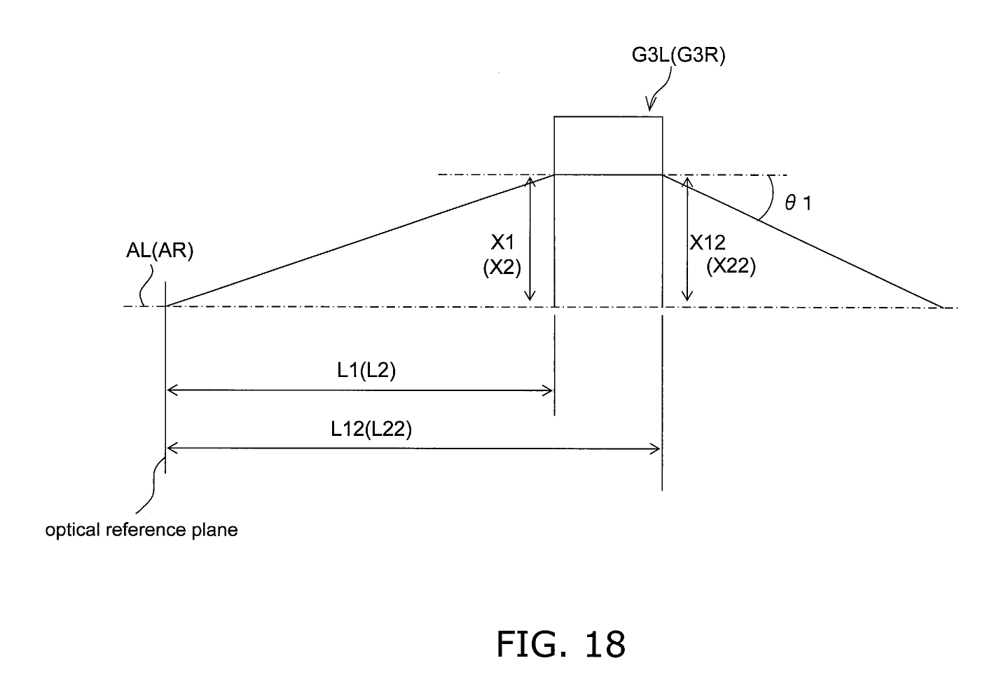

As shown in FIG. 18, the following relation (1) holds true when we let θL (an example of θ11 or θ22) be the polarization angle of the left-eye prism group G3L, θ1 be the emission angle of light transmitted by the left-eye prism group G3L, X1 be the vertical length from the left-eye optical axis AL to the point of intersection between the outermost light beam and the incident face of the left-eye prism group G3L, X12 be the vertical length from the left-eye optical axis AL to the point of intersection between the outermost light beam and the emission face of the left-eye prism group G3L, L1 be the distance from the incident face to the optical reference plane defined on the incident side of the left-eye prism group G3L (more precisely, the distance from the convergence point shown in FIG. 7 to the incident face of the left-eye prism group G3L), and L12 be the distance from the optical reference plane to the emission face (more precisely, the distance from the convergence point shown in FIG. 7 to the emission face of the left-eye prism group G3L).

θL≦{(θ1+arctan(X1/L1))²+(θ1+arctan(X12/L12))²}^{0.5}≦4×θL (1)

As shown in FIG. 18, the left-eye optical axis AL is inclined with respect to the intermediate reference plane B so as to move away from the intermediate reference plane B going toward the emission side. The light transmitted by the left-eye positive lens group G2L is refracted by the left-eye prism group G3L so as to move closer to the intermediate reference plane B.

(3) Right-Eye Optical System OR

As shown in FIG. 3, the right-eye optical system OR is an optical system for forming a right-eye optical image (an example of a first optical image or a second optical image) seen from a right-side viewpoint (an example of a first viewpoint or a second viewpoint), and has a right-eye negative lens group G1R, a right-eye positive lens group G2R, and a right-eye prism group G3R. The right-eye optical system OR is a substantially afocal optical system. For example, the focal length of the right-eye optical system OR is preferably at least 1000 mm or no more than −1000 mm.

The right-eye negative lens group G1R (an example of a second adjustment optical system, and an example of a first negative lens group or a second negative lens group) has on the whole a negative focal length (also called a negative refractive power), and has a first lens L1R, a second lens L2R, a third lens L3R, and a fourth lens L4R. The right-eye negative lens group G1R is disposed the farthest on the subject side in the right-eye optical system OR (at a position that is closest to the subject). The first lens L1R has a negative focal length. The second lens L2R has a negative focal length. The third lens L3R has a positive focal length (also called a positive refractive power). The fourth lens L4R has a negative focal length and is joined to the third lens L3R. The combined focal length of the right-eye negative lens group G1R is negative. The effective radius of the right-eye negative lens group G1R is smaller than the effective radius of the right-eye positive lens group G2R.

As shown in FIG. 3, the right-eye positive lens group G2R (an example of a first positive lens group or a second positive lens group) is a lens group that receives light transmitted by the right-eye negative lens group G1R, and is disposed on the opposite side of the right-eye negative lens group G1R from the subject. The right-eye positive lens group G2R is disposed between the right-eye negative lens group G1R and the right-eye prism group G3R.

The right-eye positive lens group G2R has a fifth lens L5R, a sixth lens L6R, and a seventh lens L7R. The fifth lens L5R has a positive focal length. The sixth lens L6R has a positive focal length. The seventh lens L7R has a negative focal length and is joined to the sixth lens L6R.

As shown in FIG. 3, since light transmitted by the right-eye negative lens group G1R diverges, the optically effective region of the incident face of the right-eye positive lens group G2R is larger than the optically effective region of the emission face of the right-eye negative lens group G1R. Accordingly, the effective radius of the right-eye positive lens group G2R is larger than the effective radius of the right-eye negative lens group G1R. Also, the right-eye positive lens group G2R has a substantially semicircular shape in order to move the left-eye optical axis AL and right-eye optical axis AR closer together. More specifically, the inner side of the right-eye positive lens group G2R (the right-eye optical axis AR side, and the intermediate reference plane B side) is cut in a straight line (see FIG. 14). This allows the stereo base to be made smaller, and allows the convergence angle formed by the left-eye optical axis AL and the right-eye optical axis AR to be reduced. This also makes it easier to set the convergence angle formed by the left-eye optical axis AL and the right-eye optical axis AR to the proper value.

As shown in FIG. 3, the right-eye optical axis AR is defined by the right-eye negative lens group G1R and the right-eye positive lens group G2R. More specifically, the right-eye optical axis AR is defined by a line that passes through the principal point of the right-eye negative lens group G1R and the principal point of the right-eye positive lens group G2R. The left-eye optical axis AL and the right-eye optical axis AR are disposed so as to be farther apart going from the subject side toward the CMOS image sensor 110 side.

The right-eye prism group G3R (an example of a first prism group or a second prism group) is a lens group that receives the light transmitted by the right-eye positive lens group G2R, and has a second front prism P1R and a second rear prism P2R. The second front prism P1R and the second rear prism P2R are refracting wedge prisms. The right-eye prism group G3R refracts light transmitted by the right-eye positive lens group G2R so that light transmitted by the right-eye positive lens group G2R will be guided to the optical system V (an example of a uniaxial optical system) of the video camera 200. More specifically, light transmitted by the right-eye positive lens group G2R is refracted inward (closer to the intermediate reference plane B) by the right-eye prism group G3R. The second front prism P1R refracts light transmitted by the right-eye positive lens group G2R inward (closer to the intermediate reference plane B). The second rear prism P2R refracts light transmitted by the second front prism P1R outward (away from the intermediate reference plane B). The main function of the second front prism P1R is to refract light transmitted by the right-eye positive lens group G2R inward, and the main function of the second rear prism P2R is to correct color dispersion caused by refraction. The combined polarization angle of the right-eye prism group G3R is approximately 1.7 degrees, for example.

As shown in FIG. 14, the right-eye negative lens group G1R is fixed to a second adjustment frame 40 (discussed below) of the second adjustment mechanism 4, and is disposed substantially movably in the Z axis direction with respect to the right-eye positive lens group G2R, the right-eye prism group G3R, and the main body frame 2. As shown in FIG. 16, the right-eye positive lens group G2R is fixed to the intermediate lens frame 28 (discussed below). The right-eye prism group G3R is fixed to the prism support frame 29 (discussed below).

As shown in FIG. 18, the following relation (2) holds true when we let θR (an example of θ11 or θ22) be the polarization angle of the right-eye prism group G3R, θ2 be the emission angle of light transmitted by the right-eye prism group G3R, X2 be the vertical length from the right-eye optical axis AR to the point of intersection between the outermost light beam and the incident face of the right-eye prism group G3R, X22 be the vertical length from the right-eye optical axis AR to the point of intersection between the outermost light beam and the emission face of the right-eye prism group G3R, L2 be the distance from the incident face to the optical reference plane defined on the incident side of the right-eye prism group G3R (more precisely, the distance from the convergence point shown in FIG. 7 to the incident face of the right-eye prism group G3R), and L22 be the distance from the optical reference plane to the emission face (more precisely, the distance from the convergence point shown in FIG. 7 to the emission face of the right-eye prism group G3R).

θR≦{(θ2+arctan(X2/L2))²+(θ2+arctan(X22/L22))²}^{0.5}≦4×θR (2)

As shown in FIG. 18, the right-eye optical axis AR is inclined with respect to the intermediate reference plane B so as to move away from the intermediate reference plane B going toward the emission side. The light transmitted by the right-eye positive lens group G2R is refracted by the right-eye prism group G3R so as to move closer to the intermediate reference plane B.

(4) Main Body Frame 2

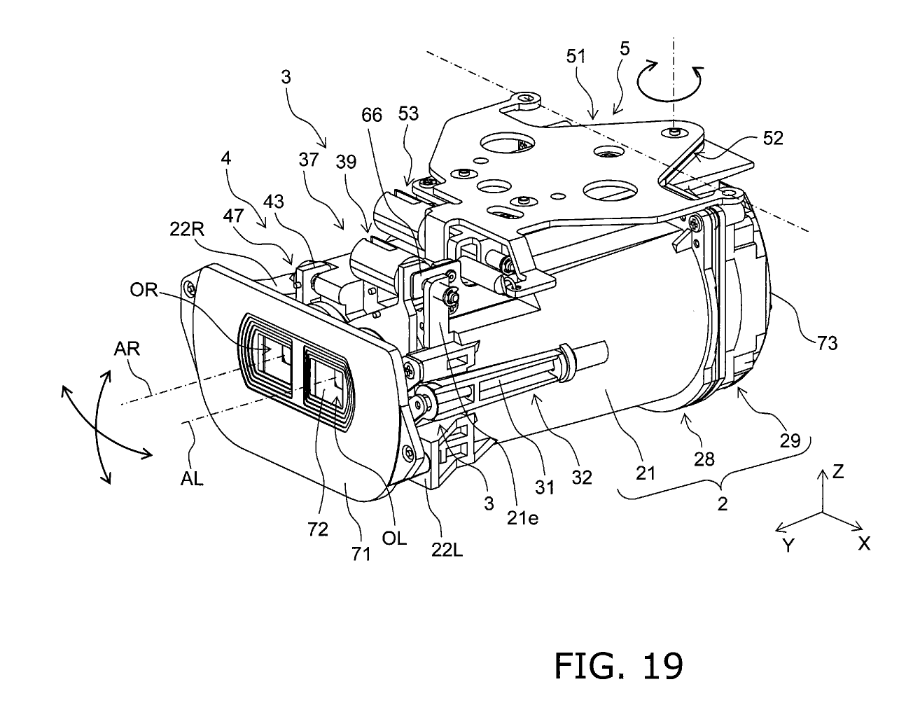

As shown in FIG. 19, the main body frame 2 supports the entire left-eye optical system OL and the entire right-eye optical system OR, and is disposed inside the exterior part 101 movably with respect to the exterior part 101 in the Z axis direction (first direction) and the X axis direction (second direction). When the main body frame 2 moves in the Z axis direction with respect to the exterior part 101, the entire left-eye optical system OL and the entire right-eye optical system OR move in the Z axis direction with respect to the exterior part 101. Also, when the main body frame 2 moves in the X axis direction with respect to the exterior part 101, the entire left-eye optical system OL and the entire right-eye optical system OR move in the Z axis direction with respect to the exterior part 101. The “movement” of the main body frame 2 with respect to the exterior part 101 here can include parallel movement, rotational movement, and rotation.

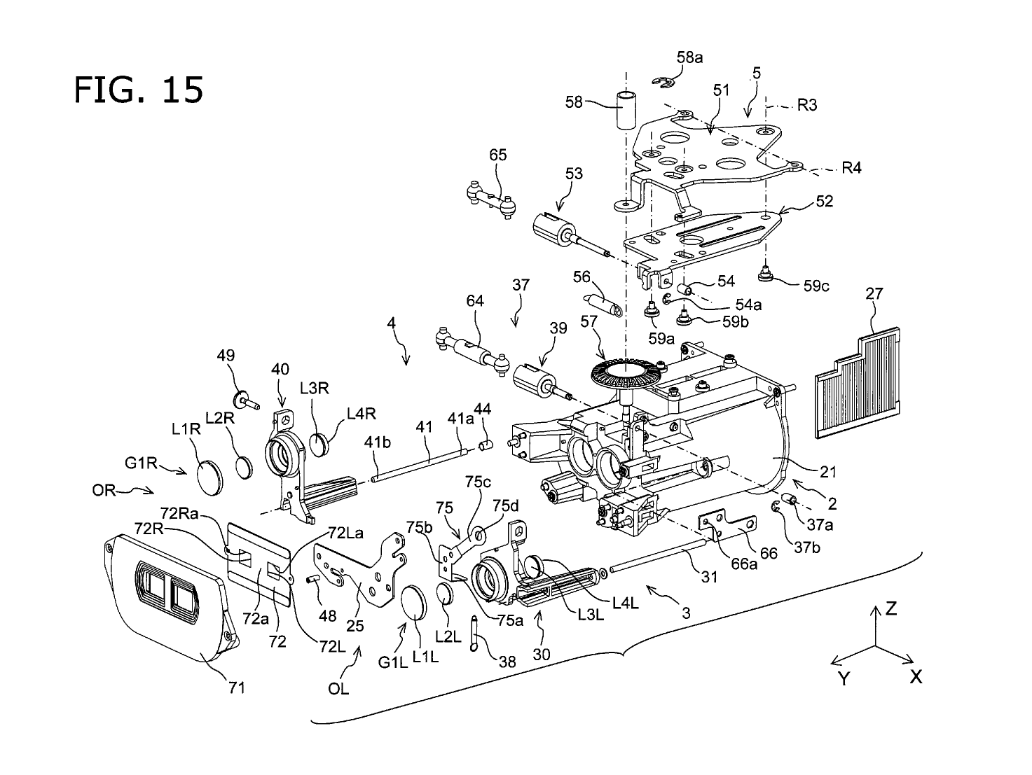

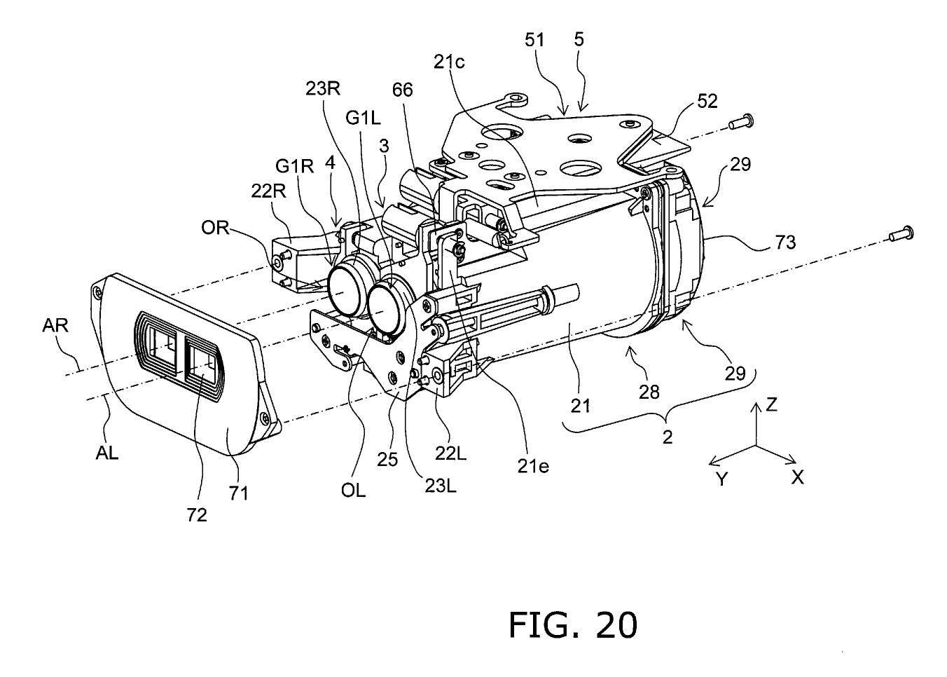

More specifically, as shown in FIG. 20, the main body frame 2 has a cylindrical frame 21, a first fixing component 22L, a second fixing component 22R, a left-eye cylindrical component 23L, a right-eye cylindrical component 23R, a seat component 21c, a light blocking panel 27 (see FIG. 15), the intermediate lens frame 28, the prism support frame 29, a front panel 71, and a rear panel 73. The cylindrical frame 21, the first fixing component 22L, the second fixing component 22R, the left-eye cylindrical component 23L, the right-eye cylindrical component 23R, and the seat component 21c are integrally molded from plastic.

The cylindrical frame 21 is disposed inside the exterior part 101, and is linked to the exterior part 101 by the third adjustment mechanism 5. The left-eye positive lens group G2L and the right-eye positive lens group G2R are disposed inside the cylindrical frame 21. The first fixing component 22L, the second fixing component 22R, the left-eye cylindrical component 23L, and the right-eye cylindrical component 23R are disposed on the front side (subject side) of the cylindrical frame 21. The seat component 21c is disposed on the top side of the cylindrical frame 21.

As shown in FIG. 20, the front panel 71 is fixed to the first fixing component 22L and the second fixing component 22R. The left-eye cylindrical component 23L is disposed at a position corresponding to the left-eye negative lens group G1L. The light transmitted by the left-eye negative lens group G1L is taken in through the left-eye cylindrical component 23L into the cylindrical frame 21. The right-eye cylindrical component 23R is disposed at a position corresponding to the right-eye negative lens group G1R. The light transmitted by the right-eye negative lens group G1R is taken in through the right-eye cylindrical component 23R into the cylindrical frame 21. A second linking plate 52 (discussed below) of the third adjustment mechanism 5 is fixed to the seat component 21c.

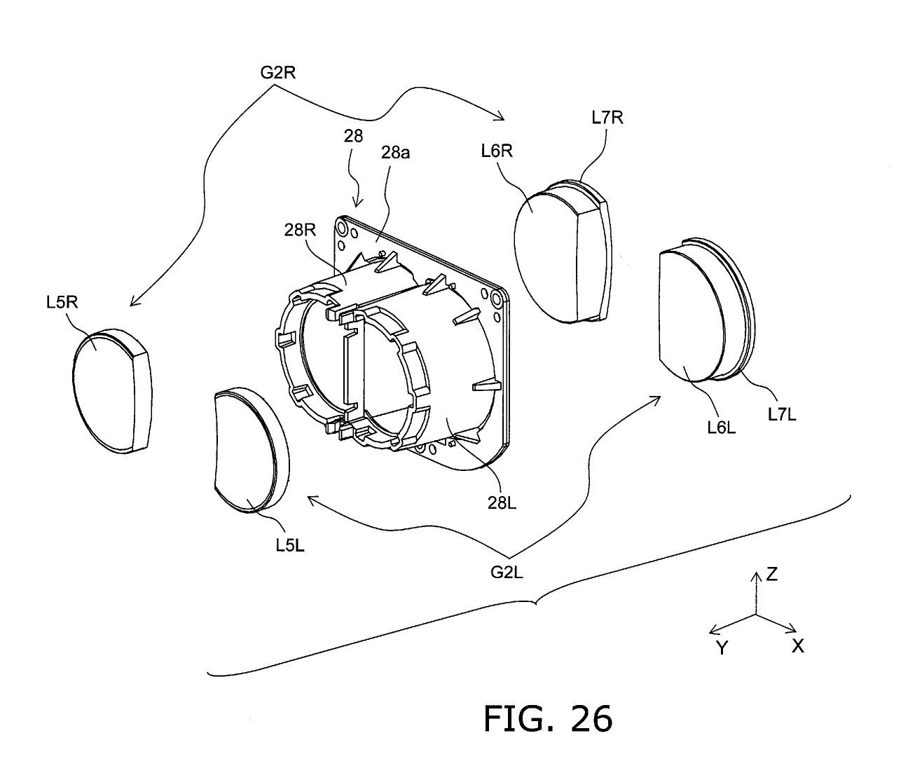

As shown in FIG. 26, the left-eye positive lens group G2L and the right-eye positive lens group G2R are fixed to the intermediate lens frame 28. More specifically, the intermediate lens frame 28 has a flange 28a, a first intermediate frame 28L, and a second intermediate frame 28R. The first intermediate frame 28L is a cylindrical portion that protrudes from the flange 28a. The second intermediate frame 28R is also a cylindrical portion that protrudes from the flange 28a. The fifth lens L5L and the sixth lens L6L of the left-eye positive lens group G2L are fixed to the first intermediate frame 28L. The fifth lens L5R and the sixth lens L6R of the right-eye positive lens group G2R are fixed to the second intermediate frame 28R.

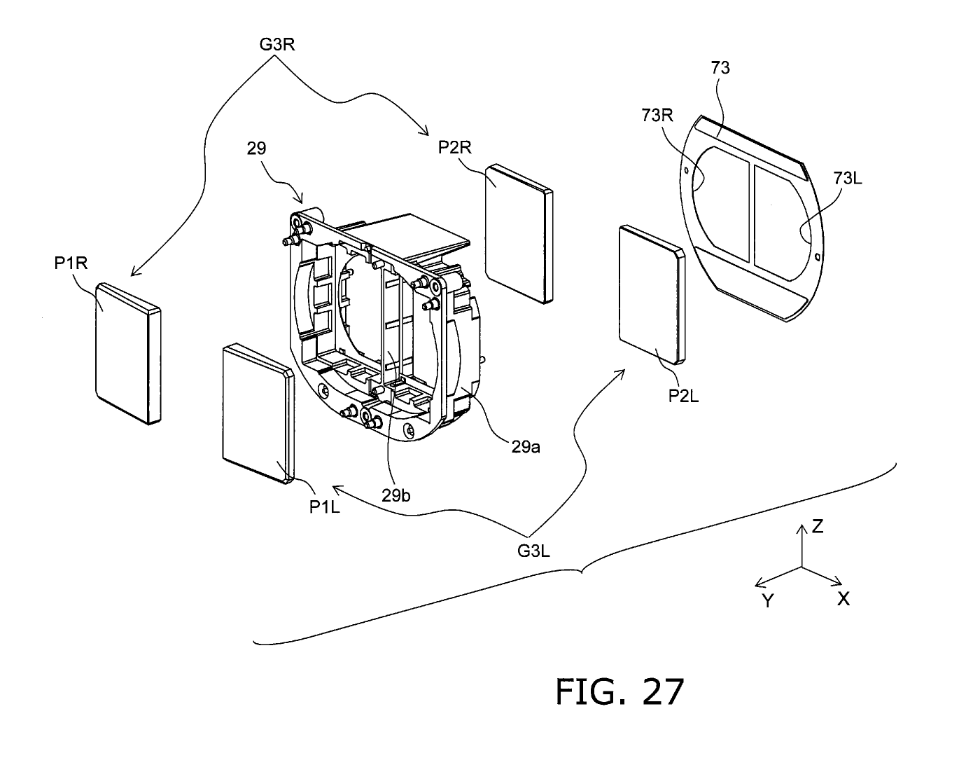

As shown in FIG. 27, the left-eye prism group G3L and the right-eye prism group G3R are fixed to the prism support frame 29. More specifically, the prism support frame 29 has an annular support frame main body 29a and a partition 29b. The first front prism P1L and the first rear prism P2L are fixed to the support frame main body 29a and the partition 29b. The second front prism P1R and the second rear prism P2R fit into the support frame main body 29a, and are fixed to the support frame main body 29a and the partition 29b.

The rear panel 73 is fixed behind the prism support frame 29. The rear panel 73 has a first opening 73L and a second opening 73R. The light transmitted by the left-eye optical system OL passes through the first opening 73L. The light transmitted by the right-eye optical system OR passes through the second opening 73R.

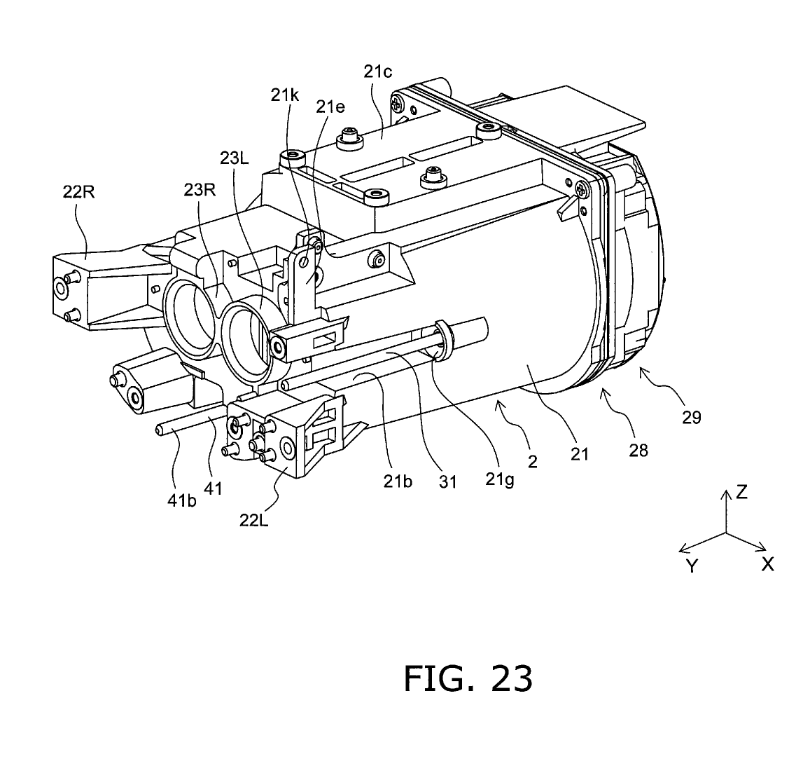

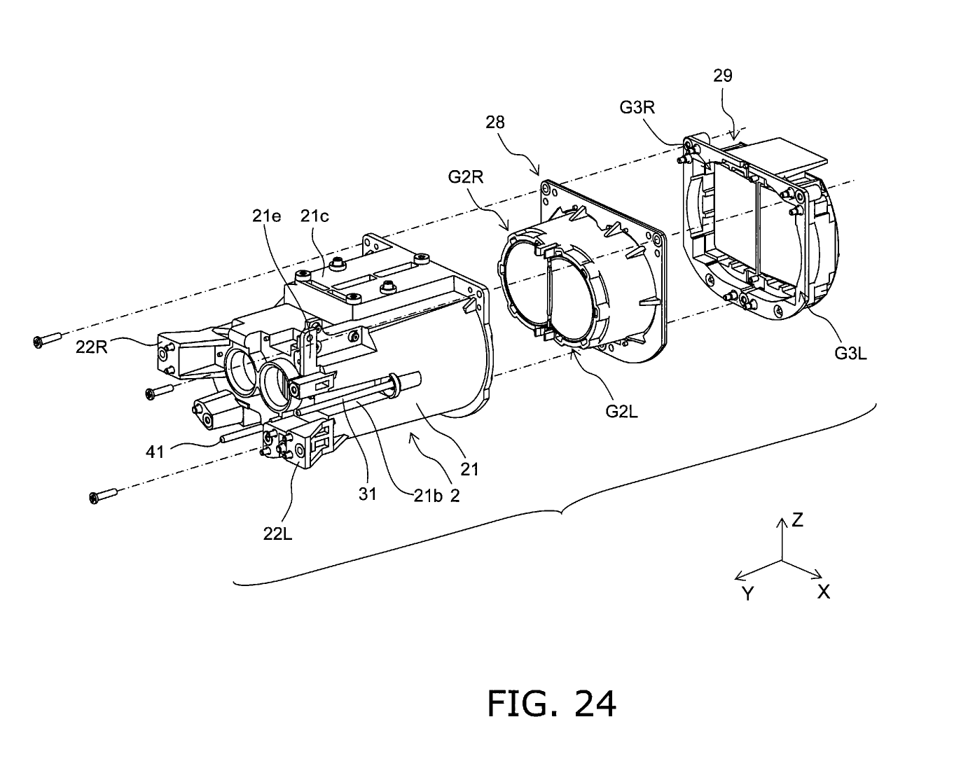

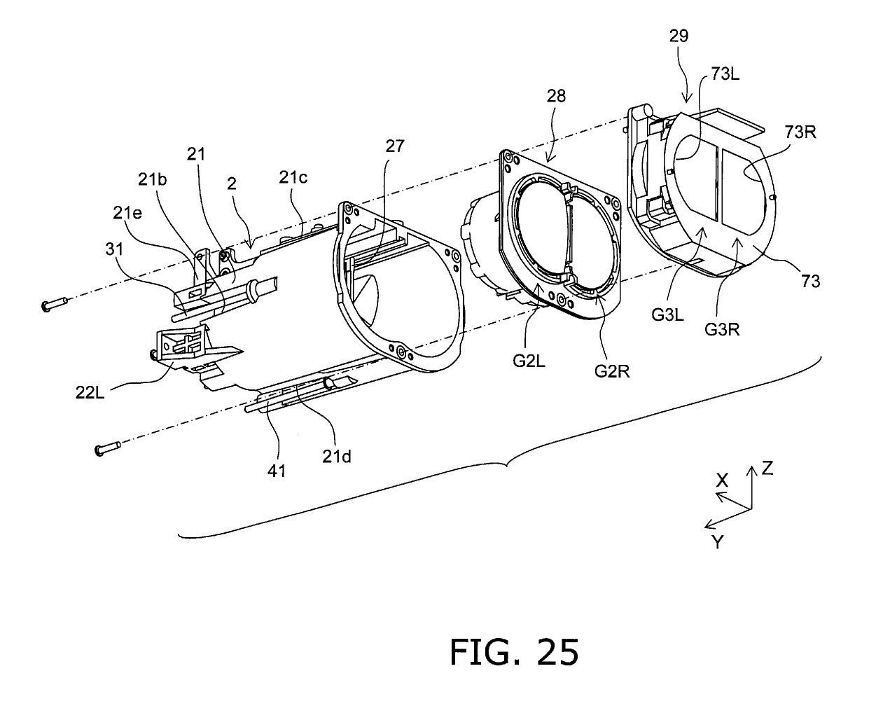

As shown in FIGS. 24 and 25, the intermediate lens frame 28 and the prism support frame 29 are fixed by screws behind the cylindrical frame 21. Part of the intermediate lens frame 28 is inserted into the cylindrical frame 21. As shown in FIG. 25, the light blocking panel 27 is mounted in the interior of the cylindrical frame 21. The space inside the cylindrical frame 21 is partitioned by the light blocking panel 27. FIG. 23 shows how the intermediate lens frame 28 and the prism support frame 29 are fixed to the cylindrical frame 21.

(5) First Adjustment Mechanism 3

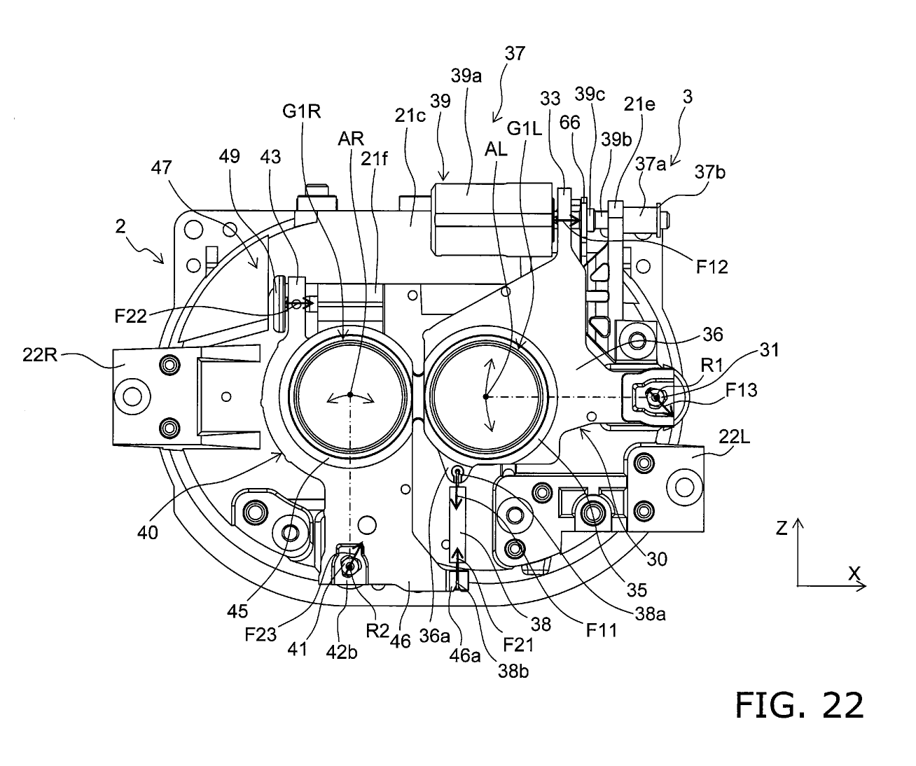

The first adjustment mechanism 3 shown in FIG. 22 is a mechanism for adjusting vertical relative offset of the left-eye optical image QL1 and the right-eye optical image QR1, and moves the left-eye negative lens group G1L in substantially the Z axis direction (the first direction, the second adjustment direction) with respect to the main body frame 2 according to user operation. The first adjustment mechanism 3 has the first adjustment frame 30, a first rotational shaft 31, an adjusting spring 38, and a first restricting mechanism 37.

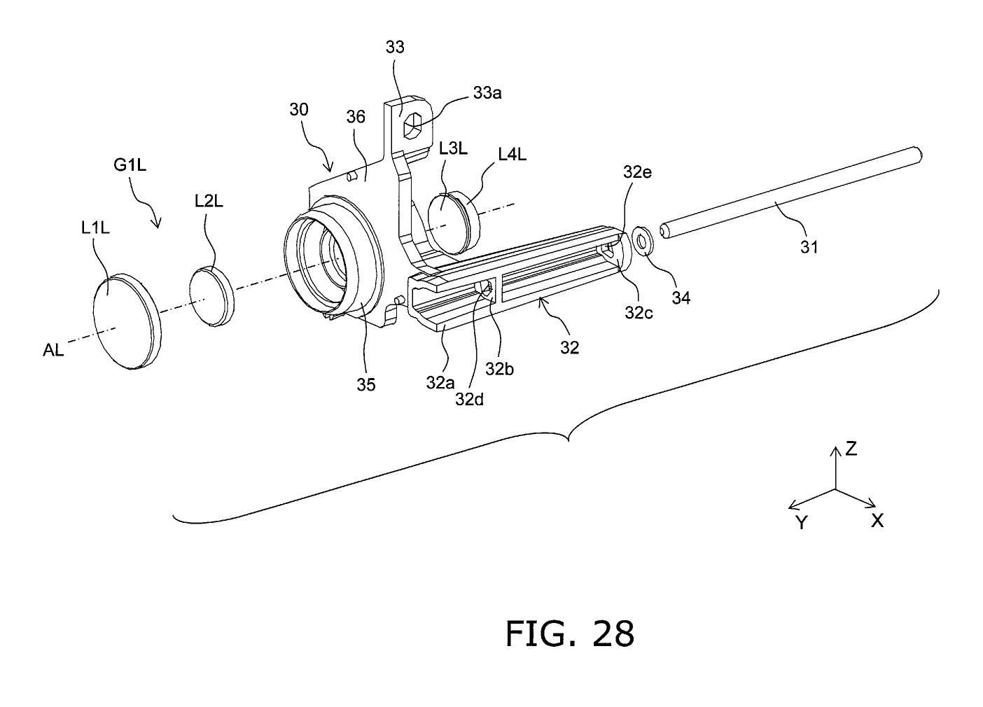

As shown in FIG. 28, the first adjustment frame 30 is supported by the main body frame 2 movably in substantially the Z axis direction (first direction). The first adjustment frame 30 has a first adjustment frame main body 36, a first cylindrical component 35, a first restrictor 33, and a first guide component 32.

The first adjustment frame main body 36 is a plate-shaped portion. The first cylindrical component 35 protrudes in the Y axis direction from the first adjustment frame main body 36. The left-eye negative lens group G1L is fixed to the first cylindrical component 35. The first restrictor 33 is a plate-shaped portion that protrudes in the Z axis direction from the first adjustment frame main body 36, and constitutes part of the first restricting mechanism 37. The first restrictor 33 has a first hole 33a.

The first guide component 32 extends in a slender shape in the Y axis direction, and protrudes in the Y axis direction from the first adjustment frame main body 36. The first guide component 32 has a first guide component main body 32a, a first front support 32b, and a first rear support 32c. The first guide component main body 32a has a substantially U-shaped cross section. The first front support 32b and the first rear support 32c are disposed inside the first guide component main body 32a. The first front support 32b has a first front support hole 32d. The first rear support 32c has a first rear support hole 32e.

The first rotational shaft 31 (an example of a rotational support shaft) rotatably links the first adjustment frame 30 to the main body frame 2. More specifically, the first rotational shaft 31 is inserted into the first front support hole 32d and the first rear support hole 32e of the first guide component 32 of the first adjustment frame 30. As shown in FIG. 22, if we let the center line of the first rotational shaft 31 be a first rotational axis R1, the first adjustment frame 30 is supported by the first rotational shaft 31 rotatably around the first rotational axis R1. Consequently, the left-eye negative lens group G1L is able to rotate around the first rotational axis R1 with respect to the main body frame 2.

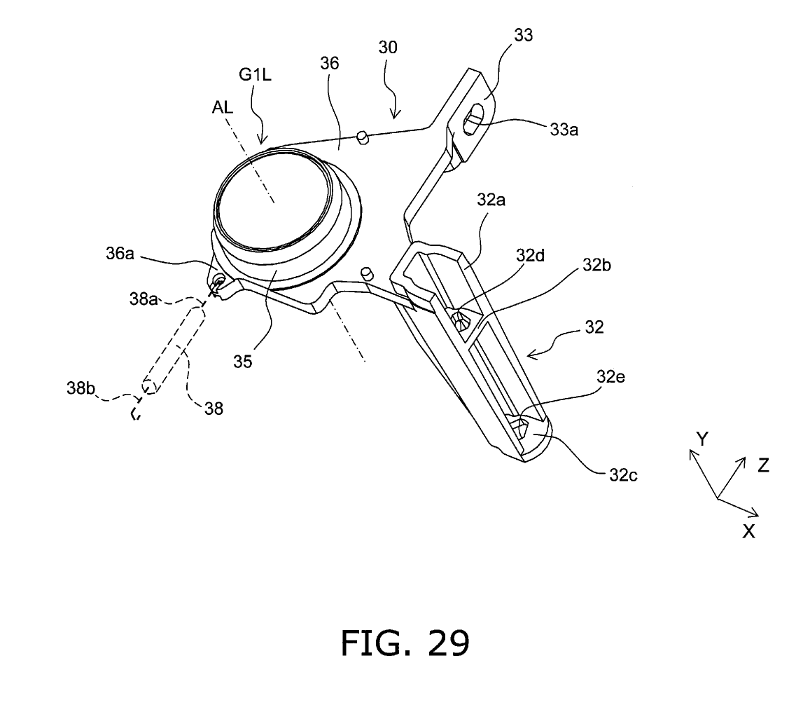

As shown in FIG. 29, the first adjustment frame main body 36 has a first hooking component 36a. A first end 38a of the adjusting spring 38 is hooked to the first hooking component 36a.

As shown in FIG. 23, the end of the first rotational shaft 31 is fixed to the cylindrical frame 21. A first recess 21b is formed in the cylindrical frame 21. The first recess 21b is a groove extending in the Y axis direction. The first guide component 32 of the first adjustment frame 30 is inserted into the first recess 21b. A first washer 34 (see FIG. 28) is sandwiched between the first guide component 32 and the cylindrical frame 21.

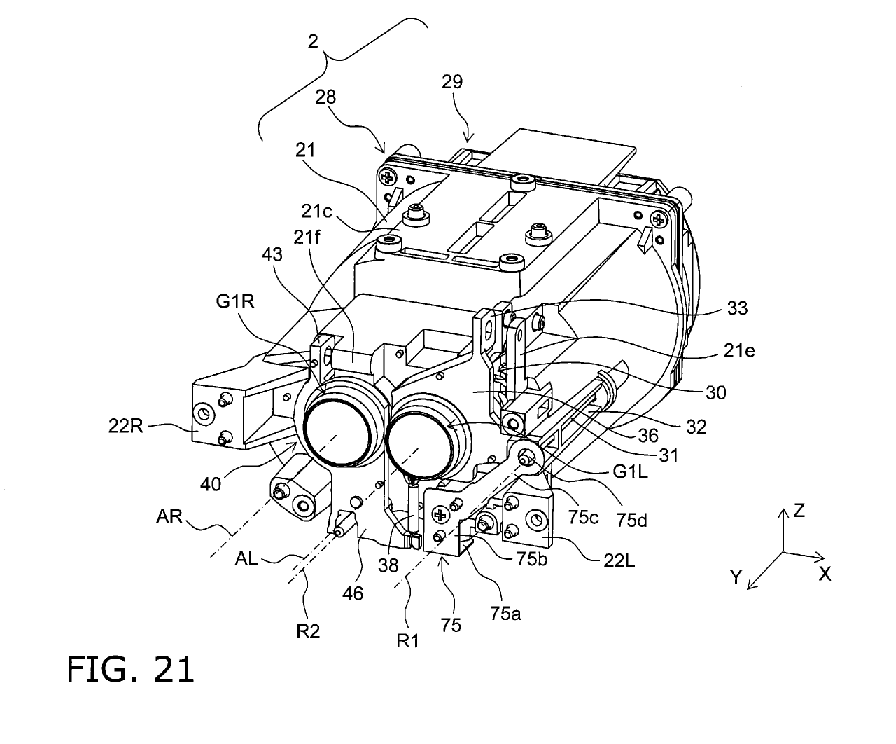

As shown in FIG. 21, the first adjustment frame 30 is held down in the Y axis direction by a hold-down plate 75. More specifically, the hold-down plate 75 has a fixed component 75b that is fixed to the main body frame 2, a first leaf spring 75c that protrudes from the fixed component 75b, and a second leaf spring 75a that protrudes from the fixed component 75b. The first leaf spring 75c has a through-hole 75d, and the distal end of the first rotational shaft 31 is inserted into this through-hole 75d. The first leaf spring 75c is bent slightly in the Y axis direction, and presses the first guide component 32 toward the Y axis direction negative side. This suppresses movement of the first adjustment frame 30 in the Y axis direction with respect to the main body frame 2. The second leaf spring 75a extends to the Y axis direction negative side from the fixed component 75b, and goes in on the bottom side of the main body frame 2. When the main body frame 2 moves to the Z axis direction negative side (bottom side) with respect to the exterior part 101, the second leaf spring 75a restricts the downward movement of the main body frame 2 with respect to the exterior part 101 so that the threaded component 57c of the vertical position adjustment dial 57 does not fall out of the threaded hole of a dial support 51c. This prevents malfunction caused by turning the vertical position adjustment dial 57 too far.

As shown in FIG. 23, the first recess 21b has a bowl-shaped alignment component 21g. Although not depicted in the drawings, the end of the first guide component 32 has a shape that is complementary with the alignment component 21g. When the end of the first guide component 32 is fitted into the alignment component 21g, the position of the first guide component 32 in the X axis direction and Z axis direction is stabilized. Since the first guide component 32 is pressed against the alignment component 21g by the hold-down plate 75 (see FIG. 21), the position of the first adjustment frame 30 with respect to the main body frame 2 is further stabilized.

As shown in FIG. 22, the first rotational shaft 31 is disposed aligned in the X axis direction with the left-eye optical system OL and the right-eye optical system OR. More specifically, the left-eye optical system OL is disposed between the right-eye optical system OR and the first rotational shaft 31. The first rotational axis R1 is disposed aligned substantially in a straight line with the left-eye optical axis AL and the right-eye optical axis AR. Since the first rotational shaft 31 is disposed in this way, the left-eye negative lens group G1L can move substantially in the Z axis direction, and the amount of movement of the left-eye negative lens group G1L in the X axis direction can be kept within a range that can be ignored.

The adjusting spring 38 (an example of an adjusting elastic member) is a tension spring, and imparts a rotational force around the first rotational shaft 31 to the first adjustment frame 30. More specifically, the adjusting spring 38 imparts an elastic force F11 to the first adjustment frame 30 toward the Z axis direction negative side (bottom side) when side from the subject side. As a result, the adjusting spring 38 imparts a counter-clockwise rotational force to the first adjustment frame 30. The adjusting spring 38 elastically links the first adjustment frame 30 and the second adjustment frame 40 (discussed below). The first end 38a of the adjusting spring 38 is hooked to the first hooking component 36a of the first adjustment frame 30. A second end 38b of the adjusting spring 38 is hooked to a second hooking component 46a (discussed below) of the second adjustment frame 40.

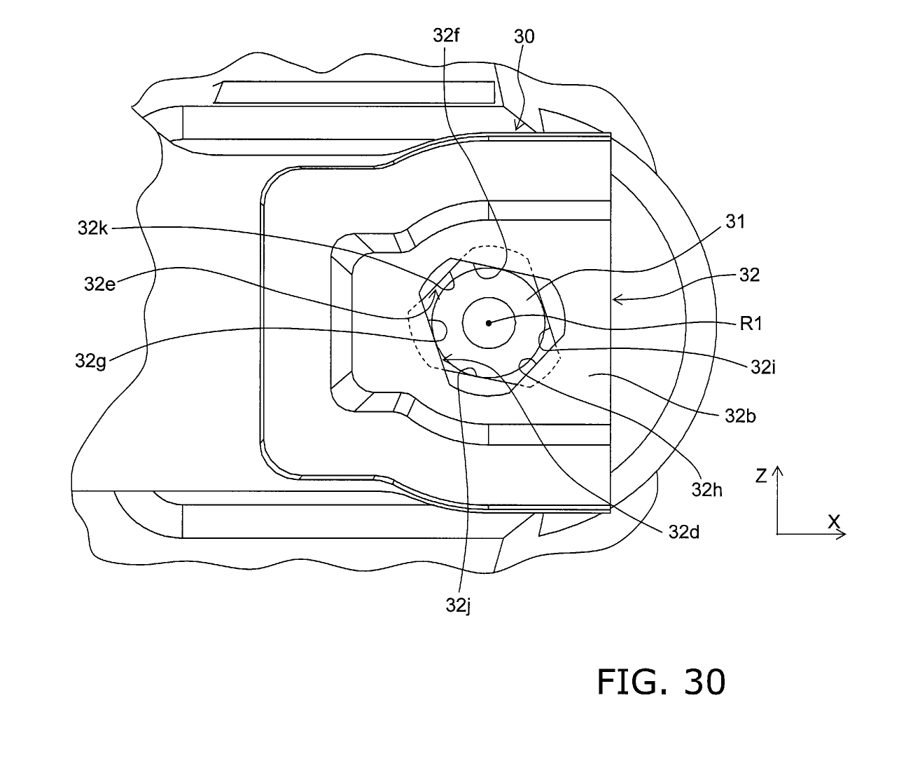

As shown in FIG. 30, the first front support hole 32d and the first rear support hole 32e have a substantially triangular shape, rather than being circular. More specifically, the first front support hole 32d has three straight edges 32f, 32g, and 32h. These straight edges 32f, 32g, and 32h each form a side of a triangle, for example. The straight edges 32f and 32g are in contact with the first rotational shaft 31, but the straight edge 32h does not touch the first rotational shaft 31.

Meanwhile, the first rear support hole 32e has three straight edges 32i, 32j, and 32k. These straight edges 32i, 32j, and 32k each form a side of a triangle, for example. The straight edges 32i and 32j are in contact with the first rotational shaft 31, but the straight edge 32k does not touch the first rotational shaft 31.

As shown in FIG. 22, a combined force F13 of the elastic force F11 produced by the adjusting spring 38 and a reaction force F12 from the first restricting mechanism 37 is exerted on the first adjustment frame 30. Therefore, the straight edges 32f and 32g of the first front support hole 32d are pressed against the first rotational shaft 31 by this combined force F13. Along with this, the straight edges 32i and 32j of the first rear support hole 32e are pressed against the first rotational shaft 31.

Thus, the first rotational shaft 31 is positioned in the X axis direction and Z axis direction by the first front support hole 32d and the first rear support hole 32e. Therefore, looseness of the second adjustment frame 40 with respect to the main body frame 2 in the X axis direction and the Z axis direction can be suppressed.

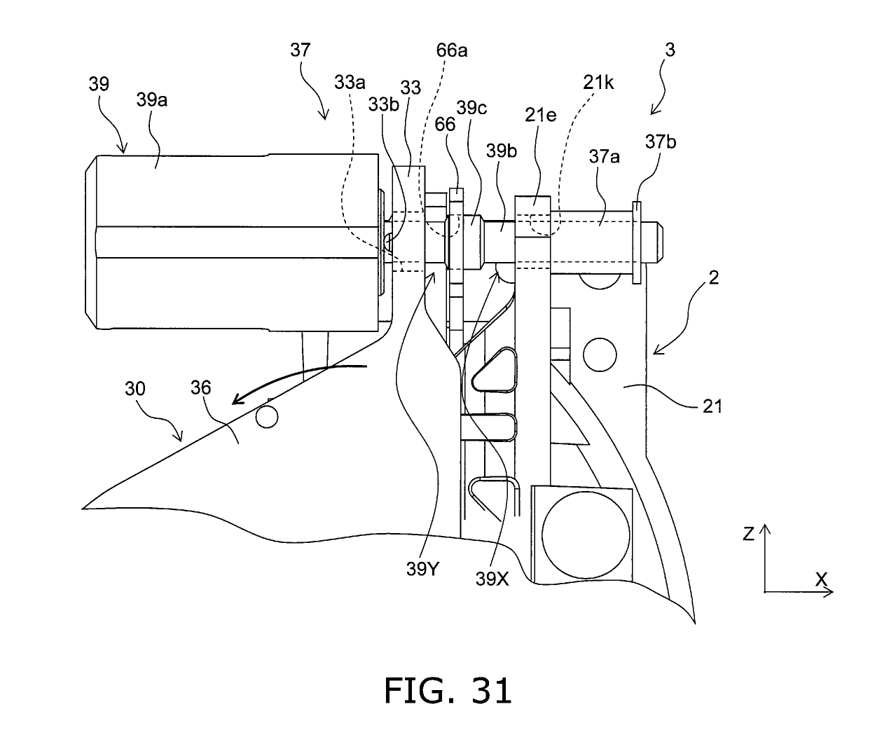

As shown in FIG. 31, the first restricting mechanism 37 (an example of a rotation restricting mechanism) is a mechanism for restricting the rotation of the first adjustment frame 30, and adjusts the position of the left-eye negative lens group G1L with respect to the main body frame 2 by changing the restriction position of the first adjustment frame 30. More specifically, it has a relative offset adjustment screw 39, a first support plate 66, a second support plate 21e, a first return spring 37a, and a first snap ring 37b. The first support plate 66 has a threaded hole 66a, and is fixed to the cylindrical frame 21. A second support plate 21e has a through-hole 21k, and is formed integrally with the cylindrical frame 21. The relative offset adjustment screw 39 has a joint component 39a and a shaft component 39b. The outside diameter of the joint component 39a is larger than the outside diameter of the shaft component 39b. The joint component 39a is mounted to the end of the shaft component 39b. The joint component 39a is linked to a second joint shaft 65 of the operation mechanism 6. The joint component 39a and the second joint shaft 65 constitute a universal joint. The shaft component 39b has a threaded component 39c. The threaded component 39c is threaded into the threaded hole 66a of the first support plate 66. When the relative offset adjustment screw 39 is rotated, the relative offset adjustment screw 39 moves in the X axis direction with respect to the main body frame 2. The shaft component 39b is inserted into the first hole 33a of the first restrictor 33 and a through-hole in the second support plate 21e. A first snap ring 37ba is mounted on the end of the shaft component 39b. The first return spring 37a is inserted into the shaft component 39b and is compressed between the second support plate 21e and the first snap ring 37b.

The first restrictor 33 of the first adjustment frame 30 comes into contact with the joint component 39a. More specifically, a pair of sliding protrusions 33b is formed on the first restrictor 33. The sliding protrusions 33b hit the joint component 39a. Since the first restrictor 33 is pressed against the joint component 39a by the elastic force of the adjusting spring 38, the rotation of the first adjustment frame 30 is restricted by the relative offset adjustment screw 39. The position of the left-eye negative lens group G1L in the Z axis direction can be adjusted by changing the restriction position of the first adjustment frame 30 in the rotational direction with the relative offset adjustment screw 39. Also, since the sliding protrusions 33b hit the joint component 39a, sliding resistance can be reduced when the relative offset adjustment screw 39 is rotated.

Since the first return spring 37a is provided, the first support plate 66 is prevented from falling completely out of the threaded component 39c if the user turns the relative offset adjustment screw 39 too far. More specifically, as shown in FIG. 22, when the first support plate 66 reaches a first side 39X of the threaded component 39c, a state in which the threaded component 39c is in contact with the threaded hole 66a of the first support plate 66 is maintained by the elastic force of the first return spring 37a. Conversely, when the first support plate 66 reaches a second side 39Y of the threaded component 39c, a state in which the threaded component 39c is in contact with the threaded hole 66a of the first support plate 66 is maintained by the elastic force of the adjusting spring 38. Consequently, even if the user turns the relative offset adjustment screw 39 too far, the first support plate 66 can be prevented from falling completely out of the threaded component 39c. Furthermore, since the threaded component 39c is disposed away from the joint component 39a, damage caused by turning too far can also be prevented.

(6) Second Adjustment Mechanism 4

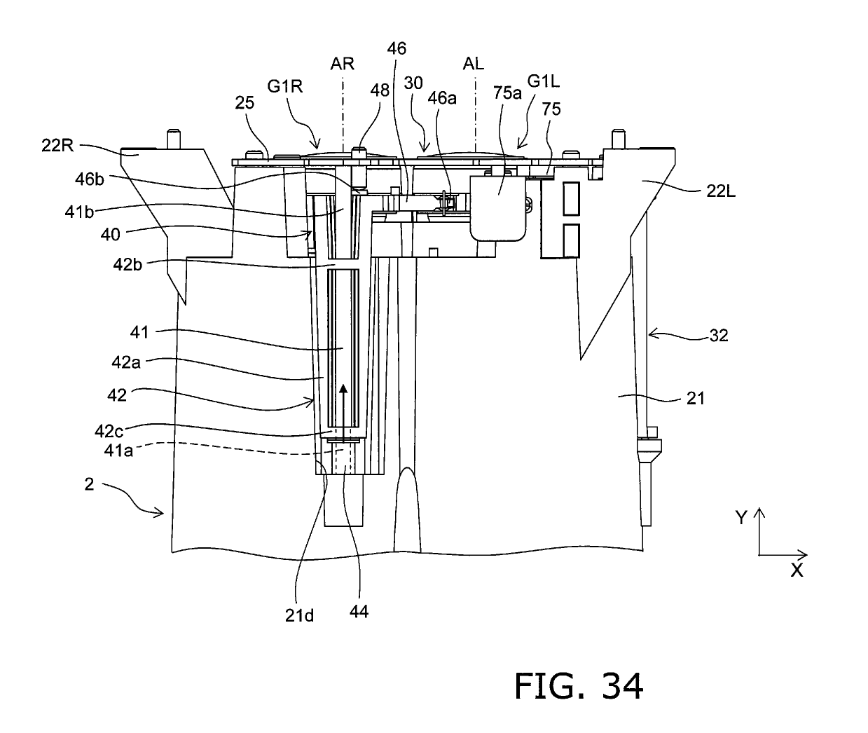

The second adjustment mechanism 4 shown in FIG. 22 is a mechanism for adjusting the convergence angle, and moves the right-eye negative lens group G1R in the X axis direction (the second direction, the first adjustment direction) with respect to the main body frame 2. The second adjustment mechanism 4 has the second adjustment frame 40, a second rotational shaft 41, a focus adjusting screw 48 (see FIG. 34), a focus adjusting spring 44 (see FIG. 34), and a second restricting mechanism 47.

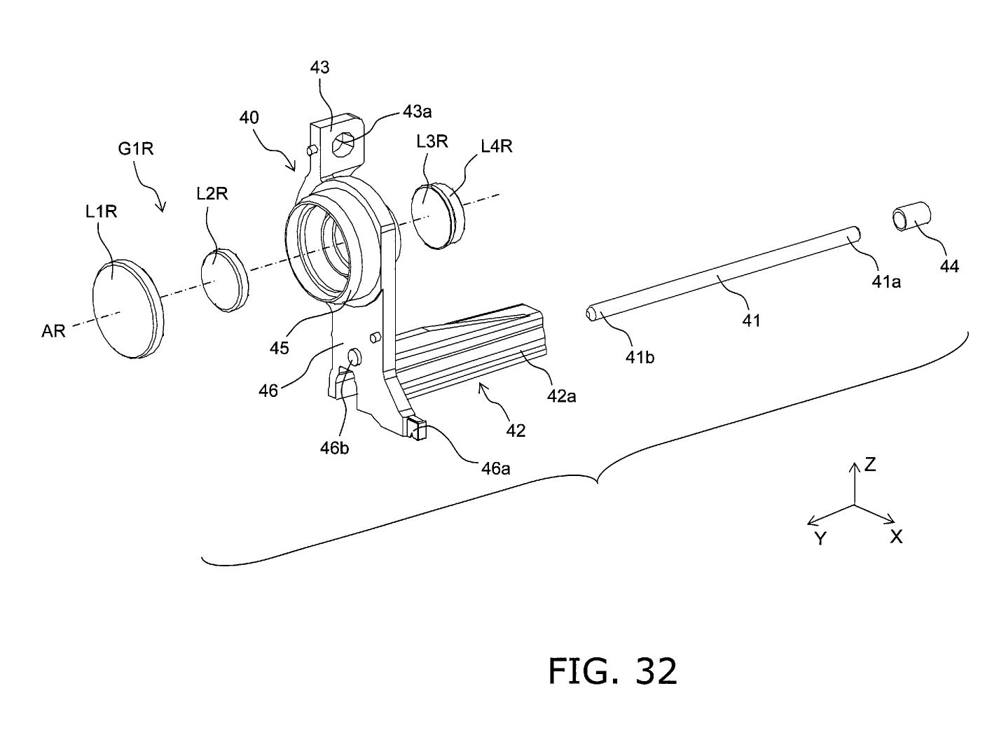

As shown in FIG. 32, the second adjustment frame 40 is supported by the main body frame 2 movably in substantially the X axis direction (first direction). The second adjustment frame 40 has a second adjustment frame main body 46, a second cylindrical component 45, a second restrictor 43, and a second guide component 42.

The second adjustment frame main body 46 is a plate-shaped portion, and has the second hooking component 46a and a protrusion 46b. The adjusting spring 38 is hooked to the second hooking component 46a. The protrusion 46b protrudes to the Y axis direction positive side (front side, subject side), and hits the focus adjusting screw 48. Since the diameter of the protrusion 46b is larger than the diameter of the focus adjusting screw 48, even if the second adjustment frame 40 rotates with respect to the main body frame 2, the focus adjusting screw 48 remains in contact with the protrusion 46b. Also, since the distal end of the focus adjusting screw 48 is formed in a hemispherical shape, the sliding resistance generated between the protrusion 46b and the focus adjusting screw 48 can be reduced.

The second cylindrical component 45 protrudes in the Y axis direction from the second adjustment frame main body 46. The right-eye negative lens group G1R is fixed to the second cylindrical component 45. The second restrictor 43 is a plate-shaped portion that protrudes in the Z axis direction from the second adjustment frame main body 46, and constitutes part of the second restricting mechanism 47. The second restrictor 43 has a second hole 43a.

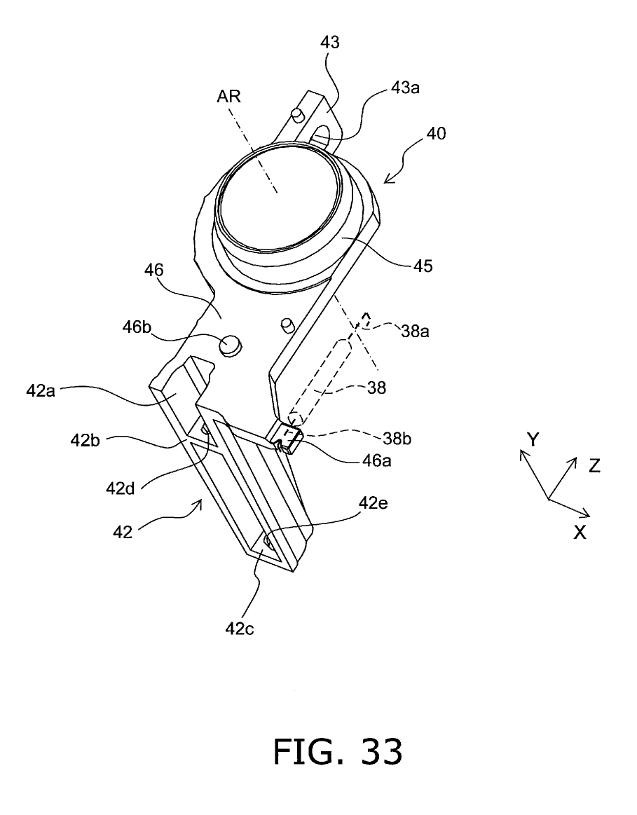

As shown in FIG. 33, the second guide component 42 extends in a slender shape in the Y axis direction, and protrudes in the Y axis direction from the second adjustment frame main body 46. The second guide component 42 has a second guide component main body 42a, a second front support 42b, and a second rear support 42c. The second guide component main body 42a has a substantially U-shaped cross section. The second front support 42b and the second rear support 42c are disposed inside the second guide component main body 42a. The second front support 42b has a second front support hole 42d. The second rear support 42c has a second rear support hole 42e.

As shown in FIG. 22, the second end 38b of the adjusting spring 38 (an example of an adjusting elastic member) is hooked to the second hooking component 46a of the second adjustment frame main body 46, and imparts a rotational force around the second rotational shaft 41 to the second adjustment frame 40. More specifically, when viewed from the subject side, the adjusting spring 38 imparts an elastic force F21 to the second adjustment frame 40 toward the Z axis direction positive side (upper side). As s result, the adjusting spring 38 imparts a counter-clockwise rotational force to the second adjustment frame 40. Since the first end 38a is hooked to the first adjustment frame 30, and the second end 38b is hooked to the second adjustment frame 40, the adjusting spring 38 can be said to link the first adjustment frame 30 and the second adjustment frame 40 elastically.

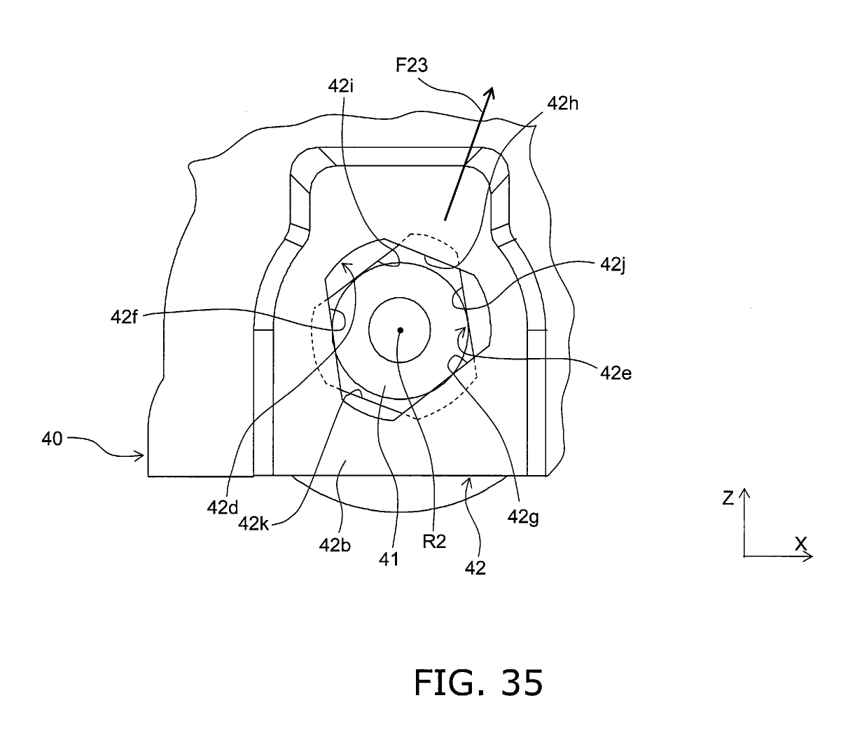

As shown in FIG. 35, the second rotational shaft 41 (an example of a rotational support shaft) rotatably links the second adjustment frame 40 to the main body frame 2. More specifically, the second rotational shaft 41 is inserted into the second front support hole 42d and the second rear support hole 42e of the second guide component 42 of the second adjustment frame 40.

As shown in FIG. 34, a second recess 21d is formed in the cylindrical frame 21. The second recess 21d is a groove extending in the Y axis direction. The second guide component 42 of the second adjustment frame 40 and the second rotational shaft 41 is inserted into the second recess 21d. The support method for the second rotational shaft 41 is double-support. A first end 41a of the second rotational shaft 41 is fixed to the cylindrical frame 21. Meanwhile, a second end 41b of the second rotational shaft 41 is supported by a front support plate 25. More specifically, the second end 41b has a shape that tapers toward the end (see FIG. 32). A support hole (not shown) is formed in the front support plate 25. The inside diameter of this support hole is smaller than the outside diameter of the second rotational shaft 41. The tapered portion of the second end 41b is inserted into the support hole. Thus, the second end 41b of the second rotational shaft 41 is supported by the front support plate 25.

As shown in FIG. 22, if we let the center line of the second rotational shaft 41 be a second rotational axis R2, then the second adjustment frame 40 is supported by the second rotational shaft 41 rotatably around the second rotational axis R2. Consequently, the right-eye negative lens group G1R is able to rotate around the second rotational axis R2 with respect to the main body frame 2.

The second adjustment mechanism 4 also has the function of adjusting the back focus of the right-eye optical system OR. More specifically, as shown in FIG. 34, the second rotational shaft 41 is inserted into the focus adjusting spring 44. The focus adjusting spring 44 is compressed between the second guide component 42 and the cylindrical frame 21, and presses the second adjustment frame 40 against the focus adjusting screw 48 mounted to the front support plate 25. The front support plate 25 is fixed to the front side of the cylindrical frame 21. The focus adjusting screw 48 is threaded into the front panel 71. The focus adjusting screw 48 restricts the movement of the second adjustment frame 40 in the Y axis direction. The position of the right-eye negative lens group G1R in the Y axis direction with respect to the main body frame 2 can be adjusted by changing the restriction position of the second adjustment frame 40. This allows the focus of the right-eye optical system OR to be adjusted. Therefore, even if the left-eye optical system OL and the right-eye optical system OR should go out of focus, for example, the left-eye optical system OL and the right-eye optical system OR can be focused at the time of shipping the product by turning the focus adjusting screw 48. Since there is no need for the user to adjust the focus of the left-eye optical system OL and the right-eye optical system OR after adjustment during shipping, the focus adjusting screw 48 is adhesively fixed, for example, to the front panel 71. However, the design may instead be such that the user can adjust the focus.

As shown in FIG. 22, the second rotational shaft 41 is disposed aligned with the right-eye optical system OR in the Z axis direction. More specifically, when viewed from the subject side, a line connecting the left-eye optical axis AL and the right-eye optical axis AR is perpendicular to a line connecting the right-eye optical axis AR and the second rotational axis R2. Since the second rotational shaft 41 is disposed in this way, the right-eye negative lens group G1R moves substantially in the X axis direction, and the amount of movement of the right-eye negative lens group G1R in the Z axis direction can be kept within a range that can be ignored. For example, if the adjustment range of the right-eye negative lens group G1R in the X axis direction is ±0.2 mm, the right-eye negative lens group G1R will move hardly at all in the Z axis direction. This configuration allows the convergence angle to be adjusted with a simple structure.

As shown in FIG. 35, the second front support hole 42d and the second rear support hole 42e have a substantially triangular shape, rather than being circular. More specifically, the second front support hole 42d has three straight edges 42f, 42g, and 42h. These straight edges 42f, 42g, and 42h each form a side of a triangle, for example. The straight edges 42f and 42g are in contact with the second rotational shaft 41, but the straight edge 42h does not touch the second rotational shaft 41.

Meanwhile, the second rear support hole 42e has three straight edges 42i, 42j, and 42k. These straight edges 42i, 42j, and 42k each form a side of a triangle, for example. The straight edges 42i and 42j are in contact with the second rotational shaft 41, but the straight edge 42k does not touch the second rotational shaft 41.

As shown in FIG. 22, a combined force F23 of the elastic force F21 produced by the adjusting spring 38 and a reaction force F22 from the second restricting mechanism 47 is exerted on the second adjustment frame 40. Therefore, the straight edges 42f and 42g of the second front support hole 42d are pressed against the second rotational shaft 41 by this combined force F23. Along with this, the straight edges 42i and 42j of the second rear support hole 42e are pressed against the second rotational shaft 41.

Thus, the second adjustment frame 40 is rotatably supported by the second rotational shaft 41 in a state in which there is little looseness with respect to the second rotational shaft 41.

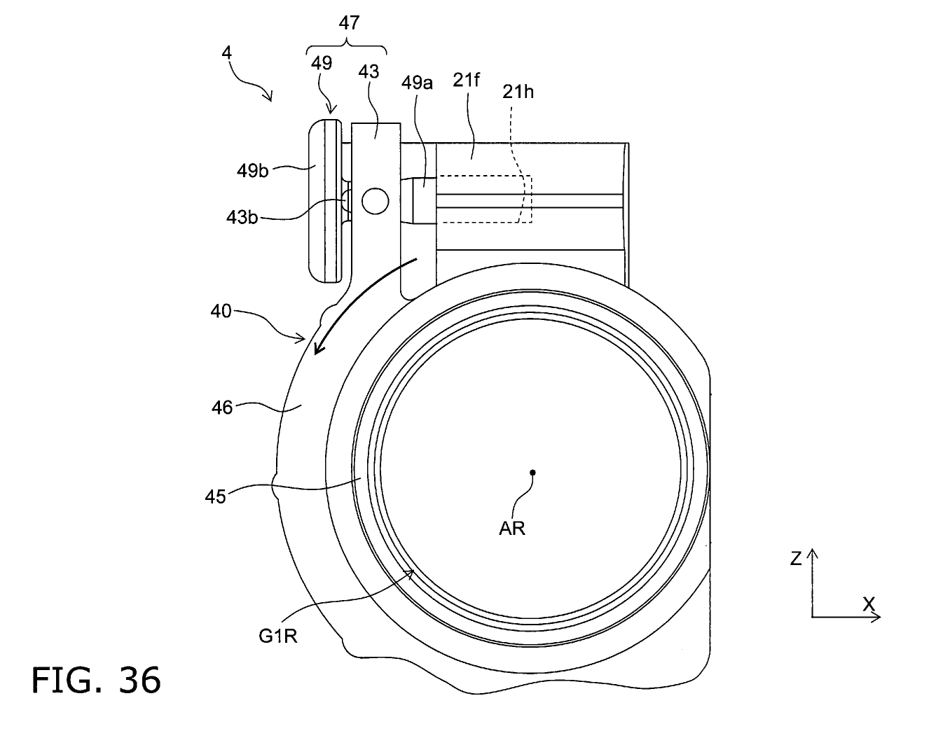

As shown in FIG. 36, the second restricting mechanism 47 (an example of a positioning mechanism) is a mechanism for restricting the rotation of the second adjustment frame 40, and the position of the right-eye negative lens group G1R with respect to the main body frame 2 is adjusted by changing the restriction position of the second adjustment frame 40. More specifically, the second restricting mechanism 47 has a convergence angle adjusting screw 49 and a support 21f.

The support 21f is formed on the cylindrical frame 21. A threaded hole 21h is formed in the support 21f. The convergence angle adjusting screw 49 has a threaded component 49a and a head component 49b. The threaded component 49a is inserted into the second hole 43a of the second restrictor 43, and is threaded into the threaded hole 21h of the support 21f. The threaded component 49a is inserted into the second hole 43a of the second restrictor 43. When the convergence angle adjusting screw 49 is rotated, the convergence angle adjusting screw 49 moves in the X axis direction with respect to the main body frame 2.

The second restrictor 43 of the second adjustment frame 40 hits the head component 49b. More specifically, a pair of sliding protrusions 43b is formed on the second restrictor 43. Since a counter-clockwise rotational force is imparted by the adjusting spring 38 to the second adjustment frame 40, the second restrictor 43 is pressed against the head component 49b, and the sliding protrusions 43b hit the head component 49b. The rotation of the second adjustment frame 40 is restricted by the convergence angle adjusting screw 49. The position of the right-eye negative lens group G1R in the X axis direction can be adjusted by changing the restriction position of the second adjustment frame 40 in the rotational direction with the convergence angle adjusting screw 49. Also, since the sliding protrusions 43b hit the head component 49b, sliding resistance can be reduced when the convergence angle adjusting screw 49 is rotated.

(7) Third Adjustment Mechanism 5

The third adjustment mechanism 5 shown in FIG. 19 is a mechanism for adjusting the positions of the left-eye optical image QL1 and the right-eye optical image QR1 in the up and down direction (the vertical direction, the pitch direction) and the left and right direction (the horizontal direction, the yaw direction) with respect to the light receiving face 110a of the CMOS image sensor 110. The up and down position and the left and right position of the left-eye optical image QL1 and the right-eye optical image QR1 can be adjusted with the third adjustment mechanism 5 by moving the left-eye optical system OL and the right-eye optical system OR with respect to the exterior part 101.

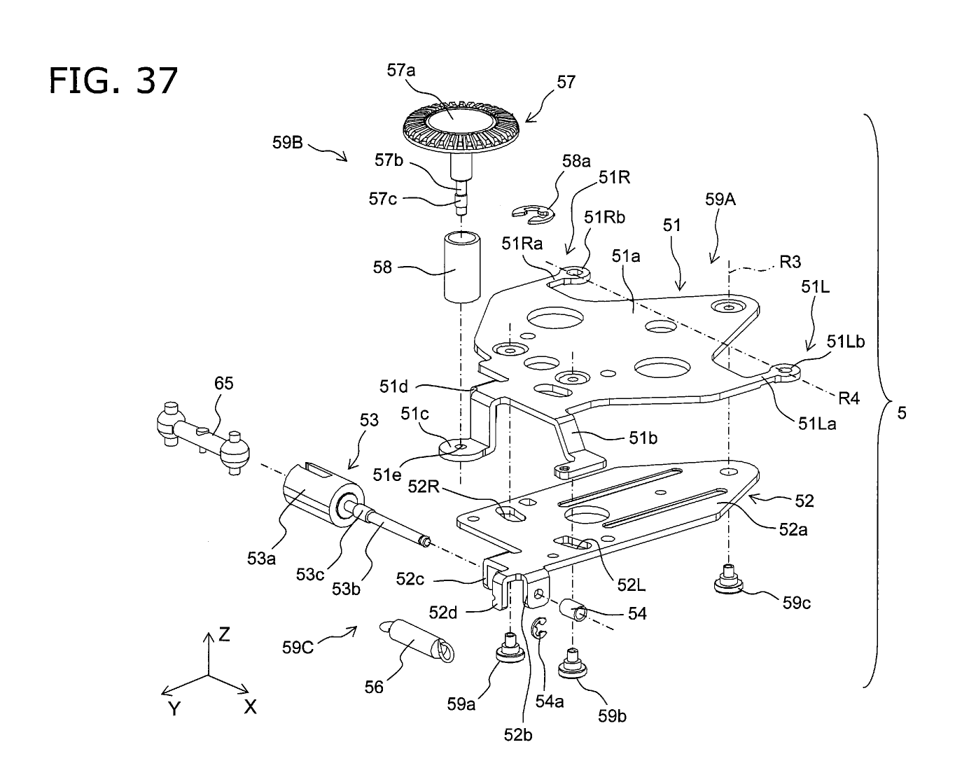

More specifically, as shown in FIG. 37, the third adjustment mechanism 5 has an elastic linking mechanism 59A, a first movement restricting mechanism 59B, and a second movement restricting mechanism 59C.

The elastic linking mechanism 59A is a mechanism that imparts a force in the Z axis direction (the second adjustment direction) to the main body frame 2, and links the main body frame 2 to the exterior part 101 rotatably around a rotational axis R4. In this embodiment, the elastic linking mechanism 59A imparts a force to the Z axis direction negative side (bottom side) to the main body frame 2.

The elastic linking mechanism 59A also imparts a force to the X axis direction (the first adjustment direction) to the main body frame 2, and links the main body frame 2 to the exterior part 101 rotatably around a rotational axis R3 (an example of an optical system rotational axis). In this embodiment, the elastic linking mechanism 59A imparts a force to the X axis direction negative side to the main body frame 2.

The rotational axis R3 here is disposed parallel to the Z axis. The rotational axis R4 is disposed substantially parallel to the X axis direction, and can be defined by the area around a first elastic support 51L and a second elastic support 51R of a first linking plate 51.

The elastic linking mechanism 59A has the first linking plate 51, the second linking plate 52, a first linking spring 56, and a second linking spring 58. The first linking plate 51 elastically links the main body frame 2 to the exterior part 101, and is fixed to the exterior part 101. More specifically, the first linking plate 51 has a first main body component 51a, the first elastic support 51L, the second elastic support 51R, a first support arm 51b, a first contact component 51d, and the dial support 51c.

The first elastic support 51L protrudes to the Y axis direction negative side from the first main body component 51a, and is fixed to the exterior part 101. The second elastic support 51R protrudes to the Y axis direction negative side from the first main body component 51a, and is fixed to the exterior part 101. In this embodiment, the first elastic support 51L has substantially the same shape as the second elastic support 51R.

The first elastic support 51L has a first fixing component 51Lb and a first elastic component 51La. The first fixing component 51Lb is fixed to the exterior part 101. More precisely, the first fixing component 51Lb is fixed to the upper case 11 via an intermediate plate 11L (see FIG. 10). The first elastic component 51La elastically links the first fixing component 51Lb and the first main body component 51a. The first elastic component 51La is compressed in the Z axis direction by stamping, for example, and the first elastic component 51La is thinner than the first fixing component 51Lb and the first main body component 51a. Therefore, the stiffness of the first elastic component 51La (more precisely, the stiffness in the Z axis direction) is much lower than that of the first main body component 51a.

The second elastic support 51R has a second fixing component 51Rb and a second elastic component 51Ra. The second fixing component 51Rb is fixed to the exterior part 101. More precisely, the second fixing component 51Rb is fixed to the upper case 11 via an intermediate plate 11R (see FIG. 10). The second elastic component 51Ra elastically links the second fixing component 51Rb and a second main body component 52a. The second elastic component 51Ra is compressed in the Z axis direction by stamping, for example, and the second elastic component 51Ra is thinner than the second fixing component 51Rb and the second main body component 52a. Therefore, the stiffness of the second elastic component 51Ra (more precisely, the stiffness in the Z axis direction) is much lower than that of the second main body component 52a.

In this embodiment, since the thickness of the first elastic component 51La is set to be substantially the same as the thickness of the second elastic component 51Ra, the stiffness of the first elastic component 51La is substantially the same as the stiffness of the second elastic component 51Ra.

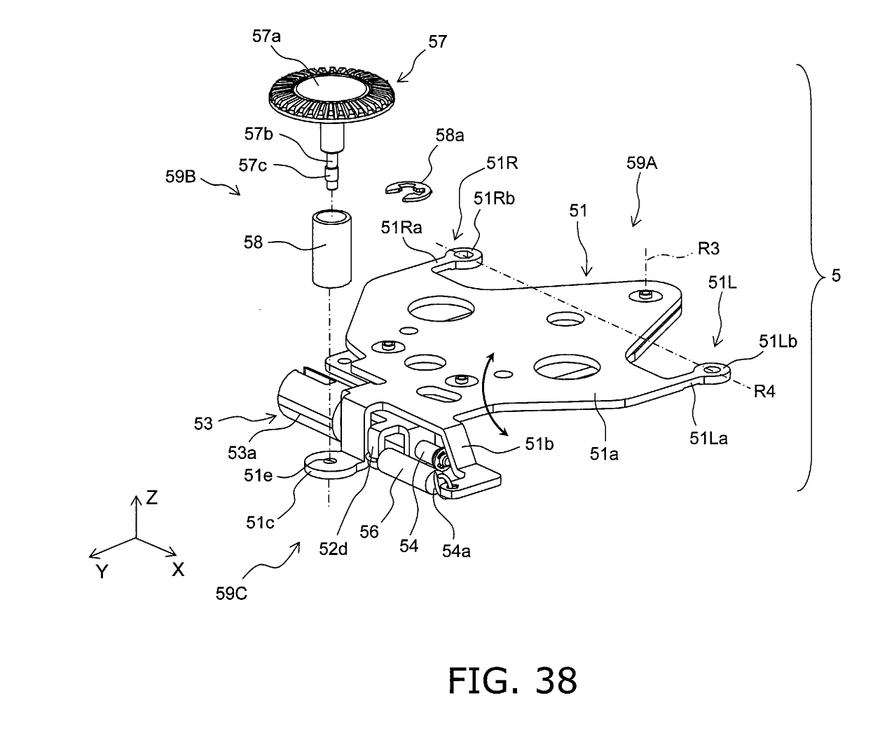

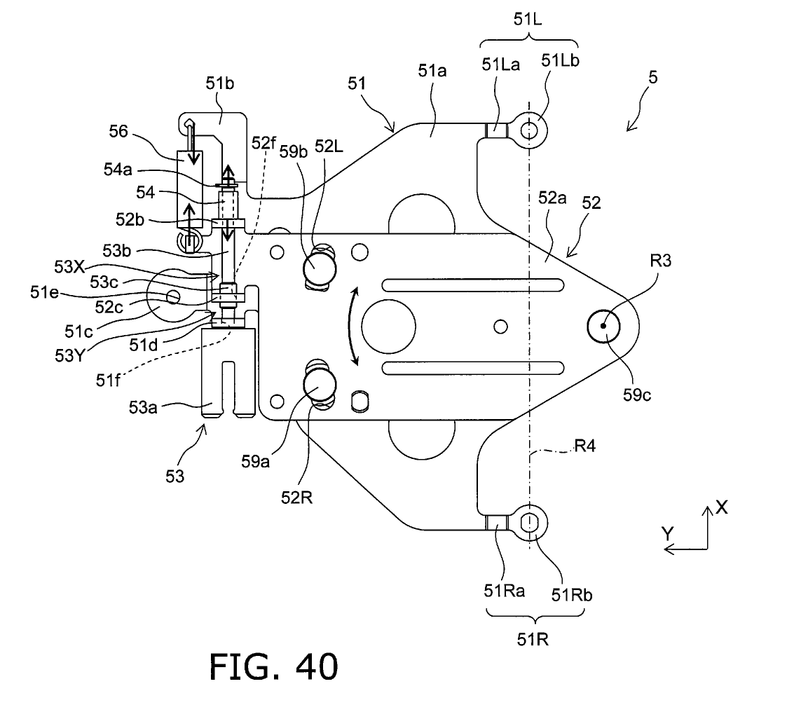

As shown in FIG. 40, the first support arm 51b extends from the first main body component 51a. The end of the first linking spring 56 is hooked to the first support arm 51b. The first contact component 51d hits a horizontal position adjusting screw 53 in the X axis direction. A hole 51f is formed in the first contact component 51d, and a shaft component 53b of the horizontal position adjusting screw 53 is inserted into this hole 51f. As shown in FIG. 38, the dial support 51c has a threaded hole 51e, and the threaded component 57c of the vertical position adjustment dial 57 is threaded into this threaded hole 51e.

The second linking plate 52 is rotatably linked to the first linking plate 51, and is fixed to the seat component 21c of the main body frame 2 (see FIG. 20, for example). The second linking plate 52 is linked to the first linking plate 51 by a rivet 59c rotatably around the rotational axis R3.

As shown in FIG. 37, the second linking plate 52 has the second main body component 52a, a second support arm 52d, a second contact component 52b, and a support 52c. The second main body component 52a is linked to the first linking plate 51 by the rivet 59c rotatably around the rotational axis R3. The second main body component 52a is also fixed to the seat component 21c of the main body frame 2. This allows the main body frame 2 to rotate around the rotational axis R3 with respect to the exterior part 101.

The second main body component 52a has a pair of slots 52L and 52R. The first linking plate 51 and the second linking plate 52 are linked in the Z axis direction by two rivets 59a and 59b. The rivet 59b is inserted into the slot 52L, and the rivet 59a is inserted into the slot 52R. The slots 52L and 52R prevent the rivets 59a and 59b from interfering with the second linking plate 52.

As shown in FIG. 40, the end of the first linking spring 56 is hooked to the second support arm 52d. The first support arm 51b and the second support arm 52d are pulled toward each other by the first linking spring 56. This imparts rotational force around the rotational axis R3 to the main body frame 2.

The second contact component 52b hits a second return spring 54. The second return spring 54 is sandwiched between the second contact component 52b and a second snap ring 54a mounted to the distal end of the shaft component 53b. The horizontal position adjusting screw 53 is pulled by the second return spring 54 to the X axis direction positive side with respect to the second linking plate 52.

As shown in FIG. 37, the first movement restricting mechanism 59B is a mechanism that restricts the movement of the main body frame 2 in the Z axis direction (first direction) with respect to the exterior part 101, and adjusts the position of the main body frame 2 with respect to the exterior part 101 by changing the restriction position of the main body frame 2. More specifically, the first movement restricting mechanism 59B has the vertical position adjustment dial 57 and a snap ring 58a. The vertical position adjustment dial 57 has a dial component 57a and a shaft component 57b. The vertical position adjustment dial 57 is mounted to the upper case 11. More specifically, the shaft component 57b is inserted into a hole 11d in the upper case 11 (see FIG. 11), and the vertical position adjustment dial 57 is able to rotate with respect to the upper case 11. Also, the snap ring 58a is mounted to the base of the shaft component 57b, and the second linking spring 58 is sandwiched in a compressed state between the snap ring 58a and the upper case 11. Therefore, the dial component 57a is always pressed against the upper case 11, and the position of the vertical position adjustment dial 57 in the Z axis direction with respect to the upper case 11 is fixed. Also, the vertical position adjustment dial 57 does not fall out of the upper case 11.

The threaded component 57c of the shaft component 57b is threaded into the threaded hole 51e of the dial support 51c. When the vertical position adjustment dial 57 is turned, the dial support 51c moves in the Z axis direction. Thus, movement of the main body frame 2 in the Z axis direction with respect to the exterior part 101 (more precisely, rotation around the rotational axis R4) is restricted by the vertical position adjustment dial 57. Since the restriction position of the main body frame 2 with respect to the exterior part 101 changes when the vertical position adjustment dial 57 is turned, the up and down angle of the main body frame 2 with respect to the exterior part 101 can be adjusted.

As shown in FIG. 37, the second movement restricting mechanism 59C is a mechanism that restricts the movement of the main body frame 2 in the X axis direction (first adjustment direction) with respect to the exterior part 101, and adjusts the position of the main body frame 2 with respect to the exterior part 101 by changing the restriction position of the main body frame 2. More specifically, the second movement restricting mechanism 59C has the horizontal position adjusting screw 53, the second return spring 54, and the second snap ring 54a. The horizontal position adjusting screw 53 has a joint component 53a and the shaft component 53b. The outside diameter of the joint component 53a is larger than the outside diameter of the shaft component 53b. The joint component 53a is mounted to the end part of the shaft component 53b. The joint component 53a is linked to the second joint shaft 65 of the operation mechanism 6. The joint component 53a and the second joint shaft 65 constitute a universal joint.

As shown in FIG. 40, the joint component 53a hits the first contact component 51d of the first linking plate 51. The joint component 53a is pressed against the first contact component 51d by the elastic force of the first linking spring 56. The shaft component 53b has a threaded component 53c. The threaded component 53c is threaded into a threaded hole 52f in the support 52c. When the horizontal position adjusting screw 53 is turned, the horizontal position adjusting screw 53 moves in the X axis direction with respect to the main body frame 2. Since the first contact component 51d is pressed against the shaft component 53b by the elastic force of the first linking spring 56, when the horizontal position adjusting screw 53 is turned, the second linking plate 52 rotates around the rotational axis R3 with respect to the first linking plate 51. When the second linking plate 52 rotates around the rotational axis R3 with respect to the first linking plate 51, the main body frame 2 rotates around the rotational axis R3 with respect to the exterior part 101 (see FIG. 19). Thus, the position of the main body frame 2 in the X axis direction with respect to the exterior part 101 can be adjusted by changing the restriction position of the second linking plate 52 in the rotational direction with the horizontal position adjusting screw 53. More precisely, the rotational position (orientation) of the main body frame 2 with respect to the exterior part 101 can be adjusted.

Also, since the second return spring 54 is provided, if the horizontal position adjusting screw 53 is turned too far, the support 52c can be prevented from completely falling out of the threaded component 53c. More specifically, when the support 52c moves to a first side 53X of the threaded component 53c, the elastic force of the second return spring 54 overcomes the elastic force of the first linking spring 56, which maintains a state in which the threaded component 53c is in contact with the threaded hole of the support 52c. Conversely, when the support 52c moves to a second side 53Y of the threaded component 53c, the elastic force of the first linking spring 56 overcomes the elastic force of the second return spring 54, which maintains a state in which the threaded component 53c is in contact with the threaded hole of the support 52c. Thus, by adjusting the elastic force of the first linking spring 56 and the second return spring 54, the support 52c can be prevented from falling completely out of the threaded component 53c even if the user turns the horizontal position adjusting screw 53 too far. Furthermore, since the threaded component 53c is disposed away from the joint component 53a, damage that would otherwise be caused by turning too far can also be prevented.

(8) Operation Mechanism 6

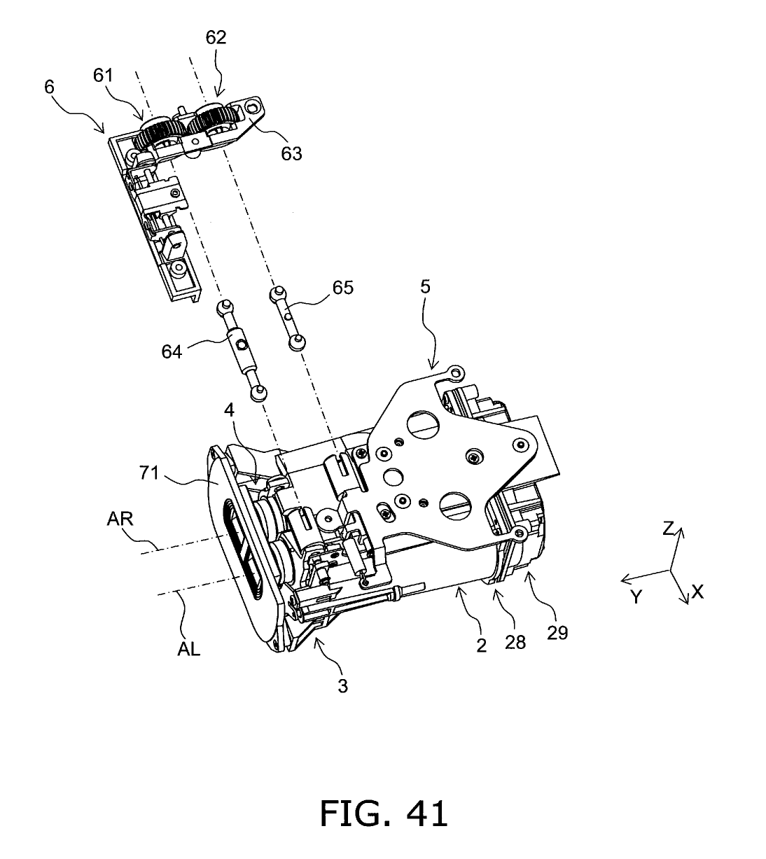

As shown in FIG. 41, the operation mechanism 6 has a support frame 63, the relative offset adjustment dial 61, the horizontal position adjustment dial 62, a first joint shaft 64, and the second joint shaft 65.

The support frame 63 is fixed to the top face of the main body frame 2. The relative offset adjustment dial 61 and the horizontal position adjustment dial 62 are rotatably supported by the support frame 63. In a state in which the cover 15 has been opened, part of the relative offset adjustment dial 61 and part of the horizontal position adjustment dial 62 are exposed to the outside through a first opening 11b and a second opening 11c in the upper case 11 (see FIGS. 9 and 11). When the cover 15 is opened, the user can operate the relative offset adjustment dial 61 and the horizontal position adjustment dial 62.

As shown in FIG. 41, the first joint shaft 64 is inserted into the relative offset adjustment dial 61. The second joint shaft 65 is inserted into the horizontal position adjustment dial 62. The rotation of the relative offset adjustment dial 61 is transmitted through the first joint shaft 64 to the relative offset adjustment screw 39. The rotation of the horizontal position adjustment dial 62 is transmitted through the second joint shaft 65 to the horizontal position adjusting screw 53. When the relative offset adjustment dial 61 is turned, vertical relative offset of the left- and right-eye images can be adjusted. When the horizontal position adjustment dial 62 is turned, the positions of the left-eye optical image QL1 and the right-eye optical image QR1 in the horizontal direction with respect to the CMOS image sensor 110 can be adjusted. When the vertical position adjustment dial 57 (FIG. 38) is turned, the positions of the left-eye optical image QL1 and the right-eye optical image QR1 in the vertical direction with respect to the CMOS image sensor 110 can be adjusted.

### Stereo Images

We will now describe the left-eye optical image QL1 and right-eye optical image QR1 formed on the CMOS image sensor 110 when the 3D adapter 100 is mounted to the video camera 200.

The two optical images shown in FIG. 6 are formed on the CMOS image sensor 110 of the video camera 200. More specifically, the left-eye optical image QL1 is formed by the left-eye optical system OL, and the right-eye optical image QR1 is formed by the right-eye optical system OR. FIG. 6 shows the optical images on the CMOS image sensor 110 as seen from the rear face side (image side). The right and left positions of the left-eye optical image QL1 and the right-eye optical image QR1 are switched, and inverted up and down, by the optical system V.

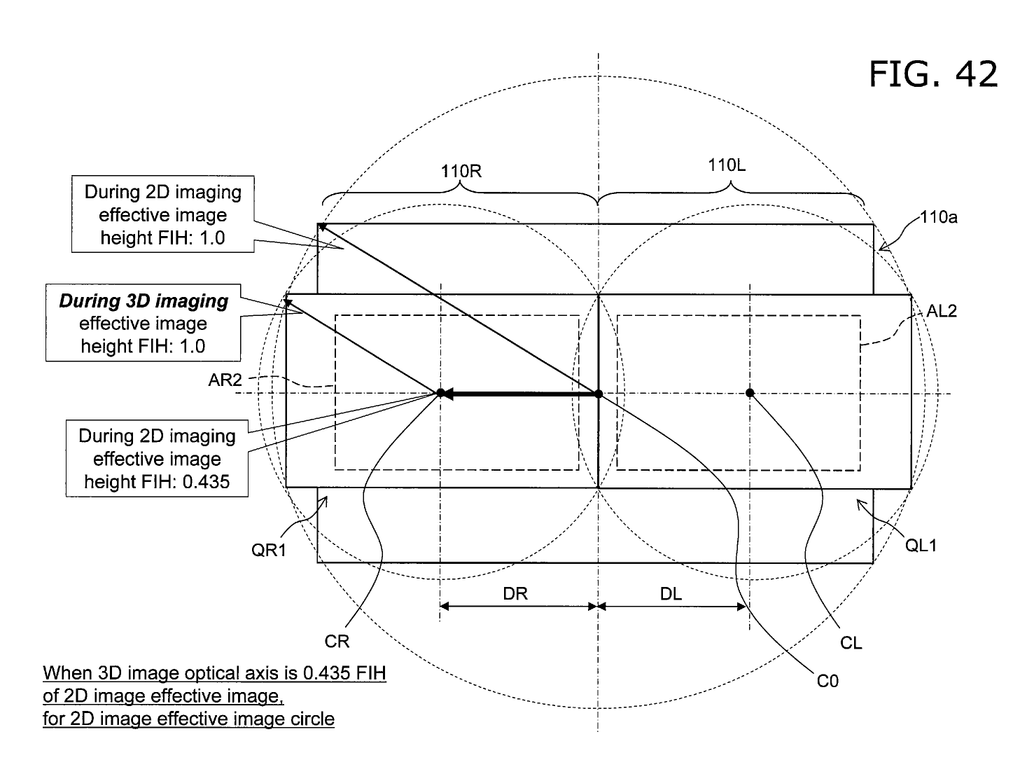

As shown in FIG. 42, the effective image height of the left-eye optical image QL1 is set to a range of 0.3 to 0.7, and the effective image height of the right-eye optical image QR1 is set to a range of 0.3 to 0.7. More precisely, if the main body maximum image height is 1.0, then a light beam passing through the optical axis center of the left-eye optical system OL arrives at a region corresponding to a range of 0.3 to 0.7 of the main body maximum image height. Also, if the main body maximum image height is 1.0, a light beam passing through the optical axis center of the right-eye optical system OR arrives at a region corresponding to a range of 0.3 to 0.7 of the main body maximum image height.

The “effective image height” referred to here is set using the effective image height during normal imaging (two-dimensional imaging) as a reference. More specifically, the effective image height of the left-eye optical image QL1 during three-dimensional imaging is a value obtained by dividing the distance DL from the center C0 of the effective image circle of a two-dimensional image to the center CL of the effective image circle of the left-eye optical image QL1, by the diagonal length D0 from the center C0 of the two-dimensional image. A light beam passing through the optical axis center of the left-eye optical system OL arrives at the center CL. Similarly, the effective image height of the right-eye optical image QR1 during three-dimensional imaging is a value obtained by dividing the distance DR from the center C0 of the effective image circle of a two-dimensional image to the center CR of the effective image circle of the right-eye optical image QR1, by the diagonal length D0 from the center C0 of the two-dimensional image. A light beam passing through the optical axis center of the right-eye optical system OR arrives at the center CR.

If the effective image height of the left-eye optical image QL1 and the right-eye optical image QR1 is set to be within the above range, the left-eye optical image QL1 and the right-eye optical image QR1 will readily fit within the effective image range.

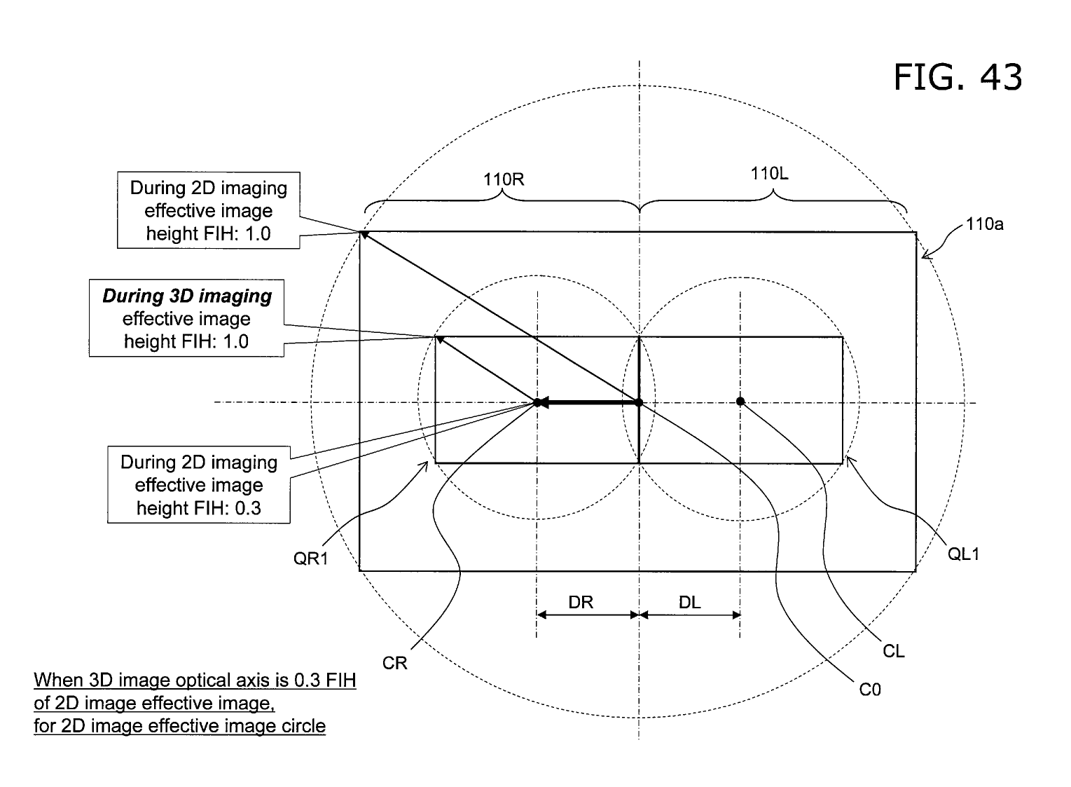

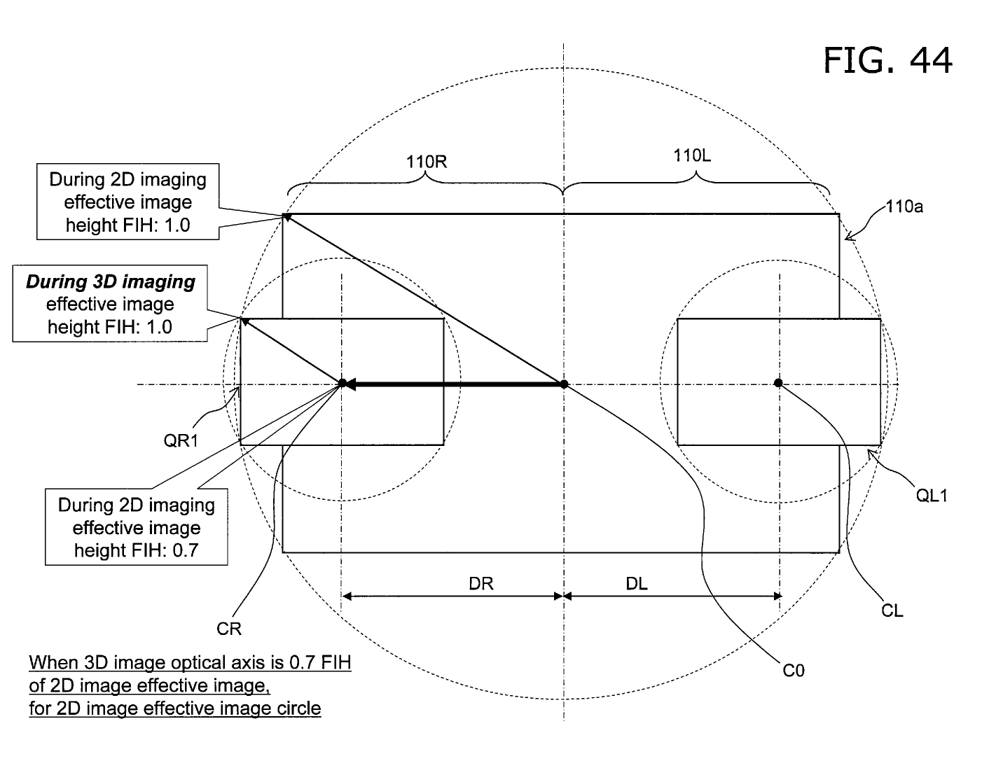

FIG. 43 shows the state when both effective image heights are 0.3, and FIG. 44 shows the state when both are 0.7. The state shown in FIG. 42 is a state in which both effective image heights are 0.435.

Since the amount of light usually decreases around the periphery of the left-eye optical image QL1 and around the periphery of the right-eye optical image QR1 as compared to in the center, there is a limited region of the left-eye optical image QL1 and the right-eye optical image QR1 from which an image can be extracted. Furthermore, the effective regions of the left-eye optical image QL1 and the right-eye optical image QR1 must be separated so that the periphery of the right-eye optical image QR1 does not overlap the effective region of the left-eye optical image QL1, and so that the periphery of the left-eye optical image QL1 does not overlap the effective region of the right-eye optical image QR1. Therefore, even if the effective image heights are set as discussed above, the left-eye optical image QL1 and the right-eye optical image QR1 must be reduced in size somewhat so that the effective region of the left-eye optical image QL1 and the effective region of the right-eye optical image QR1 will fit on the CMOS image sensor 110.

However, when the left-eye optical image QL1 and the right-eye optical image QR1 are made smaller, the resolution of three-dimensional imaging ends up decreasing. To obtain a good stereo image, the left-eye optical image QL1 and the right-eye optical image QR1 are preferably arranged efficiently in the effective image region of the CMOS image sensor 110.

In view of this, with the 3D adapter 100, a shaded region is intentionally provided to the left-eye optical image QL1 and the right-eye optical image QR1.

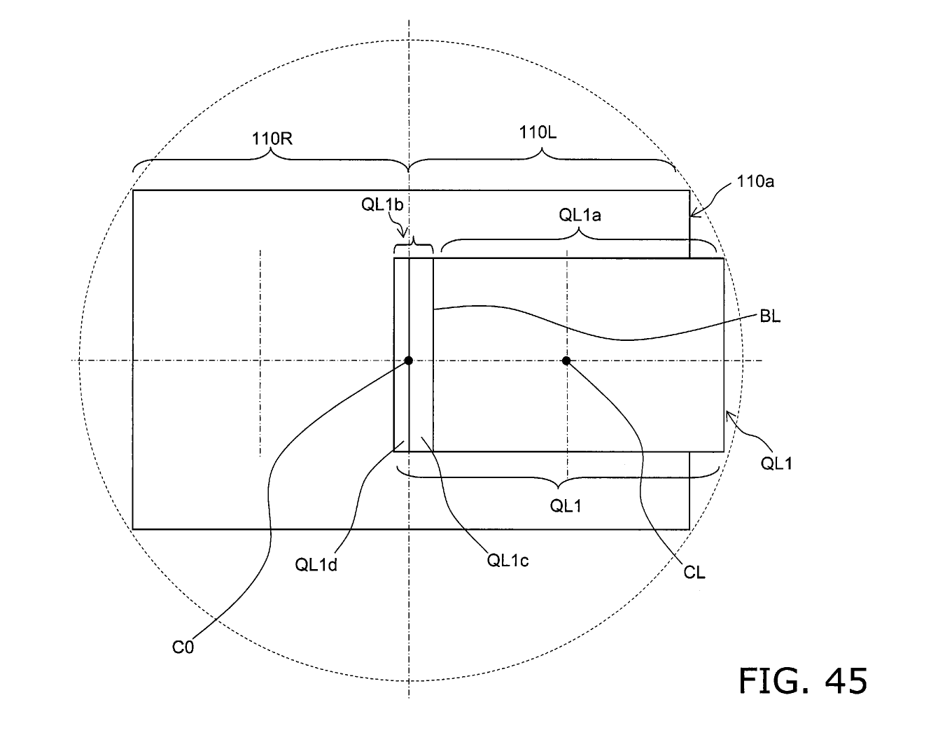

More specifically, as shown in FIG. 45, the left-eye optical image QL1 has a left-eye effective image region QL1a and a left-eye shaded region QL1b in which the amount of light is reduced by an intermediate light blocker 72a. Only the left-eye optical image QL1 is shown in FIG. 45. The left-eye effective image region QL1a is formed by light passing through a first opening 72La, and is adjacent to the left-eye shaded region QL1b. The left-eye effective image region QL1a is used in the production of a stereo image. More precisely, as shown in FIGS. 6 and 42, image data for the first extraction region AL2 is cut out from the image data for the left-eye effective image region QL1a and used in the production of a stereo image. Meanwhile, as shown in FIG. 45, the left-eye shaded region QL1b is a region in which the amount of light is reduced by the intermediate light blocker 72a, and is not used in the production of a stereo image.

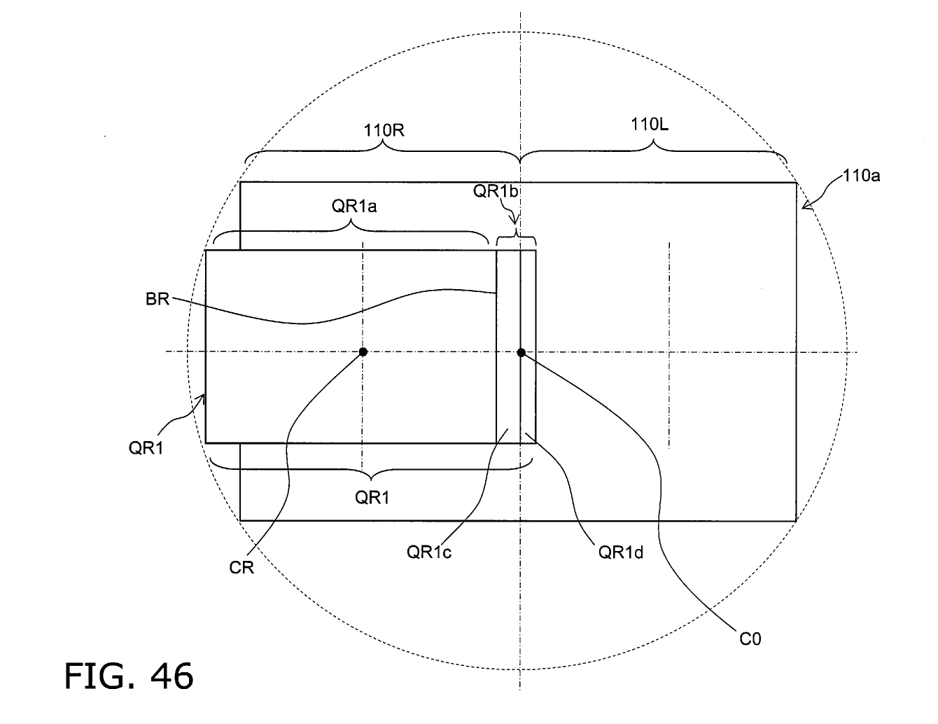

Also, as shown in FIG. 46, the right-eye optical image QR1 has a right-eye effective image region QR1a and a right-eye shaded region QR1b in which the amount of light is reduced by the intermediate light blocker 72a. Only the right-eye optical image QR1 is shown in FIG. 46. The right-eye effective image region QR1a is formed by light passing through a second opening 72Ra, and is adjacent to the right-eye shaded region QR1b. The right-eye effective image region QR1a is used in the production of a stereo image. More precisely, as shown in FIGS. 6 and 42, image data for the second extraction region AR2 is cut out from the image data for the right-eye effective image region QR1a and used in the production of a stereo image. Meanwhile, as shown in FIG. 46, the right-eye shaded region QR1b is a region in which the amount of light is reduced by the intermediate light blocker 72a, and is not used in the production of a stereo image.

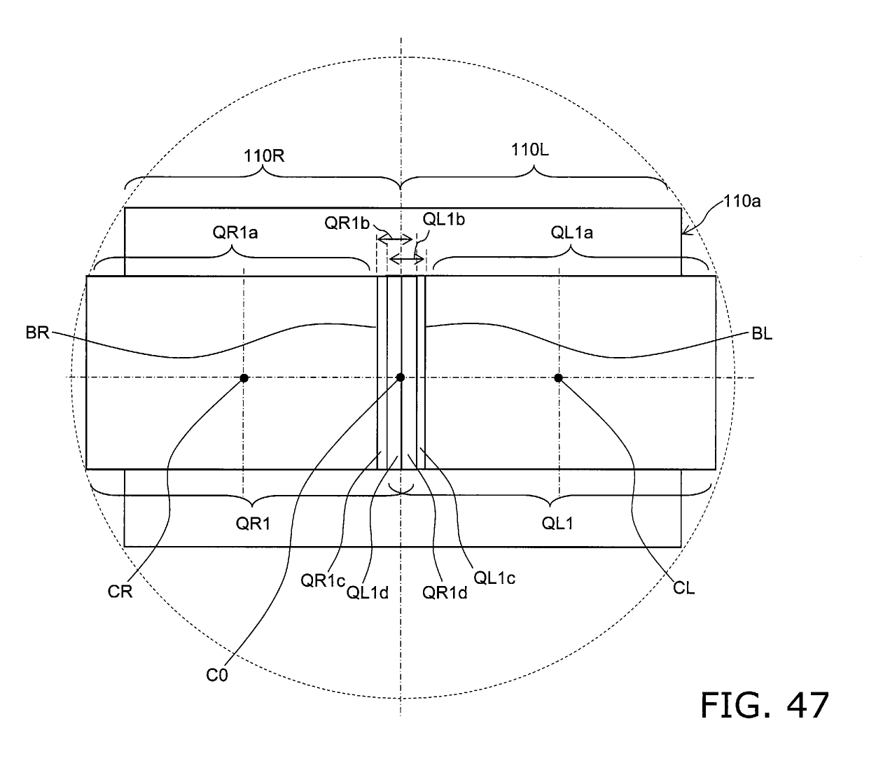

FIG. 47 shows the left-eye optical image QL1 and the right-eye optical image QR1. As shown in FIG. 47, during normal imaging, part of the left-eye shaded region QL1b overlaps the right-eye shaded region QR1b.

For example, as shown in FIGS. 45 and 47, the left-eye shaded region QL1b has a left-eye inner region QL1c formed on the first light receiving face 110L, and a left-eye outer region QL1d formed on the second light receiving face 110R. The surface area of the left-eye outer region QL1d is smaller than the surface area of the left-eye inner region QL1c. More precisely, the dimension in the horizontal direction of the left-eye outer region QL1d is smaller than the dimension in the horizontal direction of the left-eye inner region QL1c, and in this embodiment is approximately one-half the dimension in the horizontal direction of the left-eye inner region QL1c.

Similarly, as shown in FIGS. 46 and 47, part of the right-eye shaded region QR1b overlaps the left-eye shaded region QL1b. The right-eye shaded region QR1b has a right-eye inner region QR1c formed on the second light receiving face 110R, and a right-eye outer region QR1d formed on the first light receiving face 110L. The surface area of the right-eye outer region QR1d is smaller than the surface area of the right-eye inner region QR1c. More precisely, the dimension in the horizontal direction of the right-eye outer region QR1d is smaller than the dimension in the horizontal direction of the right-eye inner region QR1c, and in this embodiment is approximately one-half the dimension in the horizontal direction of the right-eye inner region QR1c.

Thus, the left-eye shaded region QL1b and the right-eye shaded region QR1b are formed by the intermediate light blocker 72a, and during normal imaging, part of the left-eye shaded region QL1b overlaps the right-eye shaded region QR1b, and part of the right-eye shaded region QR1b overlaps the left-eye shaded region QL1b. As a result, the periphery of the left-eye optical image QL1 can be prevented from overlapping the effective region of the right-eye optical image QR1, and the periphery of the right-eye optical image QR1 can be prevented from overlapping the effective region of the left-eye optical image QL1. Consequently, the effective region of the left-eye optical image QL1 and the effective region of the right-eye optical image QR1 can be moved closer together, and the effective region of the left-eye optical image QL1 and the effective region of the right-eye optical image QR1 can be set to be relatively larger. Specifically, the effective image region of the CMOS image sensor 110 can be used more efficiently.

The extent to which the left-eye shaded region QL1b and the right-eye shaded region QR1b overlap can be adjusted mainly by varying the width of the intermediate light blocker 72a (the dimension in the X axis direction). As shown in FIG. 15, the intermediate light blocker 72a has a first edge 72L and a second edge 72R. The first edge 72L formed the end of the left-eye shaded region QL1b, and is disposed parallel to the Z axis direction (perpendicular to the reference plane). The second edge 72R forms the end of the right-eye shaded region QR1b, and is disposed parallel to the Z axis direction (perpendicular to the reference plane).

More precisely, a light blocking sheet 72 (an example of a light blocking member, and an example of a light blocking unit) has the rectangular first opening 72La through which passes light incident on the left-eye optical system OL, and the rectangular second opening 72Ra through which passes light incident on the right-eye optical system OR. The intermediate light blocker 72a is formed by the first opening 72La and the second opening 72Ra. Part of the edge of the first opening 72La is formed by the first edge 72L, and part of the edge of the second opening 72Ra is formed by the second edge 72R. Since the first edge 72L is formed in a straight line, as shown in FIGS. 45 and 47, a first boundary BL between the left-eye effective image region QL1a and the left-eye shaded region QL1b is substantially a straight line. Since the second edge 72R is formed in a straight line, as shown in FIGS. 46 and 47, a second boundary BR between the right-eye effective image region QR1a and the right-eye shaded region QR1b is substantially a straight line. Therefore, it is easy to ensure a larger first extraction region AL2 and second extraction region AR2.

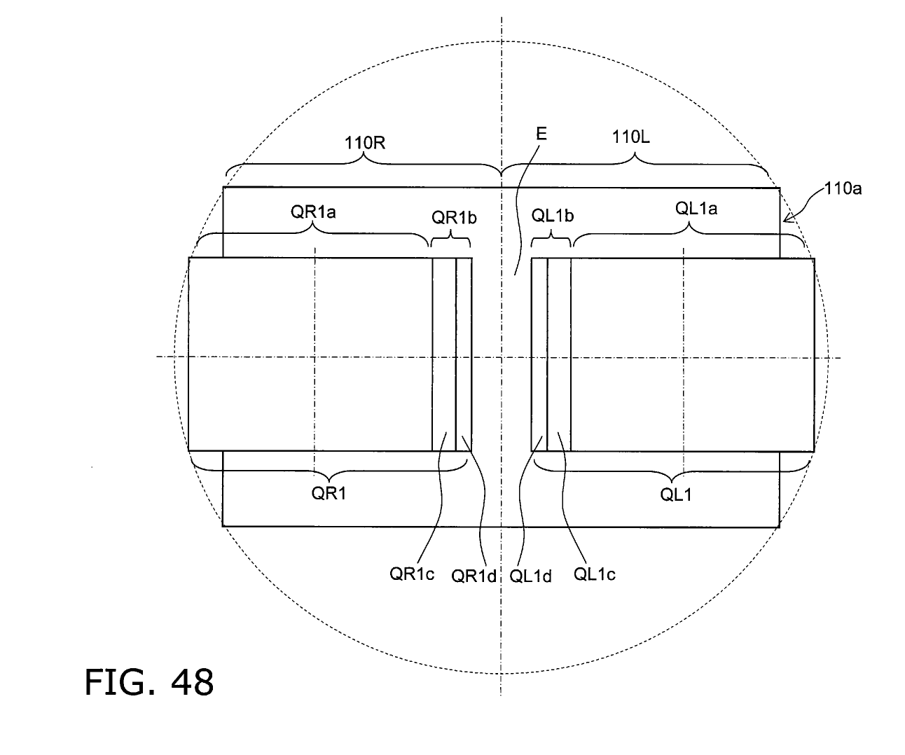

Meanwhile, during normal imaging the video camera 200 cannot focus on the intermediate light blocker 72a, but in adjustment mode the video camera 200 can focus on the intermediate light blocker 72a. More specifically, when the adjustment mode button 133 is pressed, the second lens group G2 and the fourth lens group G4 are driven to their specific positions by the zoom motor 214 and the focus motor 233, respectively. Fine adjustment of focus may be performed with a contrast detection type of auto focus, or the user can perform it using a focus adjustment lever (not shown). The focus can also be on the intermediate light blocker 72a of the light blocking sheet 72. When the focus is on the intermediate light blocker 72a, the focal length increases and the overall image height on the light receiving face 110a is greater. As a result, as shown in FIG. 48, the left-eye optical image QL1 moves away from the right-eye optical image QR1 in the horizontal direction, and this is accompanied by the left-eye shaded region QL1b moving away from the right-eye shaded region QR1b in the horizontal direction. In this case, a black band E is displayed between the left-eye optical image QL1 and the right-eye optical image QR1 on the camera monitor 120. In this state, it is easier for the user to recognize relative offset in the up and down directions between the left-eye optical image QL1 and the right-eye optical image QR1, which can be adjusted with the first adjustment mechanism 3.

### Adjustment Work

Since there is a difference between individual products of the 3D adapter 100 and the video camera 200, it is preferable to adjust the state of the left-eye optical system OL and right-eye optical system OR during shipping and use by using the first adjustment mechanism 3, the second adjustment mechanism 4, and the third adjustment mechanism 5.

The various kinds of adjustment work in which the above-mentioned constitution is employed will now be described in brief.

### Relative Offset Adjustment

“Relative offset adjustment” refers to adjusting positional offset in the up and down direction of the left-eye optical image QL1 and the right-eye optical image QR1. To produce a good stereo image, it is preferable if the positions in the up and down directions of the left-eye optical image QL1 and the right-eye optical image QR1 formed on the CMOS image sensor 110 are matched to a relatively high degree of precision.

However, we can imagine situations in which even though adjustment is performed at the time of shipping, relative offset increases due to individual differences between video cameras 200 that are mounted.

In view of this, with the 3D adapter 100, during use the user adjusts the positions of the left-eye optical image QL1 and the right-eye optical image QR1 in the up and down directions (more specifically, the positions of the left-eye image and the right-eye image in the up and down directions) while looking at the image displayed on the camera monitor 120.

The adjustment of relative offset is accomplished by operating the relative offset adjustment dial 61 in adjustment mode. The adjustment mode is executed when the adjustment mode button 133 is pressed in a state in which the 3D adapter 100 has been mounted to the video camera 200. In adjustment mode, not just either the left- or right-eye image is displayed on the camera monitor 120, but rather the entire image corresponding to the effective image region of the CMOS image sensor 110, and the focus is put on the intermediate light blocker 72a of the light blocking sheet 72. In a state in which the intermediate light blocker 72a is in focus, as shown in FIG. 48, the left-eye optical image QL1 and the right-eye optical image QR1 each move outward in the left and right directions on the display screen of the camera monitor 120, and the left-eye optical image QL1 and the right-eye optical image QR1 separate to the left and right. Since the black band E appears between the left-eye optical image QL1 and the right-eye optical image QR1, it is easier for the user to grasp the vertical relative offset of the left-eye optical image QL1 and the right-eye optical image QR1 on the camera monitor 120.

As shown in FIG. 22, when the relative offset adjustment dial 61 is turned, the relative offset adjustment screw 39 rotates via the first joint shaft 64. Since the threaded component 39c is threaded into the threaded hole of the first support plate 66, when the relative offset adjustment screw 39 rotates, it moves in the X axis direction with respect to the main body frame 2. Since the first restrictor 33 is pressed against the relative offset adjustment screw 39 by the elastic force of the adjusting spring 38, when the relative offset adjustment screw 39 moves in the X axis direction with respect to the main body frame 2, this is accompanied by rotation of the first adjustment frame 30 around the first rotational axis R1. When the first adjustment frame 30 rotates, the left-eye negative lens group G1L rotates around the first rotational axis R1, and as a result the left-eye negative lens group G1L moves substantially in the Z axis direction.

When the left-eye negative lens group G1L moves substantially in the Z axis direction, there is a change in the vertical position of the left-eye optical image QL1 formed on the CMOS image sensor 110. As a result, the left-eye image displayed on the camera monitor 120 moves up or down.

Thus, the vertical relative offset of the left-eye image and right-eye image can be reduced by turning the relative offset adjustment dial 61 while looking at the camera monitor 120, and thereby matching the position of the left-eye image in the up and down directions on the camera monitor 120 to that of the right-eye image.

### Convergence Angle Adjustment

The term “convergence angle” refers to the angle formed by the left-eye optical axis AL and the right-eye optical axis AR. To produce a good stereo image, the convergence angle is preferably set to the proper angle.

However, it is conceivable that individual differences between produces could result in the convergence angle varying from one product to the next. Variance in the convergence angle is preferably suppressed in order to produce a good stereo image.

In view of this, with the 3D adapter 100, a worker uses the second adjustment mechanism 4 to adjust the convergence angle during manufacture or shipping.

As shown in FIG. 22, the worker turns the convergence angle adjusting screw 49 in a state in which the exterior part 101 has been removed. Since the convergence angle adjusting screw 49 is threaded into the threaded hole 21h of the support 21f, when the convergence angle adjusting screw 49 is turned, it moves in the X axis direction with respect to the main body frame 2. Since the second restrictor 43 is pressed against the head component 49b by the elastic force of the adjusting spring 38, when the convergence angle adjusting screw 49 moves in the X axis direction with respect to the main body frame 2, this is accompanied by rotation of the second adjustment frame 40 around the second rotational axis R2. When the second adjustment frame 40 rotates, the right-eye negative lens group G1R rotates around the second rotational axis R2, and as a result, the right-eye negative lens group G1R moves substantially in the X axis direction.

When the right-eye negative lens group G1R moves substantially in the X axis direction, there is a change in the horizontal position of the right-eye optical image QR1 formed on the CMOS image sensor 110. This allows the convergence angle to be adjusted to the proper angle.

Once the convergence angle has been adjusted, the user does not need to adjust it again, so the convergence angle adjusting screw 49 is fixed adhesively, for example, to the second restrictor 43. However, the design may be such that the user can adjust the convergence angle.

### Focus Adjustment

To produce a good stereo image, it is preferable if the left-eye optical system OL and the right-eye optical system OR are not out of focus. However, individual differences between products may cause the left-eye optical system OL and the right-eye optical system OR to be out of focus.

In view of this, with the 3D adapter 100, a worker uses the second adjustment mechanism 4 to focus left-eye optical system OL and the right-eye optical system OR during manufacture or shipping. In this embodiment, the focus is adjusted by moving the right-eye negative lens group G1R of the right-eye optical system OR in the Y axis direction.

As shown in FIG. 34, when the worker turns the focus adjusting screw 48, it moves in the Y axis direction with respect to the main body frame 2. Since the second adjustment frame 40 is pressed against the focus adjusting screw 48 by the elastic force of the focus adjusting spring 44, when the focus adjusting screw 48 moves, this is accompanied by movement of the second adjustment frame 40 in the Y axis direction with respect to the main body frame 2. As a result, the right-eye negative lens group G1R moves in the Y axis direction with respect to the right-eye positive lens group G2R, and the focus of the right-eye optical system OR changes.

Thus, offset in the focus of the left-eye optical system OL and the right-eye optical system OR can be adjusted by turning the focus adjusting screw 48.

Once the focus has been adjusted, the user does not need to adjust it again, so after adjustment, the focus adjusting screw 48 is fixed adhesively, for example, to the front support plate 25. However, the design may be such that the user can adjust the focus.

### Image Position Adjustment

To produce a good stereo image, it is preferable if the left-eye optical image QL1 and the right-eye optical image QR1 are set to the proper positions on the CMOS image sensor 110. However, it is conceivable that individual differences between products may cause the positions of the left-eye optical image QL1 and the right-eye optical image QR1 to deviate greatly from the design positions. It is also conceivable that the above-mentioned relative offset adjustment and convergence angle adjustment could cause an overall deviation in the positions of the left-eye optical image QL1 and the right-eye optical image QR1 on the CMOS image sensor 110.

In view of this, with the 3D adapter 100, the user uses the third adjustment mechanism 5 to adjust the image positions during use (or in a state in which the effective image region of the CMOS image sensor 110 is displayed on the camera monitor 120).

As shown in FIG. 38, when the vertical position adjustment dial 57 is turned, since the threaded component 57c of the vertical position adjustment dial 57 is threaded into the threaded hole of the dial support 51c, the main body frame 2 moves up or down with respect to the exterior part 101, with the first elastic support 51L and the second elastic support 51R as support points. More precisely, the main body frame 2 rotates with respect to the exterior part 101 and around the rotational axis R4. Since the first elastic component 51La and the second elastic component 51Ra here are thinner, no heavy load is exerted on the first elastic support 51L or the second elastic support 51R.

When the main body frame 2 rotates with respect to the exterior part 101 and around the rotational axis R4, the left-eye optical system OL and the right-eye optical system OR move in the Z axis direction with respect to the exterior part 101. More precisely, the orientation of the left-eye optical system OL and the right-eye optical system OR changes to face upward or downward with respect to the exterior part 101. This allows the vertical positions of the left-eye optical image QL1 and the right-eye optical image QR1 on the CMOS image sensor 110 to be adjusted.

Also, as shown in FIG. 41, when the horizontal position is adjusted, such as when the horizontal position adjustment dial 62 is turned, the horizontal position adjusting screw 53 rotates via the second joint shaft 65. As shown in FIG. 40, since the first contact component 51d is pressed against the joint component 53a of the horizontal position adjusting screw 53 by the tensile force of the first linking spring 56, the horizontal position adjusting screw 53 does not move in the X axis direction with respect to the first linking plate 51. Instead, since the threaded component 53c is threaded into the threaded hole 52f of the support 52c, when the horizontal position adjusting screw 53 rotates, the support 52c moves in the X axis direction with respect to the first linking plate 51 (that is, the exterior part 101). In other words, the second linking plate 52 and the main body frame 2 rotates around the rotational axis R3 and with respect to the exterior part 101.

When the main body frame 2 rotates with respect to the exterior part 101 and around the rotational axis R3, the left-eye optical system OL and the right-eye optical system OR move in the X axis direction with respect to the exterior part 101. More precisely, the orientation of the left-eye optical system OL and the right-eye optical system OR changes to face right or left with respect to the exterior part 101. This allows the horizontal positions of the left-eye optical image QL1 and the right-eye optical image QR1 on the CMOS image sensor 110 to be adjusted.

### Operation of Video Camera

We will now describe the operation of the video camera 200 when the 3D adapter 100 is used to perform three-dimensional imaging with the video camera 200.

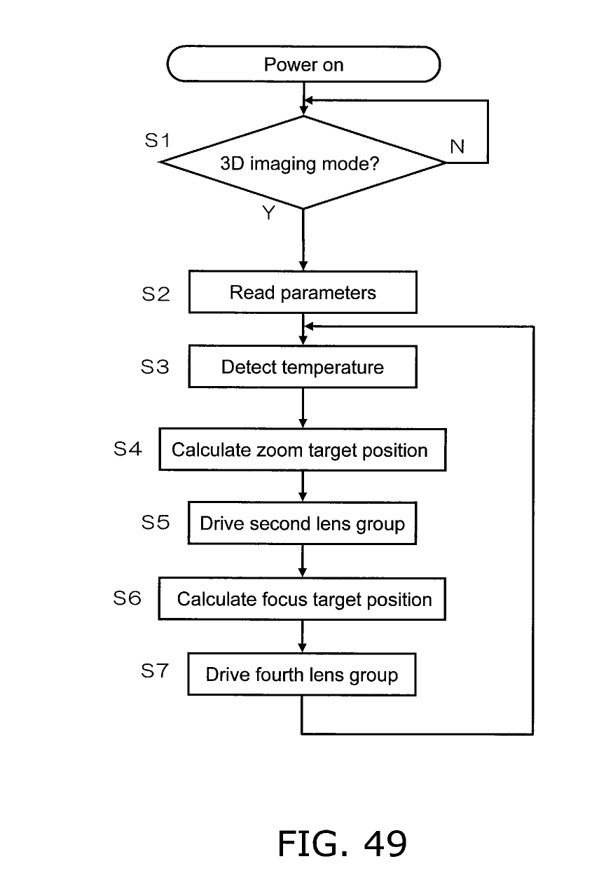

As shown in FIG. 49, when the power is switched on to the video camera 200, electrical power is sent to the various components, and the camera controller 140 confirms the operating mode, such as reproduction mode, two-dimensional imaging mode, or three-dimensional imaging mode (step S1).

When the power goes on in a state in which the 3D adapter 100 has been mounted to the video camera 200, the lens detector 149 detects that the 3D adapter 100 is mounted, and the camera controller 140 automatically switches the imaging mode of the video camera 200 to three-dimensional imaging mode. Even if the 3D adapter 100 is mounted to the video camera 200 while the power to the video camera 200 is already on, the lens detector 149 will detect that the 3D adapter 100 has been mounted, and the camera controller 140 automatically will switch the imaging mode of the video camera 200 to three-dimensional imaging mode.

Here, there may be situations in which individual differences between products (more precisely, individual differences in the video camera 200) cause the reference plane distance (see FIG. 7) of the 3D adapter 100 to deviate from the design value, cause the convergence angle also to deviate from the design value, and as a result cause the left and right positions of the left-eye optical image QL1 and the right-eye optical image QR1 to deviate from the design positions. Also, there may be situations in which the characteristics of the optical system V vary due to changes in the ambient temperature, so left and right positional offset of the left-eye optical image QL1 and the right-eye optical image QR1 using the design position as a reference can also be caused by changes in the ambient temperature. Left and right positional offset of the left-eye optical image QL1 and the right-eye optical image QR1 is undesirable because it affects the stereoscopic look of a three-dimensional image.

In view of this, the video camera 200 has the function of correcting offset in the reference plane distance and thereby correcting left and right positional offset of the left-eye optical image QL1 and the right-eye optical image QR1 using the design positions as a reference. Adjustment of the reference plane distance is performed by moving the second lens group G2 (a zoom adjusting lens group) in the Y axis direction with the zoom motor 214.

More specifically, when the operating mode of the video camera 200 is switched to three-dimensional imaging mode, various parameters are read by the drive controller 140d (step S2). Index data indicating individual differences of the optical system V is read from the ROM 140b to the drive controller 140d. This index data is measured during shipment of the product and stored ahead of time in the ROM 140b.

Next, since the characteristics of the optical system V will vary with the ambient temperature, the temperature is detected by the temperature sensor 118 (FIG. 4) to ascertain the ambient temperature (step S3). The detected temperature is temporarily stored in the 140c as temperature information, and is read by the drive controller 140d as needed.

The zoom motor 214 is controlled by the drive controller 140d on the basis of the index data and the detected temperature. More specifically, the target position of the second lens group G2 (zoom adjusting lens group) is calculated by the drive controller 140d on the basis of the index data and the detected temperature (step S4). Information (such as a calculation formula or a data table) for calculating the target position of the second lens group G2 on the basis of the index data and the detected temperature is stored ahead of time in the ROM 140b. The second lens group G2 is driven by the zoom motor 214 up to the calculated target position (step S5). The target position of the second lens group G2 may also be calculated on the basis of the index data alone.

To perform fine adjustment of the focus, the target position of the fourth lens group G4 is calculated by the drive controller 140d on the basis of the calculated target position of the second lens group G2 (step S6). Information such as a calculation formula or a data table for calculating the target position of the fourth lens group G4 is stored ahead of time in the ROM 140b. The fourth lens group G4 is driven by the focus motor 233 up to the calculated target position (step S7).

Since the above-mentioned control is thus performed by taking into account the fact that changes in the ambient temperature or individual differences between products may cause left and right positional offset of the left-eye optical image QL1 and the right-eye optical image QR1, a better stereo image can be acquired when mounting the 3D adapter 100 to the video camera 200 and performing three-dimensional imaging.

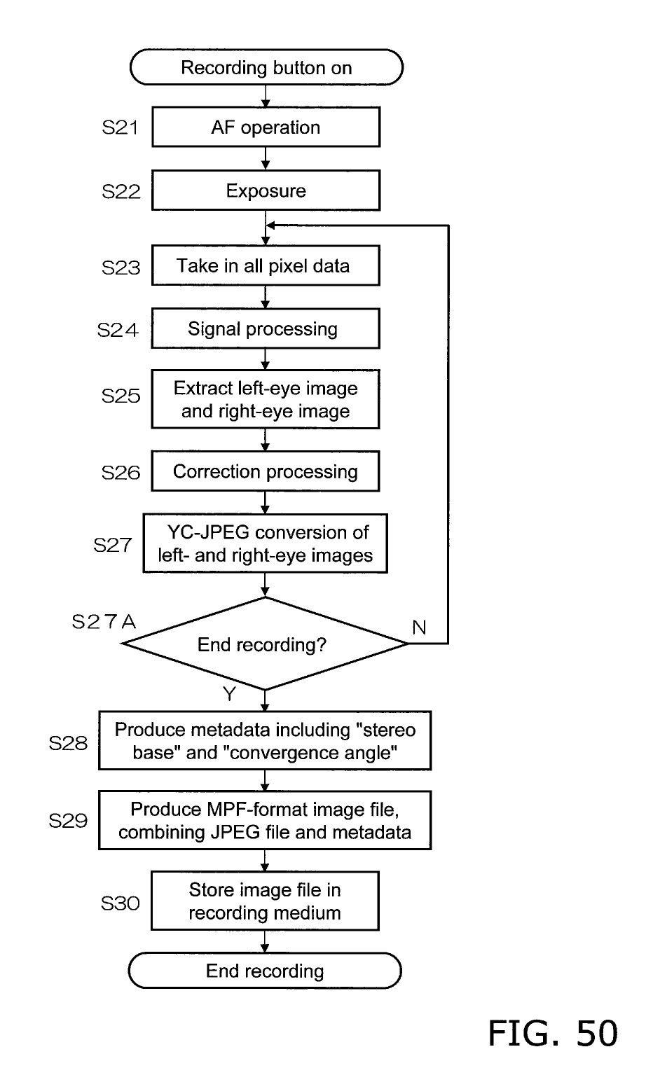

When three-dimensional imaging is performed, for example, the capture of a stereo image is executed when the user presses the record button 131. More specifically, as shown in FIG. 50, when the user presses the record button 131, auto focus is executed by wobbling, etc. (step S21), the CMOS image sensor 110 is exposed (step S22), and image signals from the CMOS image sensor 110 (data for all pixels) are sequentially read to the signal processor 215 (step S23).

Focus adjustment during three-dimensional imaging is performed using either the left-eye optical image QL1 or the right-eye optical image QR1. In this embodiment, focus adjustment is performed using the left-eye optical image QL1. In the case of wobbling, for instance, the region in which the AF evaluation value is calculated is set to part of the left-eye effective image region QL1a of the left-eye optical image QL1. The AF evaluation value in the set region is calculated at a specific period, and wobbling is executed on the basis of the calculated AF evaluation value.

The image signals that are taken in are subjected to A/D conversion or other such signal processing by the signal processor 215 (step S24). The basic image data produced by the signal processor 215 is temporarily stored in the DRAM 241.

Next, left-eye image data and right-eye image data are extracted by the image extractor 216 from the basic image data (step S25). The size and position of the first and second extraction regions AL2 and AR2 here are stored ahead of time in the ROM 140b.

The extracted left-eye image data and right-eye image data are subjected to correction processing by the correction processor 218, and the left-eye image data and right-eye image data are subjected to JPEG compression or other such compression processing by the image compressor 217 (steps S26 and S27). The processing of steps S23 to S27 is executed until the record button 131 is pressed again (step S27A).

When the record button 131 is pressed again, metadata including the stereo base and convergence angle is produced by the metadata production component 147 of the camera controller 140 (step S28).

After the metadata production, the compressed left- and right-eye image data and the metadata are combined, and an MPF-format image file is produced by the image file production component 148 (step S29). The image files thus produced are sequentially transmitted to the card slot 170 stored on the memory card 171, for example (step S30). When a moving picture is captured, these operations are repeated.

When the stereo video file thus obtained is displayed in 3D using the stereo base, convergence angle, and other such information, the displayed image can be viewed in 3D by using special glasses or the like.

### Features

The features of the 3D adapter 100 described above are compiled below.

(1) With the 3D adapter 100, since light is guided to the uniaxial optical system V by a biaxial optical system made up of the left-eye optical system OL and the right-eye optical system OR, the optical system V used for ordinary two-dimensional imaging can be converted into an optical system for three-dimensional imaging. Therefore, three-dimensional imaging can be easily carried out with this 3D adapter 100.

(2) The left-eye optical system OL has the left-eye negative lens group G1L on the subject side, and the right-eye optical system OR has the right-eye negative lens group G1R on the subject side. Therefore, the left-eye optical image QL1 and the right-eye optical image QR1 can be formed relatively large, and the effective image region on the CMOS image sensor 110 can be utilized more efficiently.

(3) The left-eye prism group G3L refracts the light transmitted by the left-eye positive lens group G2L so that it moves closer to the intermediate reference plane B, and the right-eye prism group G3R refracts the light transmitted by the right-eye positive lens group G2R so that it moves closer to the intermediate reference plane B.

(4) Since the left-eye positive lens group G2L has a substantially semicircular shape, and the right-eye positive lens group G2R also has a substantially semicircular shape, when the left-eye positive lens group G2L and the right-eye positive lens group G2R are disposed side by side on the left and right, the center of the left-eye positive lens group G2L can be disposed closer to the center of the right-eye positive lens group G2R. Therefore, the stereo base of the 3D adapter 100 can be smaller, and the convergence angle formed by the left-eye optical axis AL and the right-eye optical axis AR can also be smaller.

(5) The effective diameter of the left-eye negative lens group G1L is smaller than the effective diameter of the left-eye positive lens group G2L, and the effective diameter of the right-eye negative lens group G1R is smaller than the effective diameter of the right-eye positive lens group G2R. Therefore, transmitted light rays diverged by the left-eye negative lens group G1L and the right-eye negative lens group G1R are reliably incident on the left-eye positive lens group G2L and the right-eye positive lens group G2R, respectively. Therefore, shading can be prevented from occurring.

(6) Light rays passing through the optical axis center of the left-eye optical system OL arrive at a region corresponding to a range of 0.3 to 0.7 of the main body maximum image height, if we let the main body maximum image height be 1.0. Light rays passing through the optical axis center of the right-eye optical system OR arrive at a region corresponding to a range of 0.3 to 0.7 of the main body maximum image height, if we let the main body maximum image height be 1.0. Consequently, the left-eye optical image QL1 and the right-eye optical image QR1 are formed at positions where it is easy to acquire a stereo image.

### Other Embodiments

The present invention is not limited to the above embodiment, and various modifications and adaptations are possible without departing from the scope of the invention.

(A) The video camera 200 is able to capture both moving pictures and still pictures, but the imaging device to which the 3D adapter 100 is mounted may be one that is capable of capturing only moving pictures, or that is capable of capturing only still pictures.

(B) In the above embodiment, a lens unit was described using the 3D adapter 100 as an example, but the configuration of the lens unit is not limited to that in the above embodiment. For instance, the 3D adapter 100 comprises mechanisms for adjusting the convergence angle, vertical relative offset, and the like, but some or all of these adjusting mechanisms may be omitted.

(C) In the above embodiment, first and second optical systems were described using the left-eye optical system OL and the right-eye optical system OR as examples, but the configuration of the first and second optical systems is not limited to that in the above embodiment. For instance, the first and second optical systems may have different configurations from those of the left-eye optical system OL and right-eye optical system OR.

(D) In the above embodiment, the left-eye negative lens group G1L, the left-eye positive lens group G2L, and the left-eye prism group G3L are disposed in that order starting from the subject side, but may instead be disposed in the order of the left-eye negative lens group G1L, the left-eye prism group G3L, and the left-eye positive lens group G2L.

Also, in the above embodiment, the right-eye negative lens group G1R, the right-eye positive lens group G2R, and the right-eye prism group G3R are disposed in that order starting from the subject side, but may instead be disposed in the order of the right-eye negative lens group G1R, the right-eye prism group G3R, and the right-eye positive lens group G2R.

The various lens groups and prism groups discussed above may be constituted by a single optical element, or may be constituted by a plurality of optical elements.

(E) In the above embodiment, the left-eye positive lens group G2L and the right-eye positive lens group G2R have a substantially semicircular shape, but may instead be circular. The “substantially semicircular shape” referred to here encompasses a shape in which at least part of the outer periphery of the circle has been removed.

(F) In the above embodiment, the effective diameter of the left-eye negative lens group G1L is smaller than the effective diameter of the left-eye positive lens group G2L, and the effective diameter of the right-eye negative lens group G1R is smaller than the effective diameter of the right-eye positive lens group G2R, but the relation between the effective diameters of the lenses is not limited to what is given in the above embodiment.

(G) In the above embodiment, the left-eye optical system OL and the right-eye optical system OR are substantially afocal optical systems, but the left-eye optical system OL and the right-eye optical system OR need not be substantially afocal optical systems.

(H) In the above embodiment, light rays passing through the optical axis center of the left-eye optical system OL arrive at a region corresponding to a range of 0.3 to 0.7 of the main body maximum image height, if we let the main body maximum image height be 1.0. Light rays passing through the optical axis center of the right-eye optical system OR arrive at a region corresponding to a range of 0.3 to 0.7 of the main body maximum image height, if we let the main body maximum image height be 1.0. However, the configuration of the left-eye optical system OL and the right-eye optical system OR is not limited to this.

(I) In the above embodiment, the left-eye optical system OL and the right-eye optical system OR satisfy Relations (1) and (2), respectively, but the left-eye optical system OL and the right-eye optical system OR need not satisfy Relations (1) and (2).

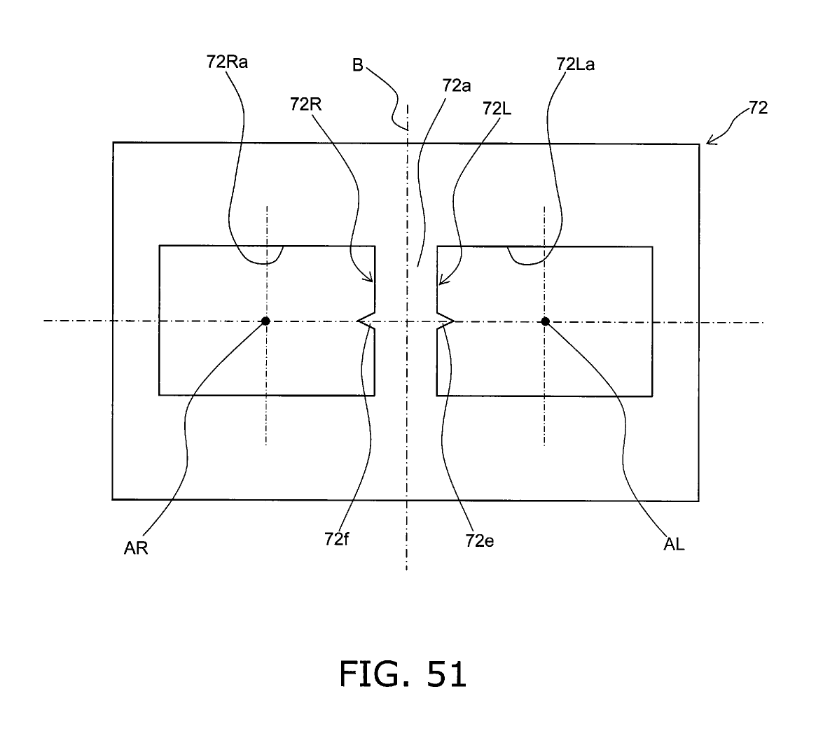

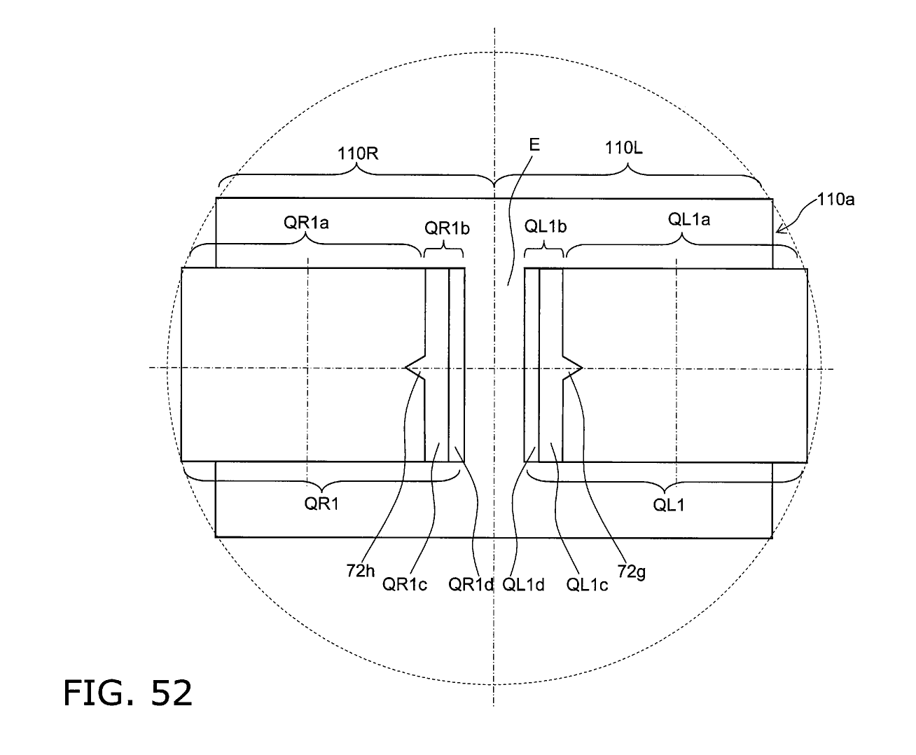

(J) As shown in FIG. 51, a vertical relative offset adjusting gauge may be provided to the intermediate light blocker 72a. FIG. 51 is a front view of the light blocking sheet 72 as seen from the subject side. As shown in FIG. 51, a pair of gauges 72e and 72f is provided to the intermediate light blocker 72a, and in a state in which the intermediate light blocker 72a is in focus, the left-eye shaded region QL1b and the right-eye shaded region QR1b are separated from each other to the left and right, so the gauges 72e and 72f are displayed as gauge images 72g and 72h on the camera monitor 120 (see FIG. 52). The relative offset of the left-eye optical image QL1 and the right-eye optical image QR1 can be ascertained by taking account of the gauges 72e and 72f in adjusting the vertical relative offset of the left-eye optical image QL1 and the right-eye optical image QR1. Therefore, vertical relative offset of the left-eye optical image QL1 and the right-eye optical image QR1 can be more accurately adjusted by matching the positions of the gauge images 72g and 72h in the up and down direction, and accuracy of the adjustment of the positions of the left-eye image and right-eye image in the up and down direction can be improved. The gauge images 72g and 72h can also be utilized in adjusting the vertical positions of the left-eye optical image QL1 and the right-eye optical image QR1 in the up and down direction.

After the intermediate light blocker 72a is put in focus in adjustment mode, the user operates the relative offset adjustment dial 61 to adjust the position of the left-eye negative lens group G1L so that the vertical positions of the gauge images 72g and 72h displayed on the camera monitor 120 will be the same. This allows the vertical relative offset of the left-eye optical image QL1 and the right-eye optical image QR1 to be corrected.

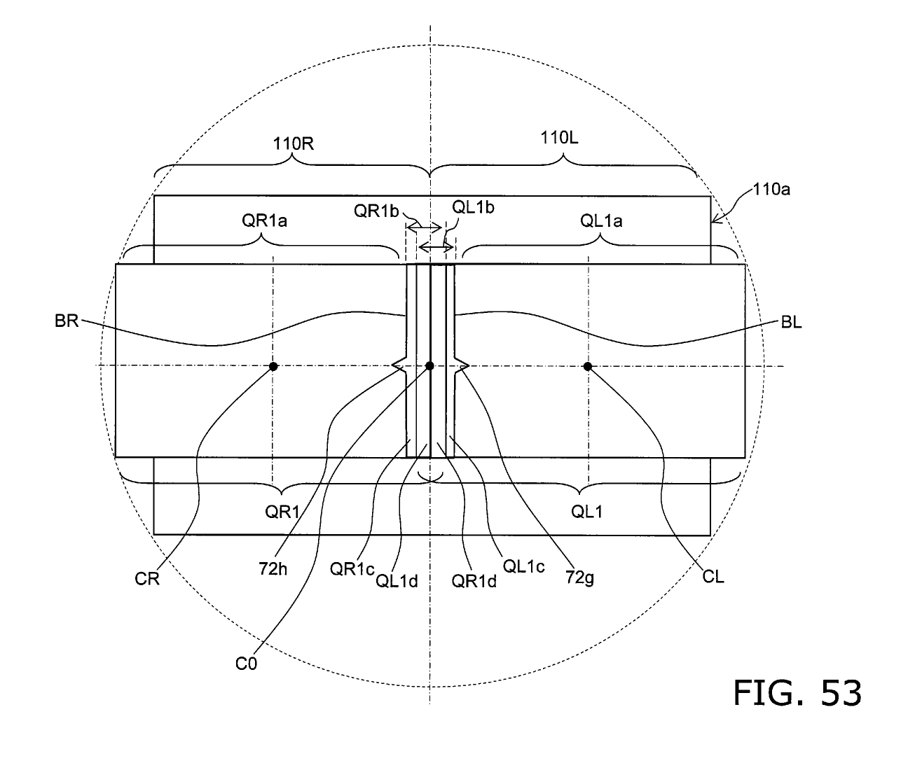

As shown in FIG. 53, during normal imaging the left-eye shaded region QL1b and the right-eye shaded region QR1b overlap, but in this case the gauge images 72g and 72h are disposed close to the first boundary BL and the second boundary BR, respectively. Also, in some cases, the gauge image 72g can be disposed more to the right-eye optical image QR1 side than the first boundary BL, and the gauge image 72h more to the left-eye optical image QL1 side than the second boundary BR. Therefore, the gauges 72e and 72f will have almost no effect on the extraction of the left-eye image data and right-eye image data.

The pair of gauges 72e and 72f may have any shape so long as the relative positions of the left-eye optical image QL1 and the right-eye optical image QR1 can be easily determined. Similarly, the pair of gauges 72e and 72f may have any shape so long as the positions of the left-eye optical image QL1 and the right-eye optical image QR1 in the up and down direction can be easily determined. For example, the gauges 72e and 72f may have mutually different shapes.

Also, the intermediate light blocker 72a or the gauges 72e and 72f may be provided to the cap 9 (FIG. 17).

(K) In the above embodiment, the intermediate light blocker 72a was made up of a single portion, but the intermediate light blocker 72a may be made up of a plurality of portions (or a plurality of members).

### INDUSTRIAL APPLICABILITY

The above technology can be applied to a lens unit and an imaging device.

### REFERENCE SIGNS LIST

1 video camera unit
2 main body frame (an example of a main body frame)
3 first adjustment mechanism (an example of a relative offset adjustment mechanism)
30 first adjustment frame (an example of a relative offset adjustment frame)
31 first rotational shaft (an example of a rotational support shaft)
37 first restricting mechanism (an example of a rotation restricting mechanism)
38 adjusting spring (an example of an adjusting elastic member, an example of a first elastic member, and an example of a second elastic member)
4 second adjustment mechanism (an example of a convergence angle adjustment mechanism)
40 second adjustment frame (an example of a convergence angle adjustment frame)
41 second rotational shaft (an example of an adjusting rotational shaft)
47 second restricting mechanism (an example of a positioning mechanism)
5 third adjustment mechanism (an example of a main body frame adjustment mechanism)
59A elastic linking mechanism (an example of an elastic linking mechanism)
59B first movement restricting mechanism (an example of a first movement restricting mechanism)
59C second movement restricting mechanism (an example of a second movement restricting mechanism)
6 operation mechanism
72 light blocking sheet (an example of a light blocking member, and an example of a light blocking unit)
72a intermediate light blocker (an example of a intermediate light blocker)
72e gauge (an example of a first adjustment reference component or second adjustment reference component)
72f gauge (an example of a first adjustment reference component or second adjustment reference component)
9 cap (an example of a light blocking member, and an example of a light blocking unit)
100 3D adapter (an example of a lens unit)
101 exterior part (an example of a housing)
118 temperature sensor (an example of a temperature detector)
140 camera controller
140b ROM (an example of an index memory)
140d drive controller (an example of a drive controller)
200 video camera (an example of an imaging device)
214 zoom motor (an example of a zoom driver)
233 focus motor (an example of a focus driver)
OL left-eye optical system (an example of a first optical system or second optical system)
OR right-eye optical system (an example of a first optical system or second optical system)
AL left-eye optical axis (an example of a first optical axis or second optical axis)
AR right-eye optical axis (an example of a first optical axis or second optical axis)
QL1 left-eye optical image (an example of a first optical image or second optical image)
QL1a left-eye effective image region (an example of a first usage region or second usage region)
QL1b left-eye shaded region (an example of a first shaded region or second shaded region)
QL1c left-eye inner region (an example of a first inner region or second inner region)
QL1d left-eye outer region (an example of a first outer region or second outer region)
QR1 right-eye optical image (an example of a first optical image or second optical image)
QR1 a right-eye effective image region (an example of a first usage region or second usage region)
QR1b right-eye shaded region (an example of a first shaded region or second shaded region)
QR1c right-eye inner region (an example of a first inner region or second inner region)
QR1d right-eye outer region (an example of a first outer region or second outer region)
G1L left-eye negative lens group (an example of a relative offset adjustment optical system, and an example of a first negative lens group or second negative lens group)
G2L left-eye positive lens group (an example of first positive lens group or second positive lens group)
G3L left-eye prism group (an example of a first prism group or second prism group)
G1R right-eye negative lens group (an example of a convergence angle adjustment optical system, and an example of a first negative lens group or second negative lens group)
G2R right-eye positive lens group (an example of first positive lens group or second positive lens group)
G3R right-eye prism group (an example of a first prism group or second prism group)
R1 first rotational axis
R2 second rotational axis
R3 rotational axis (an example of an optical system rotational axis)
R4 rotational axis (an example of a main body rotational axis)
V optical system (an example of a uniaxial optical system)
G1 first lens group
G2 second lens group (an example of a zoom adjustment lens group)
G3 third lens group
G4 fourth lens group (an example of a focus lens group)

1. A lens unit for forming a first optical image and a second optical image having parallax, on an imaging element via a uniaxial optical system, said lens unit comprising:
a first optical system operable to form the first optical image viewable from a first viewpoint, said first optical system guiding light from a subject to the uniaxial optical system; and
a second optical system operable to form the second optical image viewable from a second viewpoint that is different from the first viewpoint, said second optical system guiding light from the subject to the uniaxial optical system.

2. The lens unit according to claim 1,
wherein the first optical system has a first negative lens group that has a negative refractive power, a first positive lens group that has a positive refractive power and is disposed on an opposite side of the first negative lens group from a subject side, and a first prism group that is disposed on the opposite side of the first negative lens group from the subject side, and
the second optical system has a second negative lens group that has a negative refractive power, a second positive lens group that has a positive refractive power and is disposed on an opposite side of the second negative lens group from the subject side, and a second prism group that is disposed on the opposite side of the second negative lens group from the subject side.

3. The lens unit according to claim 2,
wherein the first positive lens group is disposed between the first negative lens group and the first prism group, and
the second positive lens group is disposed between the second negative lens group and the second prism group.

4. The lens unit according to claim 3,
wherein the first and second optical systems are disposed at substantially symmetrical positions with respect to an intermediate reference plane defined by a position located at a middle of the first and second optical systems,
the first prism group refracts light, which is transmitted by the first positive lens group, toward the intermediate reference plane, and
the second prism group refracts light, which is transmitted by the second positive lens group, toward the intermediate reference plane.

5. The lens unit according to claim 3,
wherein the first prism group refracts light, which is transmitted by the first positive lens group, and guides the refracted light to a uniaxial optical system disposed to a rear of the lens unit, and
the second prism group refracts light, which is transmitted by the second positive lens group, and guides the refracted light to a uniaxial optical system disposed to the rear of the lens unit.

6. The lens unit according to claim 2,
wherein the first positive lens group has a substantially semicircular shape, and
the second positive lens group has a substantially semicircular shape.

7. The lens unit according to claim 2,
wherein an effective radius of the first negative lens group is smaller than an effective radius of the first positive lens group, and
an effective radius of the second negative lens group is smaller than an effective radius of the second positive lens group.

8. The lens unit according to claim 2,
wherein the first optical system is a substantially afocal optical system, and
the second optical system is a substantially afocal optical system.

9. The lens unit according to claim 2,
wherein a first optical axis is a line that passes through a principal point of the first negative lens group and a principal point of the first positive lens group,
a second optical axis is a line that passes through a principal point of the second negative lens group and a principal point of the second positive lens group, and
the first optical axis and the second optical axis form a convergence angle.

10. The lens unit according to claim 2,
wherein a light beam passing through an optical axis center of the first optical system is incident upon a region corresponding to a range of 0.3 to 0.7 of a main body maximum image height, when the main body maximum image height is 1.0, and
a light beam passing through an optical axis center of the second optical system is incident upon a region corresponding to a range of 0.3 to 0.7 of the main body maximum image height, when the main body maximum image height is 1.0.

11. The lens unit according to claim 2,
wherein, a first optical axis is a line that passes through a principal point of the first negative lens group and a principal point of the first positive lens group, and
when θ11 is a polarization angle of the first prism group, θ1 is an emission angle of light transmitted by the first prism group, X1 is a vertical length from an intersection between an outermost light beam and an incident face of the first prism group to the first optical axis, X12 is a vertical length from an intersection between the outermost light beam and an emission face of the first prism group to the first optical axis, L1 is a distance from an optical reference plane defined on an incident side of the first prism group to the incident face, and L12 is a distance from the optical reference plane to the emission face, the following relation is satisfied:
θ11≦{(θ1+arctan(X1/L1))²+(θ1+arctan(X12/L12))²}^{0.5}≦4×θ11.

12. The lens unit according to claim 2,
wherein a second optical axis is a line that passes through a principal point of the second negative lens group and a principal point of the second positive lens group, and
when θ22 is a polarization angle of the second prism group, θ2 is an emission angle of light transmitted by the second prism group, X2 is a vertical length from an intersection between an outermost light beam and an incident face of the second prism group to the second optical axis, X22 is a vertical length from an intersection between the outermost light beam and an emission face of the second prism group to the second optical axis, L2 is a distance from an optical reference plane defined on an incident side of the second prism group to the incident face, and L22 is a distance from the optical reference plane to the emission face, the following relation is satisfied:
θ22≦{(θ2+arctan(X2/L2))²+(θ2+arctan(X22/L22))²}^{0.5}≦4×θ22.

13. The lens unit according to claim 1,
further comprising a housing that accommodates the first and second optical systems in its interior and can be attached to and removed from an imaging device having the imaging element.
